(19) United States
(12) Patent Application Publication
(10) Pub. No.: US 2009/0157523 A1
(43) Pub. Date: Jun. 18, 2009

(54) METHOD AND SYSTEM FOR HUMAN ASSISTED REFERRAL TO PROVIDERS OF PRODUCTS AND SERVICES

(75) Inventors: Scott A. Jones, Carmel, IN (US); Thomas E. Cooper, Indianapolis, IN (US)

Correspondence Address: STAAS & HALSEY LLP, SUITE 700, 1201 NEW YORK AVENUE, N.W., WASHINGTON, DC, 20005, US

(73) Assignee: ChaCha Search, Inc., Carmel, IN (US)

(21) Appl. No.: 12/332,920

(22) Filed: Dec. 11, 2008

Related U.S. Application Data
(60) Provisional application No. 61/013,473, filed on Dec. 13, 2007.
(60) Provisional application No. 61/016,173, filed on Dec. 21, 2007.

(51) Int. Cl. G06Q 30/00

(52) U.S. Cl. 705/26

(57) ABSTRACT

A method and system for referring a user to a provider of good(s), service(s) and/or information thereof which utilizes a human assistant. A human searcher or guide is selected to respond to a user request, and communication is established between a user and a guide. If the system determines that a user is requesting a product(s) and/or service(s), a provider of the product(s) and/or the service(s) is identified, and a communication session is established between a user and a provider of goods and/or services. A search system may assist in completing a transaction and may provide a referral service. Payment may be made using a payment system associated with a user using Premium SMS without requiring a user to provide payment information to a guide and/or the search system.

### CROSS-REFERENCE TO RELATED APPLICATIONS

This application is related to and claims the benefit of U.S. Provisional Patent Application Ser. No. 61/013,473 entitled, “PAYMENT METHOD AND SYSTEM FOR SEARCH SERVICES”, by Scott A. Jones et al., filed Dec. 13, 2007, Attorney Docket No. 1918.1037P, U.S. Provisional Patent Application Ser. No. 61/016,173 entitled, “METHOD AND SYSTEM FOR HUMAN ASSISTED REFERRAL TO PROVIDERS OF PRODUCTS AND SERVICES”, by Scott A. Jones et al., filed Dec. 21, 2007, Attorney Docket No. 1918.1038P, U.S. patent application Ser. No. 11/779,502 entitled, “ANONYMOUS SEARCH SYSTEM USING HUMAN SEARCHERS”, by Scott A. Jones et al., filed Jul. 18, 2007, Attorney Docket No. 1918.1006 and U.S. patent application Ser. No. 12/265,411, filed Nov. 5, 2008, inventor Brad Bostic, et. al., entitled METHOD AND SYSTEM OF ACCESSING INFORMATION, Attorney Docket No. 1918.1039, filed in the United States Patent and Trademark Office, the disclosures of which are incorporated herein by reference in its entirety.

### BACKGROUND

1. Field

The invention relates to search engine technology and specifically to search engines which utilize human searcher(s) or guide(s). A method and system is disclosed whereby a person may request information, identify a product or service(s), make a purchase and pay for a transaction using a human-assisted search service.

2. Description of the Related Art

The use of search systems is generally established as a technology whereby a user may locate information. Desk-top search has been popularized by companies such as Google, Yahoo!, and Microsoft to allow a user to access provider(s) of good(s) and/or service(s). For example, if a user is looking for a service, the user submits a request to a search engine which includes keywords associated with what the user is seeking. The search engine will return information of providers of goods and/or services associated with those keywords. A user may then be directed to a website of the merchant which may allow the user to make a purchase from the merchant.

But such systems have some serious weaknesses. A user must know what sort of goods or services may be provided, and the user must decide which merchant to select based on limited information. Services such as Angie's List® and Service Magic have been implemented to improve this situation, but have limited utility as the service base is specialized and narrow. Likewise, if a user is unaware of a service such as music recognition, image recognition, people information, etc. a user may not use such services. Smaller merchants or merchants without an on-line presence may be excluded from consideration as they may not have a website.

Such weaknesses are further aggravated when a user is using a mobile device, or a telephone or voice system wherein input capability is limited, and a browser function may be absent, difficult to use and/or costly. As a result, many users may not utilize services and/or products which might be available and beneficial and merchants miss out on sales. For example, an application exists for the Apple® iPhone® which may be used to send audio information to a web service which can pattern match the music to a database to determine an artist, title, etc. Such an activity requires the user to have a high end phone, a corresponding application, and activation of the application, etc. A sophisticated mobile device is required, as well as a sophisticated user. The provider of recognition service(s) may have a limited marketplace as adoption cost may be high.

Selecting a merchant and performing a transaction is similarly complex on a mobile device. For example, a user may dial an 800 number to get directory assistance, but such services will not provide general search services, which may lead a user to look elsewhere for help. Likewise a user can submit a request to a search engine by text which may provide information, but due to the limits of machine intelligence may not recognize a request which might be met by a provider of goods and/or services. For example, ‘What is the best place to buy Xbox in the Bronx?’ is easily answered by a human, but not recognized by an automated search system. A user has to discover the service provider, and be able to access them. A user gets no assistance to provide information needed to obtain the products or services. Limited interfaces like voice, text or mobile internet make finding, selecting and providing information difficult and frustrating to a user.

A similar situation exists with web based services such as the music recognition example above. If a user is unaware of a service such as music recognition, image recognition, people information, etc. a user may not use the services. A user has no way to discover a service such as music recognition (e.g., GraceNote), or image recognition which might provide a response to a user request. In particular, a request such as ‘what song is this?’ followed by an audio clip, or ‘where is george strait playing?’ will return a null result from automated searches by text. Each query is an opportunity to use a service, and might lead to a purchase opportunity for a merchant, but is lost.

Services like On-Star® have attempted to meet the need for general query support, but are strongly limited. Such a system suffers the issue of limited capability (such as directions, phone #'s, restaurant info, etc.), high cost since every operator does every task, and limited accessibility. A user may only access services while in their vehicle, and may have limited access elsewhere. Likewise, personal concierge services which may charge (up to $40 per month) for limited capabilities are not an economical alternative for consumers, and may have usage restrictions. In particular, costly sessions might be wasted on simple queries. Likewise, a credit card provider may offer such premium services to an elite member, but cost may be prohibitive, and service offerings are limited.

As illustrated by OnStar or similar services, or premium credit card concierge services, a user may be willing to pay for search services. For example, OnStar subscribers pay monthly (˜5 million subscribers), users of Any Questions Answered (AQA) pay on a per-question basis, as do users of traditional 411 service. However pay-per-use has fallen into disfavor. Use of 411 service continues to decline, and AQA has enjoyed limited success in the (15 million queries since 2004) at ˜2US$ per query. By contrast free services such as ChaCha®, Free411, and Google® SMS receive millions of calls per month. However, customers do purchase many products using a mobile phone. The preferred method of payment is to have charges added to the subscriber's phone bill. In 2006 87% of all paid transactions on mobile phones were billed to a subscriber's phone.

A user may wish to charge various services to the user's payment account with a phone carrier, but there may be issues with such a system. For example, a phone carrier may be unwilling to take payment risk, and a user may want to avoid erroneous charges to the account. A user may want to be able to access a service such as search service using more than one communication service(s). But current systems do not allow payments made on a single account to allow access to services using multiple devices and/or communication services. Likewise, a user might desire to make a purchase which might be charged to a user payment account without using a device which is directly associated with the account. Users have become comfortable with billing for downloads to a device such as ring-tones based on mobile terminated (MT) transactions, which are accepted in the US and EU. But there is no known method whereby such payments may be used for services and/or purchases of other types of goods using a mobile device.

In light of the above, a method and system whereby a user is enabled to ask generalized queries and be provided with goods and/or services responsive to a query, and whereby the user may pay for any or all such good(s) and service(s) using a payment account associated with a mobile phone would be greatly appreciated.

### SUMMARY

The disclosed method provides access to a good and/or a service, including receiving a request from a user, providing information of the request to a guide, and selecting a provider based on the information presented to the guide.

The method and system include associating another identifier with the identifier, transmitting a pay per use message to a device associated with the other identifier, and providing the payment to the provider based on the message.

The disclosed system includes a user device sending a request, a search system providing information of the request to a guide, a guide system selecting a provider based on the information presented to the guide and a provider system providing a product and/or a service.

These together with other aspects and advantages which will be subsequently apparent, reside in the details of construction and operation as more fully hereinafter described, reference being had to the accompanying drawings forming a part hereof, wherein like numerals refer to like parts throughout.

### BRIEF DESCRIPTION OF THE DRAWINGS

Aspects and advantages of the invention will become apparent and more readily appreciated from the following description of the embodiments, taken in conjunction with the accompanying drawings, of which:

FIG. 1 is a block diagram of a system embodiment.

FIG. 2 is a flowchart of a process for referring a user to a provider of goods and/or services.

FIG. 3 is a flowchart of a process for selecting a provider.

FIG. 4 illustrates a record for a user.

FIG. 5 illustrates a record for a guide.

FIG. 6 illustrates a record for a provider.

FIG. 7 illustrates a record for an advertisement.

FIG. 8 illustrates a record for a keyword.

FIG. 9 illustrates a record for a category.

FIG. 10 illustrates a record for a request.

FIG. 11 illustrates a database relationship.

FIG. 12 illustrates records used to select items.

FIG. 13 illustrates a graphical user interface (GUI) for a guide.

FIG. 14 illustrates a GUI for a guide.

FIG. 15 illustrates a GUI for a guide.

FIG. 16 is a block diagram of a system embodiment.

FIG. 17 is a flowchart of a process for registration of a user.

FIG. 18 is a flowchart of a process for obtaining payment.

FIG. 19 is a flowchart of a process for de-registration of a user.

FIG. 20 illustrates a payment record for a user.

FIG. 21 illustrates a payment account record for a user.

FIG. 22 illustrates an enrollment message.

FIG. 23 illustrates a user confirmation message.

FIG. 24 illustrates an error message.

FIG. 25 illustrates a system confirmation message.

FIG. 26 illustrates a system response message.

FIG. 27 is a flowchart of a process for associating an identifier (ID) of a user with another identifier of the user.

FIG. 28 illustrates a graphical user interface (GUI) for user registration.

FIG. 29 illustrates a GUI for conducting a search as a logged-in user.

FIG. 30 illustrates a GUI for reviewing an identifier(s) associated with a user ID.

FIG. 31 illustrates a GUI for associating an identifier(s) with a user ID.

FIG. 32 illustrates a GUI for managing user information.

FIG. 33 illustrates a GUI for review of historical information.

FIG. 34 illustrates a GUI for review of historical information.

FIG. 35 illustrates a user record.

FIG. 36 is a flowchart of associating a communication service with a user query.

FIG. 37 illustrates a GUI for associating a communication service with a user query.

### DETAILED DESCRIPTION OF THE PREFERRED EMBODIMENTS

Reference will now be made in detail to the present embodiments discussed herein, examples of which are illustrated in the accompanying drawings, wherein like reference numerals refer to the like elements throughout. The embodiments are described below to explain the disclosed system and method by referring to the figures. It will nevertheless be understood that no limitation of the scope is thereby intended, such alterations and further modifications in the illustrated device, and such further applications of the principles as illustrated therein being contemplated as would normally occur to one skilled in the art to which the embodiments relate.

A system is provided which may include a search system, a search database, a guide system, a provider system, a payment system, a payment system database, a voice communication service, a messaging communication service, a voice application server, a messaging application and a network. The search system may receive a request from a user system directly via the network, via a messaging service, or via a voice service or another existing service. A request may be routed to a guide who may determine whether a service provider may respond to the user request. If a service provider is needed, a guide may respond to the request by selecting a service provider. A guide may assist a service provider and/or a user in executing a transaction.

A user may elect to pay for item(s) and/or services using a payment account which is associated with a mobile phone number and/or other address. If a user elects to use the payment service, a user may be provided with a message responsive to a transaction. If the user confirms the transaction, a charge may be initiated to the user's payment account. Multiple communication services may be associated with a payment account, which may allow a user to cause transactions associated with the services to be billed to a common payment account.

A system and method is provided whereby a user may be connected to one or more human searchers or guides who may perform information search activities. The search system receives a user search request and selects a guide to respond to a user request. When a guide determines that a user desires to obtain product(s), service(s) and/or information pertaining thereto, the guide may identify a supplier of the product(s) and/or service(s) or provider which the guide determines can satisfy the user request. The search system may establish a communication session between a user and a provider in order that the user may obtain product(s), service(s) and/or information related thereto.

The search system includes a database which includes records containing information of users, guides, and providers. A database of communication information including data associated with user(s), guide(s), and/or provider(s) is used to enable communication between a user, a guide, a provider and/or the search system User requests are received and processed including in order to establish a communication session between a user and a guide. A guide may communicate with a user in order to clarify a user request. A guide may select a provider based on information indicated in a database. A guide and/or the search system may communicate with a provider prior to establishing a communication session between a provider and a user. A guide may transmit information associated with a user request to a provider. A communication session may be established between a user and a provider of goods and/or services. A fee may be paid to the search system by a user and/or a provider. Advertisements may be delivered to a user to provide a source of income for the search system.

A search request, which may include a keyword(s), a phrase, and/or a fully formed sentence, is received by a search system utilizing the assistance of human searchers or guides. Communication is established between a user and a guide. A determination is made as to whether a user is requesting product(s), service(s) and/or information pertaining thereto. A supplier of a product(s) and/or service(s) or provider is identified or selected. Communication is established between a user and a provider. A provider and/or a user may pay a fee to the search system. An advertisement(s) may be presented to a user.

Information of providers may be indexed in relation to an index useable by a system which is used by a guide to provide a search result to a user. A guide may associate information with a user request in order to identify a provider of good(s) and/or services. Contact information associated with a provider may indicate information which may be provided to the provider in order to process a user request. A rating of a provider may be obtained and may be used to select a provider. A rating of a guide may be obtained and may be used to select a guide. Rating information may be used to rank a guide(s) and/or a provider(s).

In at least one embodiment, a user is able to access a search system using devices such as a desktop, laptop, Mac, portable PC, smart phone such as an Apple iPhone®, a RiMM Blackberry®, a Palm Centrino®, a Samsung Blackjack® or any other type of web-enabled device. In at least one embodiment, a user is able to access search services using messaging services such as Short Messaging Service (SMS), Enhanced Messaging Service (EMS), Multimedia Messaging service (MMS), Instant Messaging (IM), email, or other forms of messaging. A messaging service may provide an interface to the search system by using a server and/or system which allows the search system to send and receive messages from users via the messaging service as will be described further herein.

As some or all services and/or item(s) provided to a user may require payment, it is desirable to provide a convenient method for the user to make payment. In at least one embodiment, a payment service(s) associated with a communication service(s) of a user may be used to effect payment for an item(s) and/or service(s) provided to the user. A payment system account is associated with a user communication service. For example, a payment account associated with a mobile telephone service account may be utilized. If a user elects to obtain a service which requires payment, a user account may be charged based on a message delivered to a user device associated with the payment account.

The message may be a mobile terminated (MT) message, or may be a mobile originated message (MO). In at least one embodiment, a user may receive a message which describes a purchase and/or other details, and may respond to the message. A response message may be a MO premium SMS (PSMS) message which causes a user account to be billed for the transaction. A purchase description may require a user to respond with a code and/or other security information. If a purchase is confirmed, a user may receive an MT PSMS message which may be used to cause a user account to be billed for the transaction.

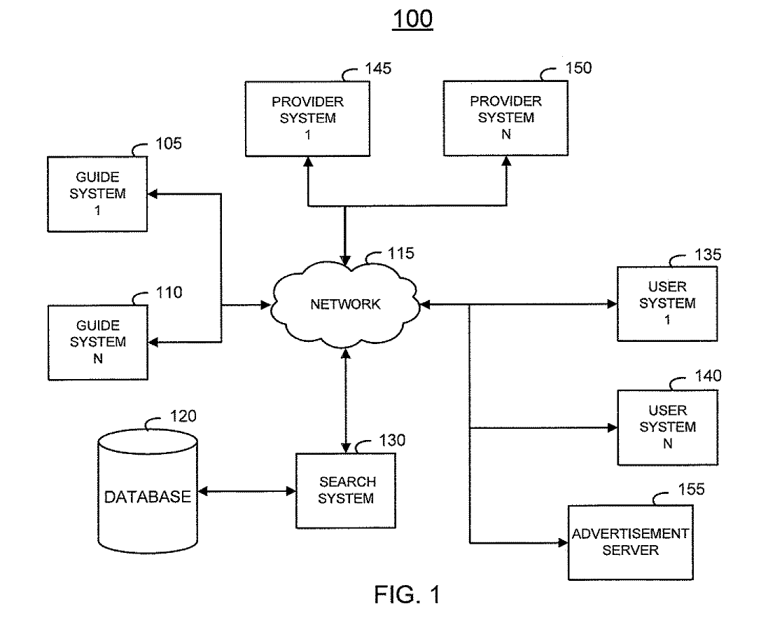

A “user” may be any person or entity which may submit a request or search request to the search system 130 (FIG. 1). A request, search request or query is information which may be submitted using any communication service which may be able to access a search system as further described herein below.

A “guide” may be any person who may be compensated and/or may be a volunteer who may respond to and/or assist with a request. An “ambassador” is a guide who may perform processing of a request and/or a search result(s). A “searcher” is a guide who may perform an information search responsive to a request.

A “raw query” is a request submitted by a user, which may include any type of information provided by a user and/or associated with a user.

A “vetted query” includes a request which is associated with a category, a structured query, or otherwise qualified query.

A “structured query” is a question formulated according to a structured grammar In at least one embodiment, a grammar construction required for a structured query is a question. A structured query may also be referred to as a “succinct query”.

An “identifier” or ID includes character(s), number(s) and/or other type(s) of information which may be used to identify an item which is stored in the database 120 (FIG. 1). Items may include but are not limited to a guide(s), a user(s), a provider(s), a resource(s), an advertisement(s), a keyword(s), a category(ies), a search result(s), a search request(s), a query(ies), a raw query(ies), a vetted query(ies), a rating(s), ranking(s), a message(s) and/or a profile(s).

A “guided request” is a request which uses the assistance of one or more guides.

A “result” or “search result” is any information which may be provided responsive to a request. A search result includes but is not limited to any of an advertisement(s), a link to a web page, a message of any sort, image, audio, text, games, interactive media and/or software of any sort.

A “search resource” or “resource” is any source of information which may be used to obtain a search result. A search resource includes automated and/or human-assisted systems, and any type of media and/or systems which may provide information. A resource may be a provider or source of item(s) and/or service(s). For example, a resource might provide an item such as a ringtone, a media file (e.g. audio, video, images, games, etc.), information such as news, lyrics, song titles, translation or any other type of information. A resource may be automated, and/or may utilize the assistance of a person(s).

A “profile” is one or more characteristics which may be associated with a person. Profile characteristics include but are not limited to demographic, geographic, personality, affiliations, areas of interest, historical actions, preferences, memberships, associations, etc.

A “provider” is any provider of item(s), service(s), and/or product(s). For example, a provider of services might include a provider of a web service such as music recognition, image recognition, translation, transcription, repair, legal, advisory, personal services, etc. A provider of item(s) or product(s) might include a provider of raw or finished goods of any sort such as food products, or manufactured goods, software products such as ringtones, music or images, etc.

An “advertisement” is any information which may be delivered to a user in order to promote a provider, a product, a service, etc. An advertisement may include text, audio, video, images, printed materials, interactive media such as a game, or other forms of media which may be provided to a user device.

The terms voice and speech are used interchangeably herein. A user, a provider, and/or a guide may establish a communication session using a voice service, a messaging service such as Short Messaging Service (SMS), Enhanced Messaging Service (EMS), Multi-media Messaging Service (MMS), Instant Messaging (IM), email, an internet portal or web page, a web browser functionality of a user device, regular mail or any other communication service(s). A connection may be established using any device which is capable of utilizing the relevant service. For example, a wireless device such as a cell phone, PDA, smart phone, etc. might be used to establish a communication session using voice, SMS, IM, email or internet protocols. A desktop, laptop or server system might be used to establish a communication session. A landline phone, a specialized communication terminal, or any other communication device might be used to establish communication session.

Communication between a guide, a user, a provider and/or the search system may include conversion of text to speech and speech to text. Any type of media which can be sent or received using a communication system may be part of a communication session. A communication session may be conducted using any or all communication service(s) associated with a user, a provider and/or guide. The search system provider and/or a guide(s) may be compensated by a user and/or a provider.

An advertisement may be transmitted including during any or all communication sessions between a user, a guide, a provider and/or the search system. A provider, a guide, and/or an advertisement may be rated. Rating information may be obtained from a user, a provider, a guide(s), and/or the search system. Rating information may be used to select a provider, a guide, and/or an advertisement. The search service may be compensated by advertising revenue.

A guide may be provided with a toolset which allows the guide to select a provider(s) which may satisfy a user request. Such a toolset may be configured to allow guides to share information regarding provider(s) which may improve a selection made by a guide. A guide may transfer a user request and/or a communication session to another guide. For example, an ambassador guide may receive a request, qualify the request, and transfer qualified request or vetted query to a searcher who may perform a search responsive to the request.

As illustrated in FIG. 1, the system 100 includes guide system(s) 105, 110, a network 115 such as the Internet, a search system 130, user system(s) or information seeker system(s) 135, 140, a database 120, which may comprise various records, provider system(s) 145, 150, and an advertisement server 155.

While only a limited number of systems associated with a guide (also referred to as a human searcher), provider (also referred to as a supplier), user (also referred to as an information seeker or requester), an advertisement server and as a search system are depicted in FIG. 1, it is within the scope of the disclosure for multiple systems for guide, provider, information seeker, advertisement server and search systems to be utilized.

Any user system (e.g., the user systems 135, 140) can be operated by an information seeker who may be any person to submit a search request to the search system 130 and/or receive a search result(s) or other information. Any guide system (e.g., the guide systems 105, 110) can be operated by a human searcher to obtain a search result(s) for an information seeker located at a user system (e.g., the user systems 135, 140). Any provider system (e.g., the provider systems 145, 150) may be operated by a human provider of good(s) and/or service(s) and/or may be an automated system which may provide product(s), service(s) and/or information pertaining thereto to a user.

The network 115 (FIG. 1) may be a global public network of networks (the Internet) and/or consist in whole or in part of one or more private networks and communicatively couples the guide systems, the provider systems and the user systems with the other components of the system such as the search system 130, and the database 120.

The search system 130 allows interaction to occur among the guide systems 105, 110, the provider systems 145, 150 and the user systems 135, 140. For example, an information search query(ies) can be transmitted from the user systems 135, 140 to the search system 130, where a search query(ies) can be accessed by the guide systems 105, 110 and/or the provider systems 145, 150. Similarly, a search result(s) produced using the guide systems 105, 110 in response to a search query(ies) submitted by the user systems 135, 140 may be transmitted to the search system 130, where it may be stored by the search system 130 and/or may be transmitted to the user systems 135, 140. While the search system 130 is illustrated as a single system any number of servers and/or other systems may be used to implement the search system 130. For example servers produced by Dell®, Gateway®, IBM® might be used to implement the search system. Voice routing and packet switching may be accomplished using well established technologies such as those provided by Cisco®, or other networking companies.

The search system 130 is communicatively coupled with the database 120. As will be described herein in further detail below, the database 120 includes data that is processed in association with operation(s) of the embodiments. Although FIG. 1 illustrates the database 120 as a separate component of the system, the database 120 may be integrated with the search system 130. Further, the records maintained in the database 120 may be stored in any typical manner, including in a Network Attached Storage (NAS), a Storage Area Network (SAN), etc. using any typical or proprietary database software such as DB2®, Informix®, Microsoft® SQLServer™, MySQL®, Oracle®, etc., and may also be a distributed database on more than one server. Elements of the database 120 may reside in any suitable elements of the system 100.

The advertisement server 155 may be used to provide advertising materials including to a user via the network 115. In at least one embodiment, the advertisement server 155 is a separate system from the search system 130 and may be operated by a provider of advertising services. Advertisements may be provided as various types of media by the advertisement sever 155 as is well known in the relevant art.

The user systems 135,140, the guide systems 105,110, the search system 130 and the provider systems 145, 150 may include equipment and personnel required to send and/or receive messages between a user system, a guide system, a provider system and/or the search system using the network 115. The database 120 includes information which may allow the search system 130 to establish communication between the other elements of the system.

A user system, a guide system, and/or a provider system may be a desktop or laptop PC or Mac, any device which may communicate using SMS, EMS or MMS messaging such as a mobile phone, a smart phone, a PDA, a server system, a landline phone, a specialized communication terminal, a terminal connected to a mainframe, a set-top box or other consumer electronic device, or any other communication device. The search system 130 may include one or more servers, computers, etc. After being presented with the disclosure herein, one of ordinary skill in the relevant art will immediately realize that any viable computer system(s) or communication device(s) known in the art may be used as user systems, guide systems, provider systems, and/or to implement the search system 130.

A guide may be required to register with the search system 130. As part of a registration process, at least one communication method is associated with a guide. In at least one embodiment, a guide may register with the search system 130 and establish a username and password which are associated with the guide. A guide may login to the search system 130 using a web browser functionality of guide system 105, 110 in order to communicate with the search system 130. Multiple communication services may be associated with a guide and may allow a communication session to be established between a guide system such as the guide system 105 and a user system, a provider system and/or the search system 130. Multiple identifiers of a guide may be associated with each other. Information such as IM credential(s), an email address(es), a phone number(s), a URL, a username, etc. of a guide may be identified which may allow the search system 130 to establish a communication session between a guide system and a user system, a provider system, and/or the search system 130.

When a guide registers with the search system 130 the guide may be associated with one or more keywords, categories, and/or other information. For example a keyword(s) or category(ies) may be selected by a guide, or may be associated with a guide based on a test(s) administered to a guide and/or other information provided during and/or after a registration process. Information associated with a guide may be stored in the database 120 and may be used for purposes such as matching a guide to a user request, determining and/or providing compensation for a guide, communicating with a guide, etc. as will be described further herein below.

A user may be identified by the search system 130. When a user system such as the user system 135 establishes a communication session with the search system 130, an identifier of a user system is determined. An identifier of a user system may be associated with other information regarding a user. A user system may be identified using an email address, a telephone number, an IM credential, a username, or other identifier which may be used to associate information with a user. Multiple identifiers of a user may be associated with each other. Using information of communication services associated with a user, a communication session may be established between a user system such as the user system 135 and a guide system, a provider system and/or the search system 130. Information such as a keyword(s), a user profile(s), previous request(s), etc. may be associated with a user. Information of a user may be stored in the database 120.

A provider, which may be a person(s) or entity(ies), may be identified by the search system 130. Information of at least one method of communication is associated with a provider system which allows a communication session to be established between the search system 130, a user system 135, 140, and/or a guide system 105, 110 and/or a provider system such as the provider systems 145, 150. An identifier of a provider system may be associated with other information regarding a provider. A provider system may be identified using an email address, a telephone number, an IM credential, a provider username, a URL or other identifier which may be used to uniquely identify the provider. Multiple identifiers of a provider may be associated with each other. Using the information of communication services associated with a provider, a communication session may be established between a provider system such as the provider system 145 and a user system, a guide system, and/or the search system 130. Information such as a keyword(s), a category(ies), a profile(s), or other information may be associated with a provider. Information of a provider may be stored in the database 120.

The search system 130 may be able to establish a communication session between any user system(s), guide system(s), or provider system(s) using information indicated in the database 120. For example, the user system 135 may establish a voice communication session with the search system 130, and subsequently the search system 130 may establish a voice communication session between the user system 135 and the guide system 105, and subsequently the search system 130 may establish a voice communication session between the user system 135 and the provider system 145. While a voice communication session is used in this example, any type of communication session using one or more services such as SMS, EMS, MMS, email, IM, chat, web based communication, etc. may be established between any user system(s), guide system(s), and/or provider system(s) and/or the search system 130 using the network 115.

Information associated with a user(s), a guide(s) and/or a provider(s) may be obtained in various ways. For example, a registration process may be performed using a web form(s) provided by the search system 130, and/or information may be obtained from an external database, and/or information may be obtained based on analysis of information indicated by a user, a guide, and/or a provider.

An index of information associated with a provider(s) may be created. An index may be based on information associated with a provider(s) which may include keyword(s), category(ies), geographic, demographic, personality, political, time, communication service(s) or other information. Information associated with a provider(s) may be indexed in any way. In a preferred embodiment, information of a provider(s) is indexed using the same system which is used to index information utilized to produce a search result(s) for a user or information seeker.

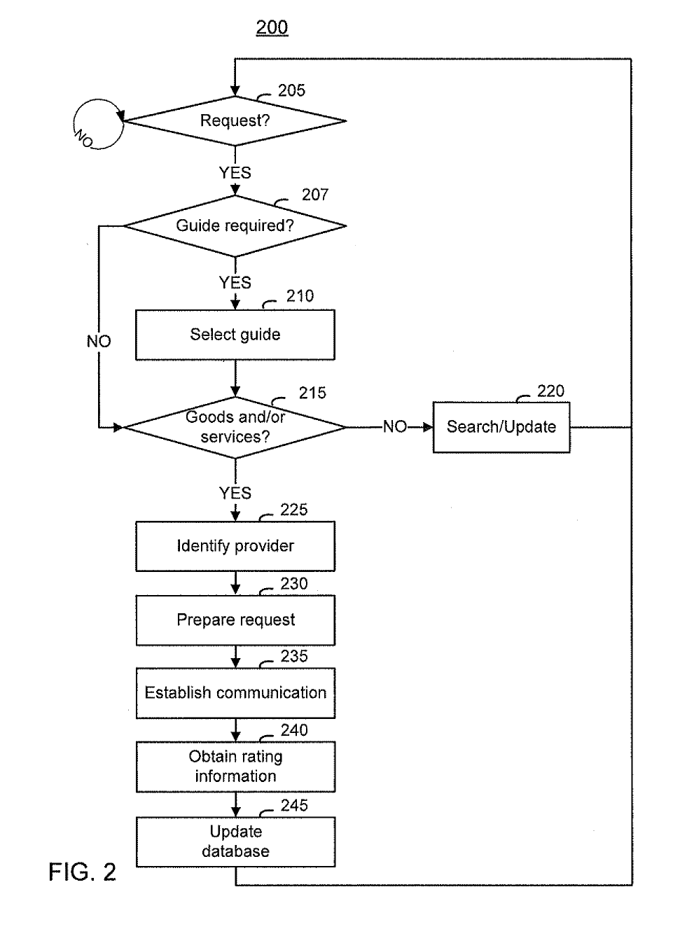

As illustrated in FIG. 2, a process 200 for responding to a user request is provided.

In operation 205 a determination is made as to whether a request or search request is received, for example, by the search system 130 (FIG. 1). If in operation 205 it is determined that a request is not received, control remains at operation 205 and process 200 continues. If in operation 205 it is determined that a request is received, control is passed to operation 210 and process 200 continues.

The determination in operation 205 may be made based on a communication session being established between a user system and the search system 130 (FIG. 1). For example, a user may transmit a request from a user system which is running web browser software via the Internet to a server of the search system 130, or a user may call an access number which establishes a voice connection between a user system and the search system 130, or a user may transmit an SMS, EMS or MMS message to a short code associated with the search system 130, or a user may send an IM message to an IM identifier associated with the search system 130, or a user may send an email to an email address associated with the search system 130, etc. A user may utilize any user system to submit a request to the search system 130. Multiple user systems may be utilized to submit a request.

In operation 207 a determination is made as to whether a request is to be routed to a guide. If in operation 207 it is determined that a request is not to be routed to a guide, control is passed to operation 215 and process 200 continues. If in operation 205 it is determined that a request is to be routed to a guide, control is passed to operation 210 and process 200 continues.

The determination in operation 207 may be made based on various criteria. In at least one embodiment, a query may be processed and/or compared to a database of previously answered queries to determine whether a guide is required to respond to a user request. If a request is determined to match a previous request it may be determined that a guide is n required to respond to a request.

In operation 210 a guide is selected, and a communication session is established between a guide and a user. A guide may be selected based on availability of a guide, for example, a first available guide might be selected to communicate with a user. A selected guide may be an ambassador. A guide may be selected based on a ratings(s) associated with a guide. For example, if more than one guide is available, a guide with a higher ranking may be selected. A guide ranking may be based on information such as a rating(s) by a user(s), a type(s) of communication service(s), a training result(s), a rating(s) by the search system, a rating(s) by a guide(s), a rating(s) by a provider(s), a rating(s) based on information associated with a guide such as geographic, demographic, or other information, etc. In at least one embodiment, the highest ranking available guide is selected to respond to a user request. Methods for selecting a guide are described in the related applications, U.S. application Ser. No. 11/779,502 and U.S. Provisional Application 60/980,010 previously mentioned. Control is passed to operation 215 and process 200 continues.

In operation 215 a determination is made as to whether a user is requesting a good(s) (product(s)) and/or service(s). If in operation 215 it is determined that a user is not requesting a product(s) and/or service(s), control is passed to operation 220 and process 200 continues. If in operation 215 it is determined that a user is requesting good(s) (a product(s)) and/or service(s), control is passed to operation 225 and process 200 continues.

The determination in operation 215 may be made by a guide. A guide may review a user request and determine whether a user is seeking information or is seeking a product(s) and/or service(s). For example, a user might request information on a song which is playing and a guide could determine that the user desires to be connected to a provider of music recognition services. A guide might suggest a product(s) and/or service(s) based on a user request. A guide may interact with a user in order to clarify and determine user intent. In at least one embodiment, a user may be connected via a voice service to a guide(s) who may communicate with the user via a voice connection and/or using text to speech conversion and/or text messaging. In at least one embodiment, a user and a guide may communicate using a chat session. In at least one embodiment, an ambassador guide may determine whether a user is requesting a product(s) and/or service(s).

In at least one embodiment, the determination in operation 215 may be made automatically based on matching of information associated with a request and information in the search database 120. For example if a message includes a keyword, the keyword may be used to determine whether a user is requesting a product(s) and/or service(s). Similarly if a user request matches a previous request, or may be programmatically determined to match a known request, a determination may be made automatically.

In operation 220 a search is performed and a search result(s) is returned to a user. A method for performing a guided search is further described in the related application Ser. No. 11/779,502 previously mentioned. Information regarding a user, a guide(s), a search result(s), an advertisement(s), etc. associated with a search request may be recorded in the database 120 (FIG. 1). Control is passed to operation 205 and process 200 continues.

In operation 225 a provider(s) of a product(s) and/or service(s) is identified. Control is passed to operation 230 and process 200 continues.

A guide may identify a provider(s) of a product(s) and/or service(s). A guide may be provided with a list of one or more provider(s) based on information associated with a request. For example, a user request may include geographic information such as an area code, GPS or other location based information, etc., and a guide may determine that a user is requesting a supplier of automotive parts and services in close proximity to the location. A guide might be presented with a list of provider(s) sorted by proximity to a user location.

In at least one embodiment, information of providers is stored in the database 120 (FIG. 1). A guide may associate one or more keyword(s) and/or category(ies) with a user request in order to assist in identification of a provider. A provider may be selected based on any information associated with a request. For example, the keyword ‘automotive’ might be associated with a user request, and the address ‘1000 east 96^{th} street, Indianapolis, Ind.’ may be associated with a user request. A provider associated with the keyword ‘automotive’ who is located closest to the address ‘1000 east 96^{th} street, Indianapolis, Ind. ’ might be the highest ranked provider associated with a user request. A guide may interact with a user in order to identify a provider. For example, a guide may associate additional information with a request in order to identify a provider. A guide may interact with a provider in order to identify a provider. For example, a guide may communicate with a provider to determine availability of a product(s) and/or service(s), etc. in order to identify a provider.

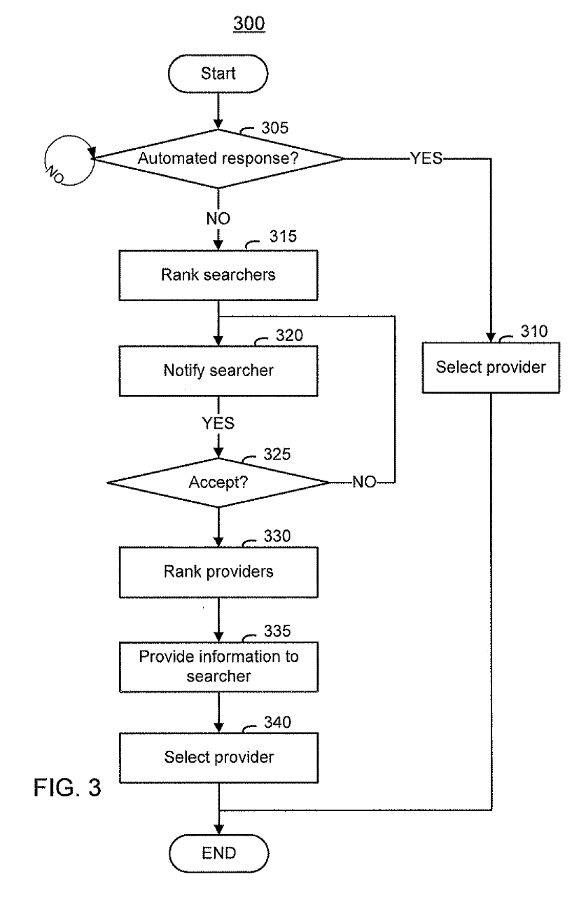

A provider(s) may be identified by the search system 130. For example, a guide may associate a keyword(s) and/or category(ies) with a request and the search system 130 may identify the highest ranking provider(s) associated with the keyword(s) and/or category(ies). Any type of information associated with a user, a guide, a provider and/or a request may be used in order to identify a provider. For example, geographic information, a type of automobile, a preferred type of provider, a purchase history, rating(s) of a provider(s), etc. may be used to identify a provider. A process for selecting a provider is further described herein below with respect to FIG. 3.

An advertisement(s) may be presented to a user during operation 225 (FIG. 2) and/or operation 230. For example, if a user is connected to a guide using a voice connection, an audio advertisement(s) may be played to the user. An advertisement(s) may be selected based on a keyword(s), category(ies) or other information associated with a request. A guide may select an advertisement(s) which is presented to a user. For example, an ambassador guide may select an advertisement in operation 210 which may be provided to a user in operation 220 or operation 225. Likewise, a guide may select an advertisement in operation 225 which may be presented to a user in operation 230.

In operation 230 a user request is prepared for submission to a provider. Control is passed to operation 235 and process 200 continues.

A request may be prepared to be submitted to a provider in various ways. For example, if a user is connected to a guide using a voice connection, and a provider is available to be contacted using a voice connection, no preparation of a user request may be required. If a user request has been associated with information which may be used by a provider in order to fulfill the user request, a guide may include that information in a message which is transmitted to a provider. For example, a provider might receive information which has been obtained by a guide and/or the search system 130 (FIG. 1), regarding a user request or the user, such as an audio recording of voice communication between a user and/or a guide(s) and/or the search system 130. A provider might receive geographic information, information of a user, audio, images, video, or any other information associated with a user request via any communication service(s) associated with a provider. Any action(s) which may be required by a provider may be performed in operation 230 to prepare a request for submission to a provider.

In at least one embodiment, a guide may provide information of a user request to a web service which may respond to the user For example, a user request might be formatted to be accepted by a web service which might require a .wav file format. A guide might remove user speech, and provide language of origin, genre, etc. in order to improve probability of recognition of a music clip. Likewise, a guide might capture text from an image, identify a person, or perform other tasks which may be used to format a user request for an automated response.

In operation 235 a communication session is established between a user and a supplier (a provider) of a product(s) and/or service(s). Control is passed to operation 240 and process 200 continues.

A communication session may be established using any communication service(s) associated with a user and/or a provider. For example, browser software operating on a user system may be directed to a URL associated with a provider, a voice connection may be established between a user system and a provider system, an email communication session may be established between a user system and a provider system, etc. It is not necessary for a user to know how to contact a provider, or for a provider to know how to contact a user. A communication session between a user(s) and a provider(s) may be established based on information indicated in the database 120 (FIG. 1). For example, if a user is connected to the search system 130 using a voice connection, a voice connection may be transferred to a provider identified or selected in operation 225 based on a telephone number associated with a provider. A communication session may include multiple types of devices and/or communication services. For example, a user may send a text message to a short code associated with the search system 130 (FIG. 1) from a user system associated with a telephone number, the search system 130 may transmit an Instant Message to a guide system, a browser function of a guide system may be used to provide information to a provider system using a web form provided by a provider system, and a voice connection may be established between a provider system and a user system. Similarly a user may conduct a voice conversation with a provider, and subsequently be contacted via email, text, IM or other service(s) without the provider knowing the explicit contact information of the user. The search system 130 may provide transcription and/or other types of processing in order to enable communication between a user system(s) and a provider system(s).

As the search system 130 may be able to establish communication between one or more user, guide, and/or provider systems, information may be exchanged between any systems connected to the network 115. Any number or type(s) of communication session(s) may be established in operation 235. For example, an automated response from a web service might be directly provided to a user system.

In operation 240 rating information is obtained. Rating information may be obtained regarding a guide(s), a provider(s), an advertisement(s), a user(s) and/or other item(s) or persons. Control is passed to operation 245 and process 200 continues.

Rating information of a guide(s) may be obtained in various ways. A user may provide a rating of a guide. For example, after completion of a communication session(s) between a user and a guide(s) and/or a provider(s), a user may be requested to rate the service(s) provided by a guide and/or a provider. A provider may rate a guide. For example, after completion of a communication session(s) between a provider and a user(s) and/or a guide(s), a provider may be requested to rate the service(s) provided by a guide.

A rating(s) of a guide may be determined based on a time interval. For example, the time between the start of a communication session between a guide and a user, and the end of a communication session between the guide and the user may be measured, and a shorter time interval may result in a higher rating of a guide, or a time interval between the start of a communication session between a user and a provider, and the end of a communication session between the user and the provider may be measured and a longer time interval, indicating that a guide may have provided insufficient information to a provider, might result in a lower rating of a guide. In at least one embodiment, if a user disconnects from a provider before completing a transaction, a guide might receive a low rating.

A guide may be rated by one or more guides. For example, information of a user request and a provider selected by a guide may be presented to a higher ranking guide and a rating(s) obtained based on the opinion of the higher ranking guide.

A rating of a guide may be based on revenue generated by guide activity(ies). For example, total revenue to a provider generated from referrals by a guide may be user to rate a guide, or a number of referrals to one or more providers by a guide may be used to rate a guide, or information of advertisements provided by a guide to a user(s) may be used to rate a guide.

A rating(s) of a guide may be based on any combination of ratings associated with a guide. A rating(s) of a guide may be based on any information associated with a guide. A rating(s) may affect compensation for a guide.

Rating information of a provider may be obtained in various ways. A user may rate a provider. For example, after completion of a communication session between a user and a provider(s), a user may be requested to rate a provider. A guide may rate a provider. For example, a guide may be requested to rate a provider after completion of a communication session between a guide and a provider. For example, if guide determines that a provider is unable to provide a product(s) and/or service(s) requested by a user(s), a guide may give a provider a low rating.

A rating of a provider may be based on frequency of selection of a provider by a guide(s). For example, if a first provider associated with the keyword ‘car service’ is selected by guides 50% of the time, and a second provider associated with the keyword ‘car service’ is selected by guides 30% of the time, the first provider might be rated higher than the second provider.

A rating of a provider may be based on a contractual arrangement between a provider and the operator of the search system 130. A rating of a provider may be based on any information associated with a provider. For example, a rating of a provider may be based on ratings associated with a keyword(s), a category(ies), profile information such as demographic, geographic, personality or other information, etc. which are associated with a provider. A rating of a provider may be based on any combination of ratings associated with a provider. A rating(s) of a provider(s) may affect the probability that a provider will be selected to respond to a user request.

A rating(s) of a user may be obtained in various ways. A user may be rated by a provider. For example, if a user has made repeated purchases from a provider, the provider may give a user a high rating, or if a user has not paid for a product(s) and/or service(s) a provider may give a user a low rating. A rating of a user may be based on any combination of ratings associated with a user. A rating of a user may be based on any information associated with a user. A rating(s) of a user may affect the priority assigned to a user request(s) by the search system 130 (FIG. 1).

A rating(s) of an advertisement(s) may be obtained in various ways. An advertisement may be rated based on a user action(s). For example, if a user clicks through an advertisement link, a rating of the advertisement may be increased, or if a user responds to an audio based advertisement, a rating of the advertisement may be increased, or if a user terminates a voice connection during an advertisement, a rating of the advertisement may be decreased. A rating of an advertisement may be based on information associated with a user(s). For example, an advertisement may be rated based on a demographic, geographic, or other type(s) of information indicated in a profile(s) associated with a user(s).

An advertisement may be rated based on a guide action(s). For example, if highly rated guides select a first advertisement 20% of the time, and highly rated guides select a second advertisement 50% of the time, the second advertisement may be rated higher than the first advertisement. One or more guide(s) may rate an advertisement(s). A rating(s) of an advertisement(s) may be based on information associated with a guide(s). For example, an advertisement may be rated based on demographic, geographic, or other type(s) of information indicated in a profile(s) associated with a guide(s).

A rating(s) of an advertisement may be based on any information associated with an advertisement. A rating(s) of an advertisement may be based on any combination of rating(s) associated with an advertisement. A rating(s) of an advertisement may affect the probability that an advertisement will be presented to a user.

In operation 245 (FIG. 2) the database 120 (FIG. 1) is updated. Information regarding a user(s), a provider(s), a guide(s), a request(s), a communication session(s), an advertisement(s), etc. may be recorded in the database 120. Information of advertisements provided to a user(s) may be used to determine compensation for a guide(s) and/or the search system 130. A user record(s) and/or a provider record(s) may be updated to indicate a credit to the search system 130 for service(s) provided. A payment transaction may be initiated. Exemplary content and relationships of information included in the database 120 are described further herein below. Control is passed to operation 205 and process 200 continues.

As illustrated in FIG. 3, a process 300 for selecting a provider is provided.

In operation 305 a determination is made as to whether an automated response to a request is available. If in operation 305 it is determined that a response to a request is not available, control is passed to operation 315 and process 300 continues. If in operation 305 it is determined that a response to a request is available, control is passed to operation 310 and process 300 continues.

The determination in operation 305 may be made based on various criteria. For example, a succinct query selected by an ambassador may match a structured query in the database 120 (FIG. 1), which may cause a provider previously selected by a guide to be selected. Likewise, if it is determined that a query matches a query template, a provider may be selected based on the query template. For example, if the query is ‘Who is the artist for this song?’ it may be determined that a response for a request is available. The determination at operation 305 may be made based on whether response(s) pertinent to a subject matter of a query exists as automatically determined by the system 100 (FIG. 1), thereby enabling an automated response to be provided in response to the query. In at least one embodiment, a keyword associated with an SMS, MMS, email or IM message may be used to determine if an automated response is available.

In operation 310 a provider is selected automatically. For example, if a user has requested information of a pizza restaurant, the top ranked provider of pizza may be selected. Similarly if a user has requested translation, a top-ranked translation system may be selected. Control is passed back to the parent process and process 300 terminates.

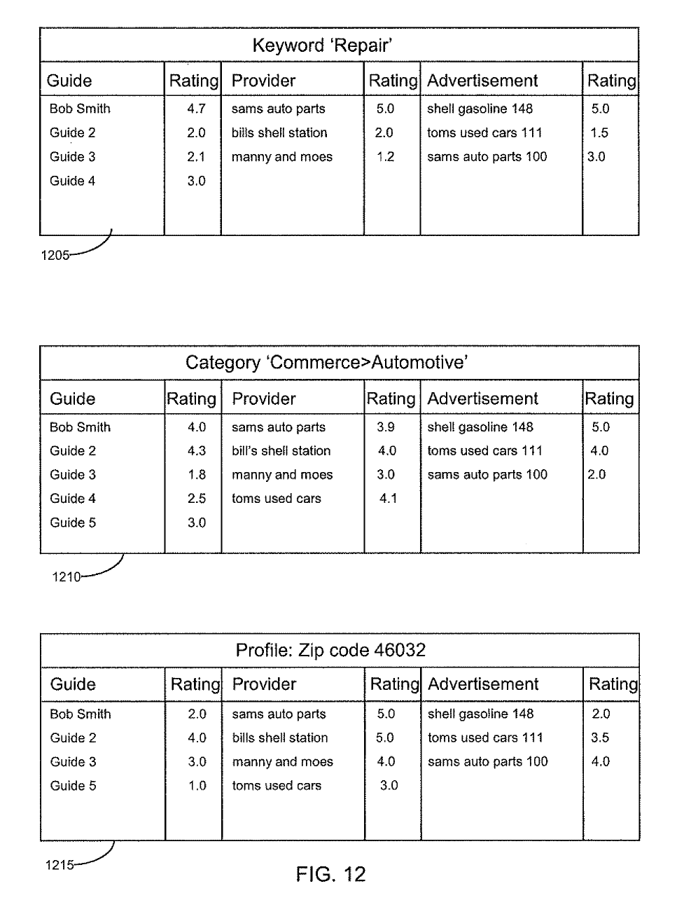

In operation 315 searchers are ranked to respond to the request. In at least one embodiment, a keyword(s), a category(ies) and a profile(s) associated with a query are used to determine a ranking of a guide(s) associated with a request. Any rating data associated with an item(s) associated with a request may be used to rank a guide to respond to a request(s). Selection of a guide is further illustrated herein below with respect to FIG. 12. Control is passed to operation 320 and process 300 continues.

In operation 320 a searcher(s) are notified of a request. For example, an IM, SMS, EMS, MMS, email, and/or voice message(s) may be used notify a searcher(s). Any number of searchers may be notified using any number of communication services associated with the searchers. Control is passed to operation 325 and process 300 continues.

In operation 325 a determination is made as to whether a searcher has accepted a request. If in operation 325 it is determined that a searcher has not accepted a request, control is passed to operation 320 and process 300 continues. If in operation 325 it is determined that a searcher has accepted a request, control is passed to operation 330 and process 300 continues. In at least one embodiment, more than one searcher may be required to respond to a request.

In operation 330 providers are ranked to respond to a request. A provider may be ranked on any basis. In at least one embodiment, a keyword(s), a category(ies) and a profile(s) associated with a query are used to determine a ranking of a provider(s) associated with a request. Any rating data associated with an item(s) associated with a request may be used to rank a provider to respond to a request(s). Selection of a guide is further illustrated herein below with respect to FIG. 12. Control is passed to operation 335 and process 300 continues.

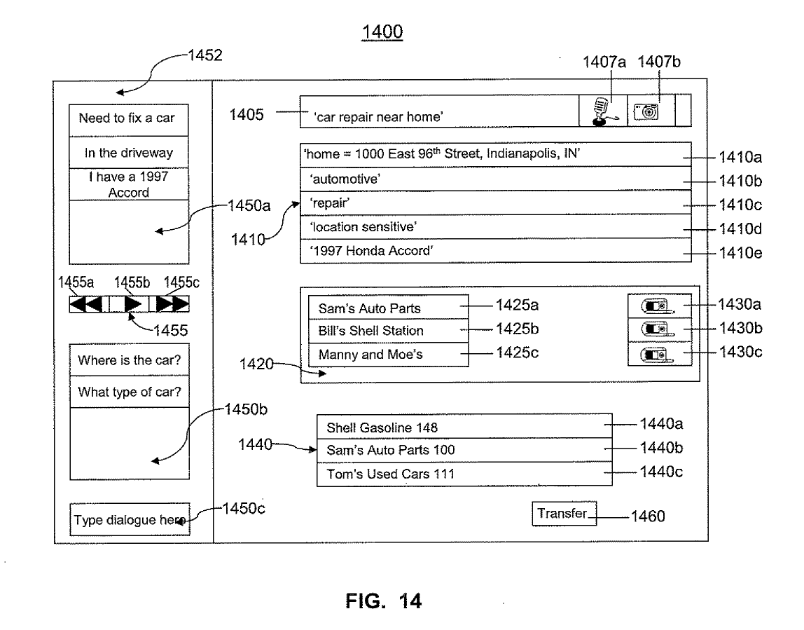

In operation 335 information of a request is provided to a searcher. An exemplary GUI for providing information of a request to a searcher is illustrated in FIG. 14. Any information associated with a request may be provided to a searcher. Control is passed to operation 340 and process 300 continues.

In operation 340 a provider is selected. In at least one embodiment, a provider is selected based on a selection by a searcher. In at least one embodiment, a provider is selected anonymously. In at least one embodiment, a provider is selected by a searcher. Control is passed back to the parent process and process 300 terminates.

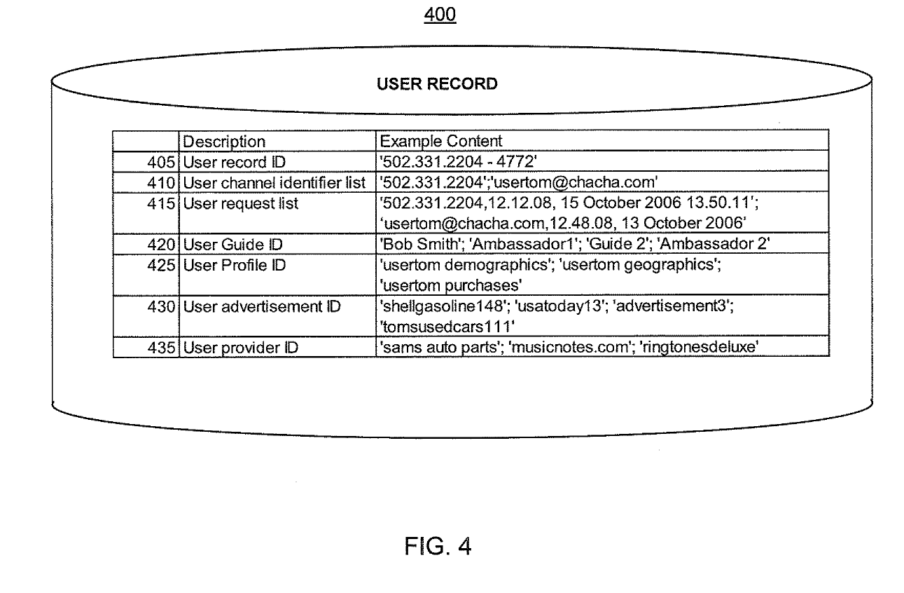

As illustrated in FIG. 4, a sample of a user record 400, of which one or more may be associated with or resident in the search database 120 (FIG. 1) is provided. The user record 400 may include a user record identifier (ID) field 405, a user channel ID field 410, a user request field 415, a user guide ID field 420, a user profile ID field 425, a user advertisement ID field 430 and a user provider ID field 435. User records such as the user record 400 may be used to store information of a user which may be used for any purpose.

The user record ID field 405 contains an identifier of a user, which is preferably unique and preferably used consistently. For example, in at least one embodiment, the user record ID field 405 can include a randomly generated numerical code, and/or a text string indicating a user. A user record ID serves to distinguish a user record associated with a user from a user record associated with other user(s). Although particular examples of identifiers are described herein, other types of identifiers uniquely indicating a user(s) may be utilized without departing from the spirit and scope of the embodiments. In at least one embodiment, a telephone number associated with a mobile phone service account may be included in the content of the user record ID field 405. A user record ID may include a username, an IM credential, an email address, etc. Using the example in FIG. 4, ‘502.331.2204-4772’ is the user record ID associated with the user record 400.

The user channel ID field 410 may include one or more identifiers associated with a user. The user channel identifier list field 410 may include one or more identifiers of a user and/or other information which may be used to establish communication with a user system. For example, a telephone number, an email address, an IM credential, a username, etc. may be included in the user channel identifier field 410. Using the example in FIG. 4, the telephone number ‘502.331.2204’ and the email address ‘usertom@chacha.com’ are the user channel identifiers which have been associated with the user record 400. While only a few channel identifiers have been illustrated in FIG. 4, any number of channel identifiers may be associated with a user.

The user request ID field 415 may include information of one or more requests associated with a user identifier. For example, the user request list field 415 may include a unique identifier(s) associated with a user request(s) submitted using a user system associated with any channel identifier associated with a user. Using the example illustrated in FIG. 4, the request ‘502.331.2204,12.12.08, 13 Oct. 2006’, ‘usertom@chacha.com, 12.48.08, 13 Oct. 2006’ and ‘502.331.2204,13.50.11, 15 Oct. 2006’ have been associated with the user ‘502.331.2204-4772’. The information in the user request ID field may be used to ‘look up’ information of previous requests by a user.

The user guide ID field 420 may include information of one or more guides associated with a user. Information in the user guide ID field 420 may be used to determine a preferred guide(s) associated with a user. If a guide has provided a highly rated search result to a user previously, the guide may have a higher rating for future queries by the user. The guides ‘Bob Smith’, ‘Ambassador 1’, ‘Guide 2’ and ‘Ambassador 2’ are associated with the user ‘502.331.2204-4772’.

The user profile ID field 425 may include profile information associated with a user. Profile information associated with a user may be used to determine a ranking(s) of an item associated with a request submitted by a user. For example, if it is determined that location is relevant to a request geographic information of a user profile might affect a rating(s) of a searcher(s), provider(s), advertisement(s), etc. Similarly if it is determined that gender is important to a request (e.g. clothing or shoes), demographic information of a user profile might affect a rating(s) of a searcher(s), provider(s), advertisement(s), etc. The profiles ‘usertom demographics’, ‘usertom geographics’and ‘usertom purchases’ are associated with ‘502.331.2204-4772’.

The user advertisement ID field 430 may include information of advertisements associated with a user. For example, if a user received an advertisement, an ID of the advertisement may be added to the user advertisement ID field 430. Advertisement information associated with a user may be used to determine distribution of advertisements based on other information associated with a user such as profile information, which may be used to improve delivery of advertisements. The advertisements ‘shell gasoline 148’, ‘usatoday 13’; ‘advertisement 4’ and ‘toms used cars 111’ are associated with ‘502.331.2204-4772’.

The user provider ID field 435 may include information of providers associated with a user. For example, if a user is connected to a provider by the search service, an ID of the provider may be added to the user provider ID field 435. The user provider ID field may be used to determine a rating(s) of a provider(s) associated with a user. For example, if a user has previously given a provider a low rating, the rating of the provider may be reduced for future requests associated with the user. If a user desires to contact a provider, information in the user provider ID field may be used to allow a user to anonymously contact a provider. The providers ‘sams auto parts’, ‘musicnotes.com’ and ‘ringtonesdeluxe’ are associated with 502.331.2204-4772’.

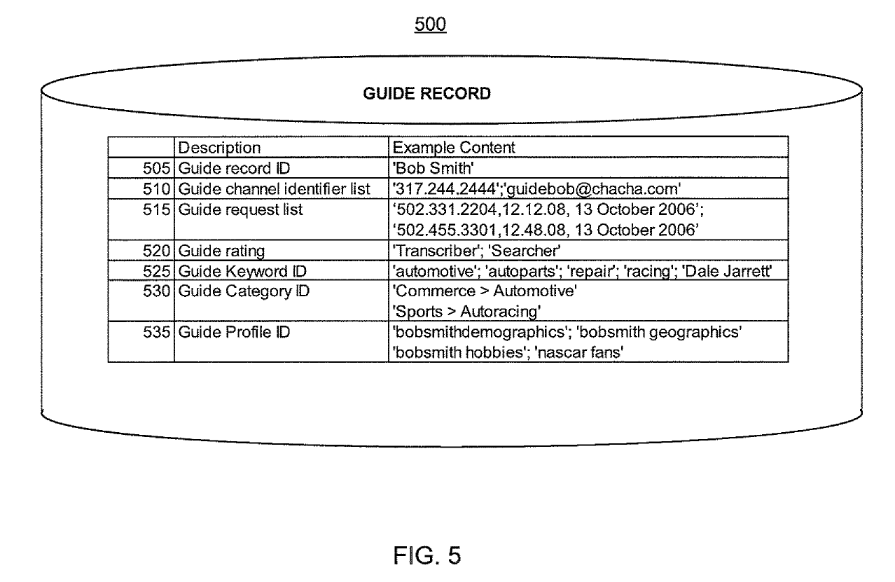

As illustrated in FIG. 5, a sample of a guide record 500, of which one or more may be associated with or resident in the search database 120 (FIG. 1) is provided. The guide record 500 may include a guide record ID field 505, a guide channel ID field 510, a guide request ID field 515, a guide rating field 520, a guide keyword ID field 525, a guide category ID field 530, and a guide profile ID field 535. A guide record may be used to represent any guide who is associated with the search system 130 (FIG. 1). A guide record may be modified during operation of the embodiments.

The guide record ID field 505 contains an identifier of a guide, which is preferably unique and preferably used consistently. For example, in at least one embodiment, the guide record ID field 505 can include a randomly generated numerical code, and/or a text string indicating a guide. A guide record ID serves to distinguish a guide record associated with a guide from a guide record associated with other guide(s). Although particular examples of identifiers are described herein, other types of identifiers uniquely indicating a guide(s) may be utilized without departing from the spirit and scope of the embodiments. In at least one embodiment, a guide record ID may include a first and last name of a guide. In at least one embodiment, a telephone number associated with a mobile phone service account may be included in the content of the guide record ID field 505. A guide record ID may include a guide username, an IM credential, an email address, etc. Using the example in FIG. 5, ‘Bob Smith’ is the guide record ID associated with the guide record 500.

The guide channel identifier list field 510 may include one or more identifiers associated with a guide. The guide channel list identifier field 510 may include one or more identifiers of a guide and/or other information which may be used to establish communication with a guide system. For example, a telephone number, an email address, an IM credential, a username, etc. may be included in the guide channel identifier field 510. Using the example in FIG. 5, the telephone number ‘317.244.2444’, the email address ‘guidebob@chacha.com’ and the password ‘BobS’ are the guide channel identifiers which have been associated with the guide ‘Bob Smith’. In at least one embodiment, an email address and a password may be used to access the guide functionality of the search system 130 (FIG. 1). While only a few channel identifiers have been illustrated in FIG. 5, any number of channel identifiers may be associated with a guide.

The guide request ID field 515 may include information of one or more requests associated with a guide ID. For example, the guide request ID field 515 may include a unique identifier(s) associated with a user request(s) which have been assigned to a guide. Using the example illustrated in FIG. 5, the request ‘502.331.2204,12.12.08, 13 Oct. 2006’, and the request ‘502.455.3301,12.48.08, 13 Oct. 2006’ have been associated with the guide ‘Bob Smith’.

The guide rating field 520 may include information of one or more ratings associated with a guide. The content of the guide rating field 520 may include one or more ratings of a guide which may be used to select a guide to be assigned to a request. In at least one embodiment, a rating may be associated with a keyword(s), a category(ies), or other information which has been associated with a request. Any information indicated in the database 120 (FIG. 1) may be used to determine a rating of a guide. Using the example illustrated in FIG. 5, the rating ‘Transcriber’ and ‘Searcher’ are associated with the guide ‘Bob Smith’. The rating information may indicate that ‘Bob Smith’ may be a preferred transcriber, and a highly ranked searcher. While only two types of ratings are illustrated in FIG. 5, ratings of a guide may be associated with various types of information. For example a guide may have a rating associated with one or more keywords, categories, skills, profiles, users or other types of information which may be associated with a guide and/or a request. Any type of information which may indicate a rating such as a number, text, etc. may be included in the guide rating field 520.

The guide keyword ID field 525 may include information of a keyword(s) associated with a guide. A guide may elect to be associated with a keyword(s) during and/or after registration with the search system 130. A rating and/or ranking of a guide(s) may be associated with a keyword(s). A keyword may be used to exclude and/or include topics for requests by a guide(s). The keywords ‘automotive’, ‘auto parts’, ‘repair’, ‘racing’, ‘dale jarrett’, are associated with the guide ‘Bob Smith’.

The guide category ID field 530 may include information of a category(ies) associated with a guide. A guide may elect to be associated with a category(ies) during and/or after registration with the search system 130. A rating and/or ranking of a guide(s) may be associated with a category(ies). A category may be used to select a type of request which a guide will accept. A category is a more general class of requests than a keyword, and thus more likely to include a larger range of requests. The categories ‘Commerce>Automotive’ and ‘Sports>autoracing’ are associated with the guide ‘Bob Smith’. This may indicate that ‘Bob Smith’ will accept queries associated with products and/or service in the ‘Automotive’ category, and searches associated with ‘Sports> autoracing’.

The guide profile ID field 535 may include information of a profile(s) associated with a guide. A guide may provide profile information during and/or after a registration process. For example, a guide may identify resources such as a personal web page, a profile page such as ‘LinkedIn®’, a collection of documents, etc. which may be processed by the search system 130 to provide profile information. A guide may participate in activities such as surveys, polls, games, etc. which may provide profile information. The guide ‘Bob Smith’ is associated with ‘Bobsmith demographics’; ‘Bobsmith geographics’; ‘Bobsmith hobbies’ and ‘NASCAR fans’.

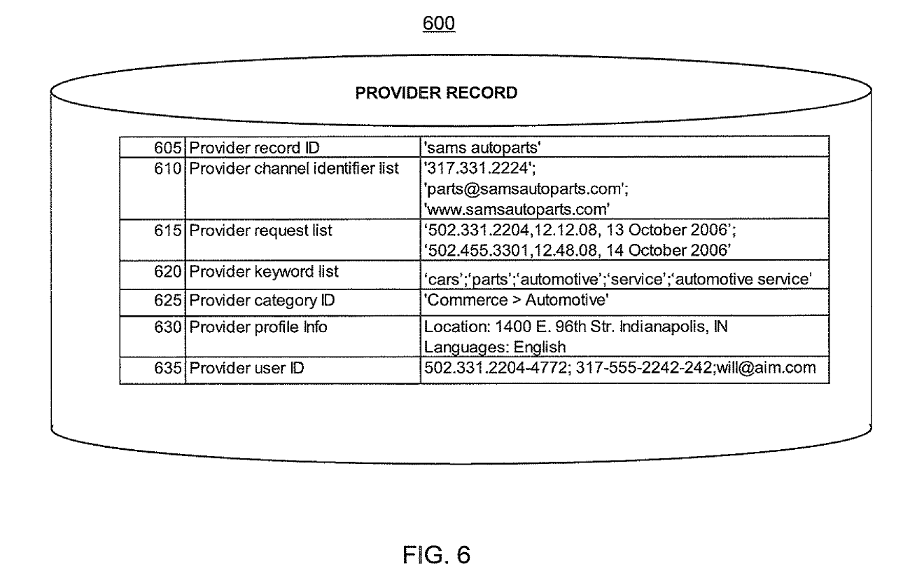

As illustrated in FIG. 6, a sample of a provider record 600, of which one or more may be associated with or resident in the search database 120 (FIG. 1) is provided. The provider record 600 may include a provider record ID field 605, a provider channel ID field 610, a provider request ID field 615, a provider keyword ID field 620, a provider category ID field 625, a provider profile ID field 630, and a provider user ID field 635. A provider record may be used to represent any provider who is associated with the search system 130. A provider record may be modified during operation of the embodiments.

The provider record ID field 605 contains an identifier of a provider, which is preferably unique and preferably used consistently. For example, in at least one embodiment, the provider record ID field 605 can include a randomly generated numerical code, and/or a text string indicating a provider. A provider record ID serves to distinguish a provider record associated with a provider from a provider record associated with other provider(s). Although particular examples of identifiers are described herein, other types of identifiers uniquely indicating a provider(s) may be utilized without departing from the spirit and scope of the embodiments. In at least one embodiment, the provider record ID is a telephone number. A provider record ID may include a provider username, an IM credential, an email address, etc. Using the example in FIG. 6, ‘sams autoparts’ is the provider record ID associated with the provider record 600. A provider may register with the search system 130 and/or information of a provider may be obtained from a resource such as a database, etc. In at least one embodiment, a provider may compensate an operator of the search system.

The provider channel ID field 610 (FIG. 6) may include one or more identifiers associated with a provider. The provider channel ID field 610 may include one or more identifiers of a provider and/or other information which may be used to establish communication with a provider system. For example, a telephone number, an email address, an IM credential, a username, a short code, a URL, etc. may be included in the provider channel ID field 610. Using the example in FIG. 6, the telephone number ‘317.331.2224’, the email address ‘parts@samsautoparts.com’ and the URL ‘www.samsautoparts.com’ are associated with ‘sams autoparts’. While only a few channel identifiers have been illustrated in FIG. 6, any number of channel identifiers may be associated with a provider.

A provider channel ID may further include information regarding how a request may be formatted when submitted to a provider. For example, a list of required information and a format of the information (e.g. HTML, .mp3, AVI, .png) may be included in the provider channel ID field in order that information obtained by the search system may be correctly transmitted to a provider. In at least one embodiment, information may be transmitted to a provider using multiple communication services associated with the provider.

The provider request ID field 615 may include information of one or more requests associated with a provider. For example, the provider request ID field 615 may include a unique identifier(s) associated with a user request(s) which have been assigned to a provider. Using the example illustrated in FIG. 6, the requests ‘502.331.2204,12.12.08, 13 Oct. 2006’, and the request ‘317.455.3301,12.48.08, 14 Oct. 2006’ are associated with the provider ‘sams autoparts’. A number of requests associated with a provider may be used to determine compensation for the search system 130.

The provider keyword ID field 620 may include information of one or more keywords which have been associated with a provider. The content of the provider keyword ID field 620 may be used to determine a ranking of a provider associated with a request. Using the example in FIG. 6, the keywords ‘cars’, ‘parts’, ‘automotive’, ‘service’ and ‘automotive service’ are associated with the provider ‘sams autoparts’. A provider may elect to be associated with a keyword(s) by for example paying for the association. A provider may be associated with a keyword(s) based on information obtained by the search system.

The provider category ID field 625 may include information of a number of categories which have been associated with a provider. The content of the provider category ID field 625 may be used to determine a ranking of a provider associated with a request. Using the example in FIG. 6, the category ‘Commerce>Automotive’ is associated with the provider ‘sams autoparts’. A provider may elect to be associated with a category(ies) by for example paying for the association. A provider may be associated with a category(ies) based on information obtained by the search system.

The provider profile information field 630 may include information of a number of profiles associated with a provider. Any type of profile information may be associated with a provider. For example, a supplier of music might indicate a target audience, a supplier of food might indicate a target customer, location information, language information, etc. may be indicated in a provider profile. The location ‘1400E 96^{th} Street, Indianapolis, Ind.’ and the language ‘English’ are associated with ‘sams autoparts’. A provider may use methods such as those used by a guide(s) to provide profile information. Profile information may be obtained without actions of a provider. Profile information associated with a provider may be used to determine a ranking of a provider associated with a profile associated with a request.

The provider user ID field 635 may include information of a user(s) associated with a provider. If a request of a user is directed to a provider, an identifier of the user may be added to the provider user ID field 635. Information of users associated with a provider may be used to determine a ranking of a provider(s), or compensation for the search system. For example, if many users are associated with a provider, a provider may have a high ranking, as this may indicate that a guide(s) have selected the provider more frequently. Likewise the search system may be compensated based on unique new users, repeat users, etc.

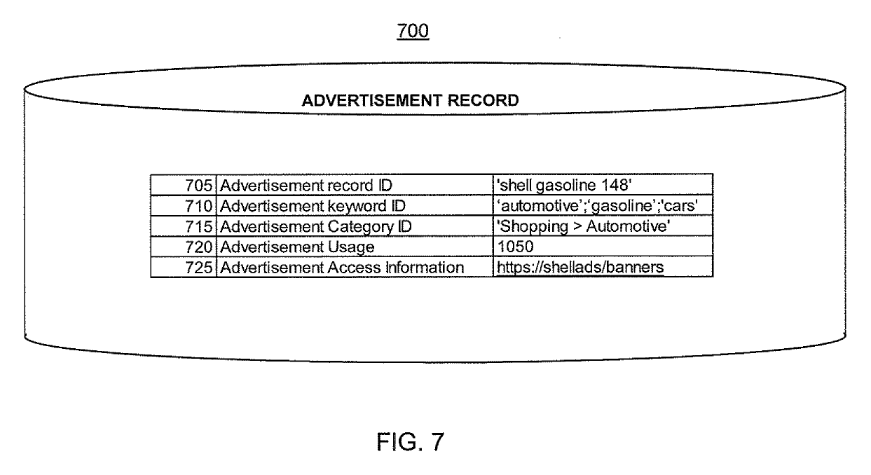

As illustrated in FIG. 7, a sample of an advertisement record 700, of which one or more may be associated with or resident in the search database 120 (FIG. 1) is provided. The advertisement record 700 may include an advertisement record ID field 705, an advertisement keyword ID field 710, an advertisement category ID field 715, an advertisement usage field 720, and an advertisement access information field 725. An advertisement record may be used to track information associated with an advertisement.

The advertisement record ID field 705 contains an identifier of an advertisement, which is preferably unique and preferably used consistently. For example, in at least one embodiment, the advertisement record ID field 705 can include a randomly generated numerical code, and/or a text string indicating an advertisement. An advertisement record ID serves to distinguish an advertisement record associated with an advertisement from an advertisement record associated with other advertisement(s). Although particular examples of identifiers are described herein, other types of identifiers uniquely indicating an advertisement(s) may be utilized without departing from the spirit and scope of the embodiments. In at least one embodiment, the advertisement record ID is a text string. An advertisement record ID may include an advertisement description, a random number, and/or any other information which uniquely identifies an advertisement. Using the example in FIG. 7, ‘shell gasoline 148’ is the advertisement record ID associated with the advertisement record 700.

The advertisement keyword ID field 710 includes information of a keyword(s) associated with an advertisement. The content of the advertisement keyword ID field 710 may be used to select an advertisement to be associated with a request. If a keyword is associated with a request, a rating(s) of an advertisement(s) associated with the keyword may be used to select an advertisement to be provided to a user responsive to the request. Using the example in FIG. 7, ‘automotive’, ‘gasoline’, and ‘cars’ are the keywords associated with the advertisement ‘shell gasoline 148’.

The advertisement category ID field 715 includes information of a category(ies) associated with an advertisement. The content of the advertisement category ID field 715 may be used to select an advertisement to be associated with a request. If a category is associated with a request, a rating(s) of an advertisement(s) associated with the category may be used to select an advertisement to be provided to a user responsive to the request. Using the example in FIG. 7, ‘shopping>Automotive’ is associated with the advertisement ‘shell gasoline 148’.

The advertisement usage field 720 may include information regarding usage of an advertisement. If an advertisement is provided to a user(s) the counter in the advertisement usage field 720 may be incremented. Usage data such as click-throughs, views, etc. may be recorded. As illustrated in FIG. 7, the advertisement ‘shell gasoline 148’ has been viewed 1050 times. Compensation of the search system may be based at least in part on usage information.

The advertisement access information field 725 may include information regarding how an advertisement is to be obtained. For example, a URL associated with the advertisement server 155 (FIG. 1) may be indicated in the advertisement access information field 725. An advertisement may include any type of media. As the advertisement is an object, an advertiser may modify the content without needing to know how the advertisement will be provided to a user. As illustrated in FIG. 7, the URL <<https://shellads/banners>> is associated with the advertisement ‘shell gasoline 148’, which may indicate that a request posted to that URL may cause the advertisement ‘shell gasoline 148’ to be provided by the advertising server 155 (FIG. 1).

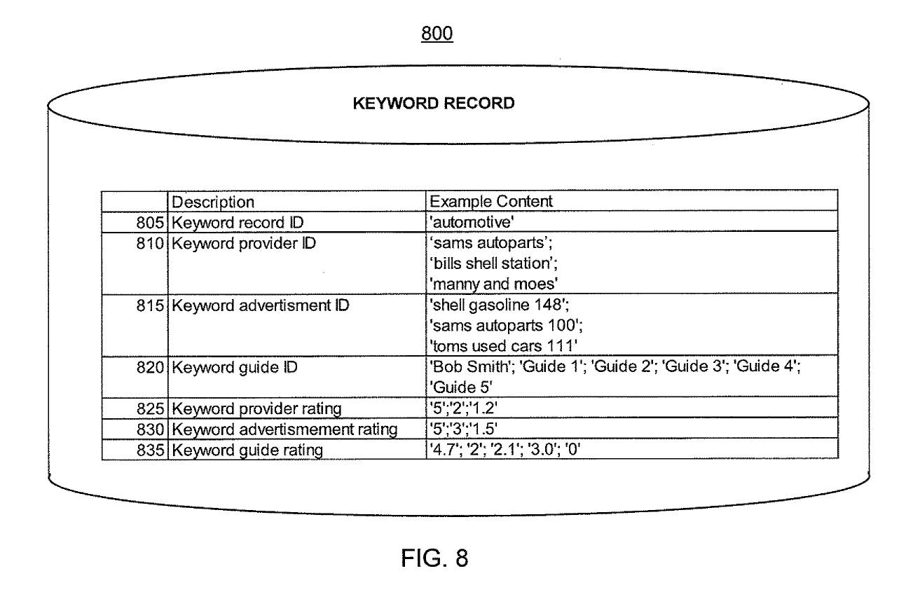

As illustrated in FIG. 8, a sample of a keyword record 800, of which one or more may be associated with or resident in the search database 120 (FIG. 1) is provided. The keyword record 800 may include a keyword record ID field 805, a keyword provider ID field 810, a keyword advertisement ID field 815, a keyword guide ID field 820, a keyword provider rating field 825, a keyword advertisement rating field 830, and a keyword guide rating field 835. A keyword record may be used to track ratings of items associated with the keyword. A rating(s) may be modified during operation of the embodiments. Items may be added and/or removed from a keyword record.

The keyword record ID field 805 contains an identifier of a keyword, which is preferably unique and preferably used consistently. For example, in at least one embodiment, the keyword record ID field 805 can include a randomly generated numerical code and/or a text string indicating a keyword. A keyword record ID serves to distinguish a keyword record associated with a keyword from a keyword record associated with other keywords(s). Although particular examples of identifiers are described herein, other types of identifiers uniquely indicating a keyword(s) may be utilized without departing from the spirit and scope of the embodiments. In at least one embodiment, the keyword record ID is a text string. A keyword record ID may include a keyword description, a random number, and/or any other information which uniquely identifies a keyword. Using the example in FIG. 8, ‘automotive’ is the keyword record ID associated with the keyword record 800.

The keyword provider ID field 810 includes information of a provider(s) associated with a keyword. The content of the keyword provider ID field 810 may be used to select a provider. Using the example in FIG. 8, the providers ‘sams autoparts’, ‘bills shell station’ and ‘manny and moes’ are associated with the keyword ‘automotive’.

The keyword advertisement ID field 815 includes information of an advertisement(s) associated with a keyword. The content of the keyword advertisement ID field 815 may be used to select an advertisement. Using the example in FIG. 8, the advertisements ‘shell gasoline 148’, ‘sams autoparts 100’ and ‘toms used cars 111’ are associated with the keyword ‘automotive’. This may indicate that the advertisers associated with the advertisements ‘shell gasoline 148’, ‘sams autoparts 100’ and ‘toms used cars 111’ have bid on the keyword ‘automotive’

The keyword guide ID field 820 includes information of a guide(s) associated with a keyword. The content of the keyword guide ID list field 810 may be used to select a guide. Using the example in FIG. 8, the guides ‘Bob Smith’, ‘Guide 1’, ‘Guide 2’, ‘Guide 3’, ‘Guide 4’ and ‘Guide 5’ are associated with the keyword ‘automotive’. This may indicate that the guides ‘Bob Smith’, ‘Guide 1’, ‘Guide 2’, ‘Guide 3’, ‘Guide 4’, etc. have registered to accept requests associated with the keyword ‘automotive’.

The keyword provider rating list field 825 includes information of ratings of a provider(s) associated with a keyword. The content of the keyword provider rating field 825 and the keyword provider ID field 810 may be linked by, for example, a pointer. Any type of rating information may be indicated in the provider rating field 825. A higher provider rating may increase the probability that a provider will be selected. For example, a list of providers may be presented to a guide in an order based at least in part on a provider rating associated with a keyword associated with a request. Using the example in FIG. 8, ‘sams autoparts’ is rated ‘5’, ‘bills shell station’ is rated ‘2’, and ‘manny and moes’ is rated ‘1.2’. Any rating system may be utilized within the scope of this disclosure. A rating(s) may be based on factors such as guide ratings, user ratings, provider ratings, an external database, time, proximity, profile information, etc. In at least one embodiment, a rating of a provider is based at least in part on bids by providers, guide selections, and user ratings.

The keyword advertisement rating field 830 includes information of ratings of an advertisement(s) associated with a keyword. The content of the keyword advertisement rating field 730 and the keyword advertisement ID field 815 may be linked by, for example, a pointer. Any type of rating information may be indicated in the keyword advertisement rating field 730. A higher advertisement rating may increase the probability that an advertisement will be selected. For example, a list of advertisements may be presented to a guide in an order based at least in part on an advertisement rating associated with a keyword associated with a request. Using the example in FIG. 8, ‘shell gasoline 148’ is rated ‘5’, ‘sams autoparts 100’ is rated ‘3’, and ‘toms used cars 111’ is rated ‘1.5’. Any rating system may be utilized within the scope of this disclosure. A rating(s) may be based on factors such as guide ratings, user ratings, provider ratings, an external database, time, proximity, profile information etc. In at least one embodiment, a rating of an advertisement is based at least in part on bids by advertisers.

The keyword guide rating field 835 includes information of ratings of a guide(s) associated with a keyword. The content of the keyword guide rating field 830 and the keyword guide ID field 815 may be linked by, for example, a pointer. Any type of rating information may be indicated in the keyword guide rating field 835. A higher guide rating may increase the probability that a guide will be selected. For example, a list of guides may be presented to an ambassador in an order based at least in part on a guide rating associated with a keyword associated with a request. Using the example in FIG. 8, ‘Bob Smith’ is rated ‘4.7’, ‘Guide 1’ is rated ‘2’, ‘Guide 2’ is rated ‘2.1’ and ‘Guide 3’ is rated ‘3.0’, Any rating system may be utilized within the scope of this disclosure. A rating(s) may be based on factors such as guide ratings, user ratings, provider ratings, an external database, time, proximity, profile information etc.

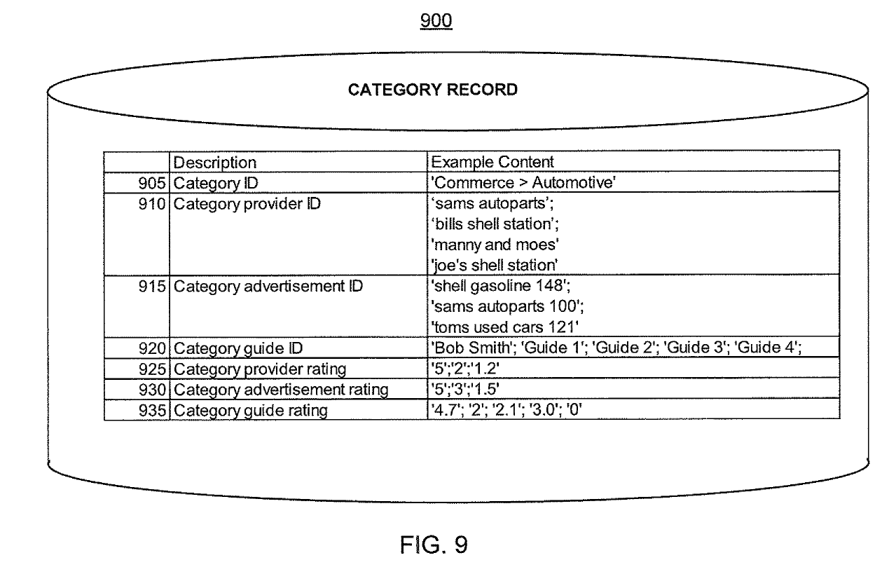

As illustrated in FIG. 9, a sample of a category record 900, of which one or more may be associated with or resident in the search database 120 (FIG. 1) is provided. The category record 900 may include a category record ID field 905, a category provider ID field 910, a category advertisement ID field 915, a category guide ID field 920, a category provider rating field 925, a category advertisement rating field 930, and a category guide rating field 935. A category record may be used to track ratings of items associated with the category. A rating(s) may be modified during operation of the embodiments. Items may be added and/or removed from a category record.

The category record ID field 905 contains an identifier of a category, which is preferably unique and preferably used consistently. For example, in at least one embodiment, the category record ID field 905 can include a randomly generated numerical code and/or a text string indicating a category. A category record ID serves to distinguish a category record associated with a category from a category record associated with other category(ies). Although particular examples of identifiers are described herein, other types of identifiers uniquely indicating a category(ies) may be utilized without departing from the spirit and scope of the embodiments. In at least one embodiment, the category record ID is a text string. A category record ID may include a category description, a random number, and/or any other information which uniquely identifies a category. Using the example in FIG. 9, ‘Commerce>Automotive’ is the category record ID associated with the category record 900.

The category provider ID field 910 includes information of a provider(s) associated with a category. The content of the category provider ID field 910 may be used to select a provider. Using the example in FIG. 9, the providers ‘sams autoparts’, ‘bills shell station’ ‘joes shell station’ and ‘manny and moes’ are associated with the category ‘Commerce>Automotive’.

The category advertisement ID field 915 includes information of an advertisement(s) associated with a category. The content of the category advertisement ID field 915 may be used to select an advertisement. Using the example in FIG. 9, the advertisements ‘shell gasoline 148’, ‘sams autoparts 100’, and ‘toms used cars 121’ are associated with the category ‘Commerce>Automotive’. This may indicate that the advertisers associated with the advertisements ‘shell gasoline 148’, ‘sams autoparts 100’ and ‘toms used cars 121’ have bid on the category ‘Commerce>Automotive’.

The category guide ID field 920 includes information of a guide(s) associated with a category. The content of the category guide ID list field 910 may be used to select a guide. Using the example in FIG. 9, the guides ‘Bob Smith’, ‘Guide 1’, ‘Guide 2’, Guide 3’ and ‘Guide 4’ are associated with the category ‘automotive’. This may indicate that the guides ‘Bob Smith’, ‘Guide 1’, ‘Guide 2’, ‘Guide 3’ and ‘Guide 4’ have registered to accept requests associated with the category ‘Commerce>Automotive’.

The category provider rating list field 925 includes information of ratings of a provider(s) associated with a category. The content of the category provider rating field 925 and the category provider ID field 910 may be linked by, for example, a pointer. Any type of rating information may be indicated in the provider rating field 925. A higher provider rating may increase the probability that a provider will be selected. For example, a list of providers may be presented to a guide in an order based at least in part on a provider rating associated with a category associated with a request. Using the example in FIG. 9, ‘sams autoparts’ is rated ‘5’, ‘bills shell station’ is rated ‘2’, ‘manny and moes’ is rated ‘1.2’ and joes shell station’ is rated ‘2.5’. Any rating system may be utilized within the scope of this disclosure. A rating(s) may be based on factors such as guide ratings, user ratings, provider ratings, an external database, time, proximity, profile information, etc. In at least one embodiment, a rating of a provider is based at least in part on bids by providers, guide selections, and user ratings.

The category advertisement rating field 930 includes information of ratings of an advertisement(s) associated with a category. The content of the category advertisement rating field 930 and the category advertisement ID field 915 may be linked by, for example, a pointer. Any type of rating information may be indicated in the category advertisement rating field 930. A higher advertisement rating may increase the probability that an advertisement will be selected. For example, a list of advertisements may be presented to a guide in an order based at least in part on an advertisement rating associated with a category associated with a request. Using the example in FIG. 9, ‘shell gasoline 148’ is rated ‘5’, ‘sams autoparts 100’ is rated ‘3’, ‘toms used cars 121’ is rated ‘1.5’. Any rating system may be utilized within the scope of this disclosure. A rating(s) may be based on factors such as guide ratings, user ratings, provider ratings, an external database, time, proximity, profile information etc.

The category guide rating field 935 includes information of ratings of a guide(s) associated with a category. The content of the category guide rating field 930 and the category guide ID field 915 may be linked by, for example, a pointer. Any type of rating information may be indicated in the category guide rating field 935. A higher guide rating may increase the probability that a guide will be selected. For example, a list of guides may be presented to an ambassador in an order based at least in part on a guide rating associated with a category associated with a request. Using the example in FIG. 9, ‘Bob Smith’ is rated ‘4.7’, ‘Guide 1’ is rated ‘2’, ‘Guide 2’ is rated ‘2.1’, ‘Guide 3’ is rated ‘3.0’ and ‘Guide 4’ is rated ‘0’. Any rating system may be utilized within the scope of this disclosure. A rating(s) may be based on factors such as guide ratings, user ratings, provider ratings, an external database, time, proximity, profile information etc. In at least one embodiment a guide rating associated with a category is based on revenue of providers associated with requests associated with the category which are handled by the guide.

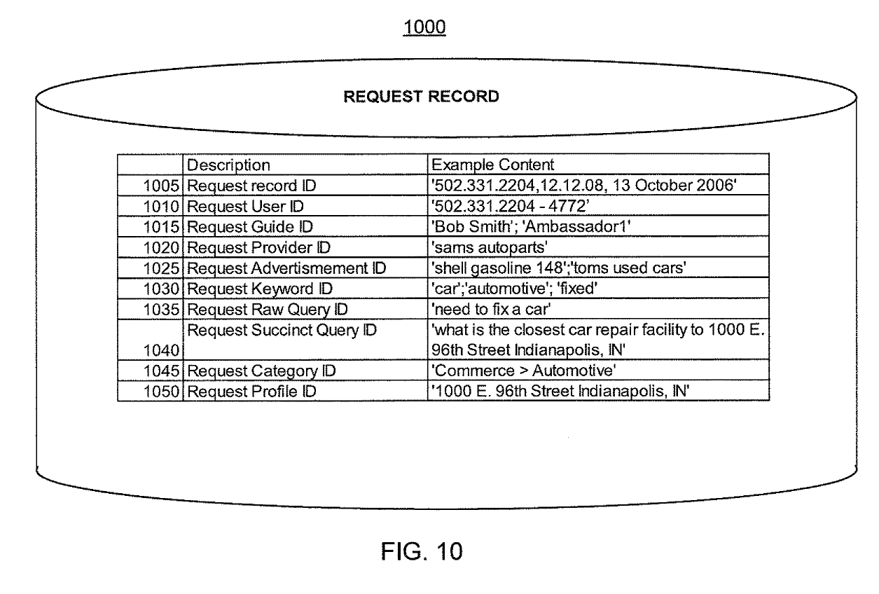

As illustrated in FIG. 10, a sample of a request record 1000, of which one or more may be associated with or resident in the search database 120 (FIG. 1), may include a request record ID field 1005, a request user ID field 1010, a request guide ID field 10151 a request provider ID field 1020, a request advertisement ID field 1025, a request keyword ID field 1030, a request raw query ID field 1035, a request succinct query ID field 1040, a request category ID field 1045, a request profile ID field 950. A request record may be used to record various activities associated with a user request. In at least one embodiment a request record is used as a container data structure which may be used to obtain information regarding a user request.

The request record ID field 1005 contains an identifier of a request, which is preferably unique and preferably used consistently. For example, in at least one embodiment, the request record ID field 1005 can include a randomly generated numerical code, and/or a text string indicating a request. A request record ID serves to distinguish a request record associated with a request from a request record associated with other request(s). Although particular examples of identifiers are described herein, other types of identifiers uniquely indicating a request(s) may be utilized without departing from the spirit and scope of the embodiments. In at least one embodiment, the request record ID includes a telephone number. A request record ID may include a username, an IM credential, an email address, etc. Using the example in FIG. 10, ‘502.331.2204,12.12.08, 13 Oct. 2006’ is the request record ID associated with the request record 1000.

The request user ID field 1010 may include an identifier of a user(s) that submitted a request. The content of the request user ID field 1010 may be used to establish communication with a user(s) based on the content of a user record such as the user record 400 (FIG. 4). Using the example in FIG. 10, the user identifier ‘502.331.2204-4772’ is the user identifier associated with the request record 1000, which may indicate that the user ‘502.331.2204-4772’ has submitted the request ‘502.331.2204,12.12.08, 13 Oct. 2006’.

The request guide ID field 1015 may include information of a guide(s) associated with a request. For example, if a request is transcribed by a first guide (i.e., a transcriber), processed by a second guide (i.e., an ambassador), and a response is provided by a third guide (searcher), an identifier of each guide may be indicated in the request guide ID field 1015. The content of the guide identifier list field 1015 may be used to establish communication with a guide based on the content of a guide record such as the guide record 500 (FIG. 5). Using the example illustrated in FIG. 10, the guides ‘Ambassador 1’ and ‘Bob Smith’ are associated with the request record 1000, which may indicate that the guides ‘Ambassador 1’ and ‘Bob Smith’ have responded to the request ‘502.331.2204,12.12.08, 13 Oct. 2006’.

The request provider ID field 1020 may include information of a provider(s) associated with a request. The content of the request provider ID field 1020 may be used to establish communication with a provider based on the content of a provider record such as the provider record 600 (FIG. 6). Using the example illustrated in FIG. 10, the provider ‘sams autoparts’ is associated with the request ‘502.331.2204,12.12.08, 13 Oct. 2006’, which may indicate that the provider ‘sams autoparts’ has been connected to the user ‘502.331.2204-4772’ responsive to the request ‘502.331.2204,12.12.08, 13 Oct. 2006’.

The request advertisement ID field 1025 may include information of an advertisement(s) associated with a request. The content of the request advertisement ID field 1025 may be used to deliver an advertisement(s) to a user based on information included in an advertisement record such as the advertisement record 1000 (FIG. 10). Using the example illustrated in FIG. 10, the advertisement ‘shell gasoline 148’, and ‘toms used cars’ are associated with the request record 1000, which may indicate that the advertisement ‘shell gasoline 148’ was transmitted to the user ‘502.331.2204-4772’ responsive to the request ‘502.331.2204,12.12.08, 13 Oct. 2006’. As shown in FIG. 10, a request may have one or more advertisements associated therewith which may be selected for presentation. For example, the request record 1000 has ‘toms used cars’ and ‘shell gasoline 148’ associated that may be presented in association with the request.

The request keyword ID field 1030 may include information of a keyword(s) associated with a request. The content of the keyword ID field 1030 may be used to select information to be associated with a request based on information included in an keyword record such as the keyword record 800 (FIG. 10). Using the example illustrated in FIG. 10, the keywords ‘automotive’, ‘car’ and ‘fixed’ are associated with the request ‘502.331.2204,12.12.08, 13 Oct. 2006’.

The request raw query ID field 1035 may include information of a raw query associated with a request. For example, text, images, audio, video and/or other media which are associated with a user query may be indicated in the request raw query ID field 1035. Using the example illustrated in FIG. 10, the text ‘need to fix a car’ is associated with the request ‘502.331.2204,12.12.08, 13 Oct. 2006’.

The request succinct query ID field 1040 may include information of a qualified query associated with a request. For example, text, images, audio, video and/or other media which are associated with a user query may be indicated in the request raw query ID field. A guide may modify a user request in order to form a succinct query based on a raw query. A succinct query may be created automatically. Using the example illustrated in FIG. 10, the text ‘what is the closest car repair shop close to 1000 E 96^{th} Street, Indianapolis, Ind.?’ is associated with the request ‘502.331.2204,12.12.08, 13 Oct. 2006’.

The request category ID field 1045 may include information of a category(ies) associated with a request A category associated with a request may be used to select other items to be associated with the request using a record such as the category record 900 (FIG. 9). A category may be associated with a request automatically and/or based on actions of a guide(s). Using the example illustrated in FIG. 10, the category ‘Commerce>Automotive’ is associated with the request ‘502.331.2204,12.12.08, 13 Oct. 2006’.

The request profile ID field 1050 may include information of a profile(s) associated with a request. A profile associated with a request may be used to select other items to be associated with the request. For example, if a location is associated with a request, geographic profile information associated with a provider, a guide, and/or other items may be used to rate the item(s) based on proximity to the location. Using the example illustrated in FIG. 10, the geographic profile ‘1000 E 96^{th} Street, Indianapolis, Ind. ’ is associated with the request ‘502.331.2204,12.12.08, 13 Oct. 2006’.

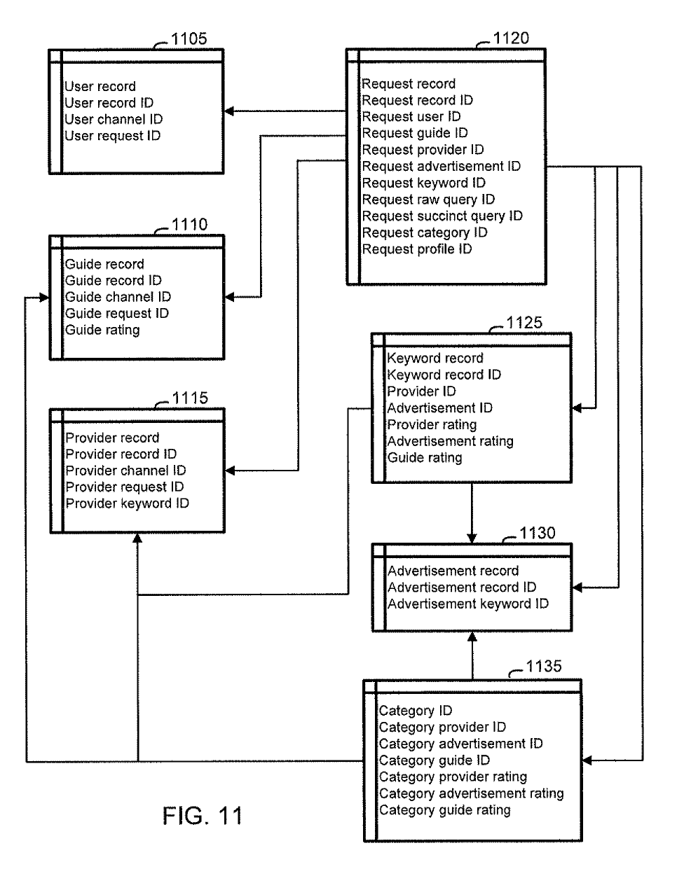

A simplified database relationship between records in the database 120 (FIG. 1) is depicted in FIG. 11. In at least one embodiment, the request record 1120 is created when a message is received from a user. A query ID, a user ID and the raw query ID are determined. The user ID in the request record 1120 points to the user record 1105. If an ambassador is required, the guide ID of the ambassador is added to the request record 1120, which may be a pointer to the guide record 1110. A keyword(s), category(ies), and a succinct query are associated with the request. A keyword ID which points to the keyword record 1125, and a category ID which points to the category record 1135 may be added to the request record 1120. If available, a profile may be associated with a request. For example, profile information associated with a user may be associated with a request submitted by the user.

A provider(s), a guide(s), an advertisement(s) and/or other information may be selected based on information indicated in a keyword record(s) 1125, a category record(s) 1135, and/or a profile(s). The guide record 1110 includes information of a guide, associated with the guide ID indicated in the request record 1120. The provider record 1115 includes information of a provider associated with the provider ID indicated in the request record 1120. The advertisement record 1130 includes information of an advertisement associated with the advertisement ID indicated in the request record 1120.

Information indicated in the selected record(s) may be used to establish communication between any of a user system, a guide system, a provider system, an advertisement server and/or the search system 130. In a preferred embodiment, communication sessions are controlled by the search system 130 for the purposes such as tracking usage and/or compensation.

While the relationships in the database have been depicted using a limited number of user, guide, provider, advertisement, keyword, category and request records, any number of records required to operate the embodiments may be utilized by the search system 130.

A ranking of guides, providers, and advertisements based on a keyword, a category, and a profile is illustrated in FIG. 12. The keyword record 1205 indicates that ‘Bob Smith’ is the highest rated guide, ‘sams auto parts’ is the highest rated provider, and ‘shell gasoline 148’ is the highest rated advertisement for the keyword ‘repair’. The category record 1210 indicates that ‘Guide 2’ is the highest rated guide, ‘bills shell station’ is the highest rated provider, and ‘shell gasoline 148’ is the highest rated advertisement for the category ‘Commerce>Automotive’. The profile record 1215 indicates that ‘Guide 2’ is the highest rated guide, ‘sams auto parts’ and ‘bills shell station’ are the highest rated providers, and ‘sams auto parts 100’ is the highest rated advertisement for the profile ‘Zip Code 46032’. Any combination of ratings and/or rankings of any items may be used to select an item to be associated with a request. Items which may be selected include search resources, which may be provided to a user(s) and/or a guide(s), search result(s), profile(s), category(ies), keyword(s), succinct query(ies) and/or other types of information indicated in the search database 120.

While the selection of a guide, a provider and an advertisement have been described using a relationship based on keywords, categories and profiles, other types of information associated with a request may be utilized to select a guide(s), a provider(s) and/or an advertisement. For example, characteristics of a user, guide or provider such as demographic information, geographic information, personal interests, political persuasion, personality traits, etc., which may be indicated in the database 120 (FIG. 1), may be employed to select a guide, a provider, or an advertisement to be associated with a user request using methods such as those described in the related provisional application U.S. Ser. No. 60/980,010 previously mentioned.

A user record, a guide record, a provider record, an advertisement record, a keyword record and/or a request record may include additional fields and any field(s) may be blank. For example, a user record may include information which may be used to provide payment to the search system 130, information which may be used to select a guide(s), a provider(s), an advertisement(s), and/or other information, etc. For example, a guide record may include information which may be used to provide compensation to a guide, information which may be used to select a guide(s), a provider(s), an advertisement(s), and/or other information, etc. For example, an advertisement record may include information regarding delivery of an advertisement, a provider of an advertisement, etc. For example, a keyword record may include information of a category(ies), a guide(s), a search resource(s), etc. which may be associated with a keyword.

While the selection of a guide and/or provider and/or advertisement has been illustrated using a particular data structure(s), other equivalent types of data structures may be used within the scope of the embodiments described herein. The selection of a guide, a provider, and/or an advertisement is not limited to the particular example illustrated herein. One of ordinary skill in the relevant art will immediately recognize that other selection criteria and mechanisms may be utilized within the spirit and scope of the embodiments herein.

In at least one embodiment, historical information may be utilized to select a guide(s) and/or a provider(s) and/or an advertisement(s). For example, if a user previously submitted a search request for information regarding restaurants, and was provided with one or more search result(s) relating to that query, a guide and/or a provider associated with information associated with a previous search request may be more likely to be selected. Likewise, if a user previously communicated with a provider(s) associated with a request, the provider may be less likely selected.

An embodiment of tools for creation of a vetted query is illustrated below. The embodiment may be used by an ambassador to process a user request.

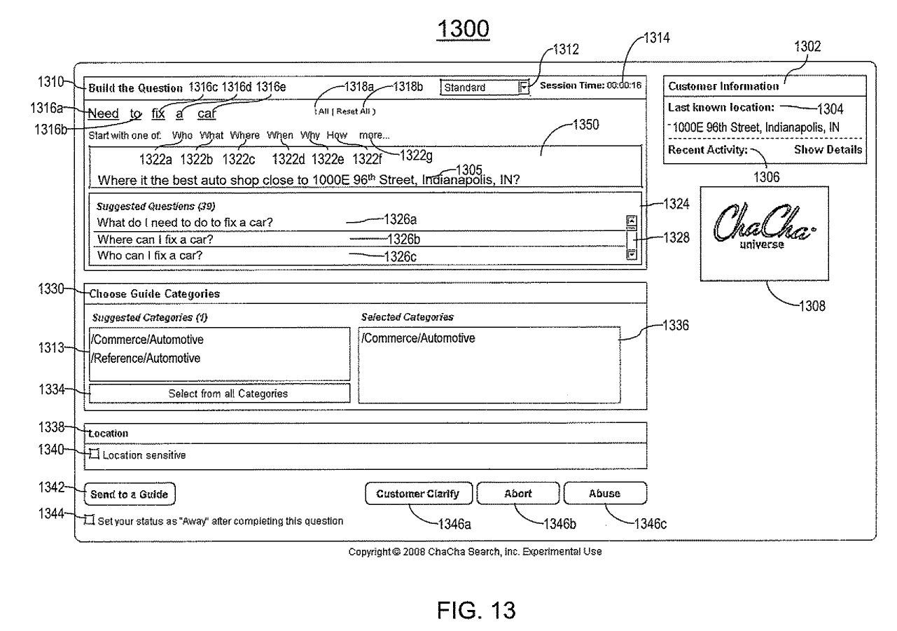

As illustrated in FIG. 13, the GUI 1300 includes a customer information window 1302, an advertisement window 1308, a question (query) building window 1310, a guide category selection window 1330, a location selection window 1338, a ‘Send to Guide’ button 1342, a status selection tool 1344, and user controls 1346.

The customer information window 1302 may include the last known location indicator 1304 and the recent activity indicator 1306. The last known location indicator 1304 may display a user's most recent geographic location. This information may be used by the search system and/or a guide to facilitate provision of a response to a user that is relevant to a certain location, area, region, etc. The recent activity indicator 1306 may display information of a user's previous use of the search system and other context information which may be relevant to a request. For example, the recent activity indicator 1306 may display a user's previous query(ies), responses by the search system, any advertisements that may have been provided to the user, previous search results, profile information of a user, etc. The advertisement window 1308 may display a selected advertisement based on content of the GUI 1300, which may be transmitted to a user based on actions of a guide. For example, an ambassador may select an advertisement that may be provided to a user while a search is being conducted.

Prior to a providing a response to a query, an initial guide or ambassador may use the GUI 1300 to develop a well-formed or structured query from a user submitted query, categorize the query, provide a database response, ask a user for clarification, qualify a request, report abuse to the search system, etc. before passing (forwarding) the well-formed query on to an additional guide(s). The question (query) building window 1310 may include a query type control 1312, a session time indicator 1314, query segment selection tools 1316, query segment controls 1318, a query building text box 1320, interrogative word selection controls 1322, a suggested questions window 1324, suggested question indicators 1326, and a scrolling control 1328.

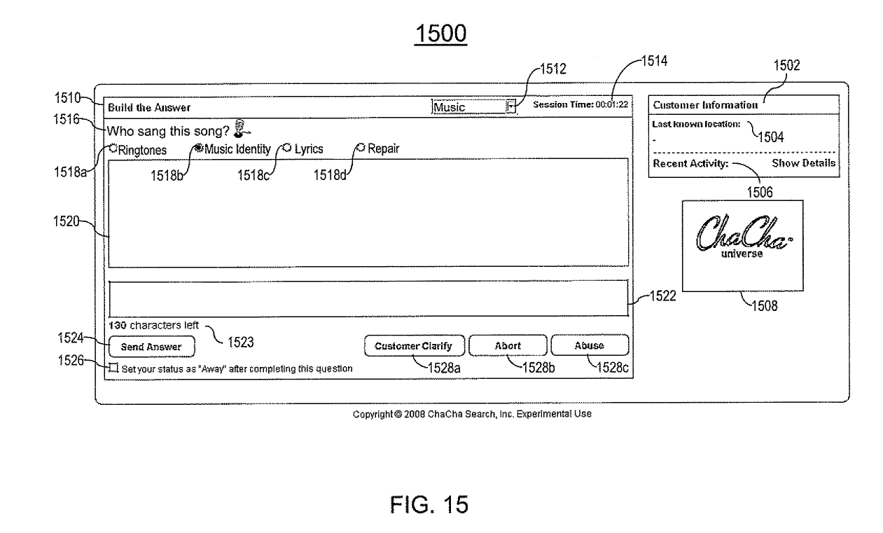

The question (query) building window 1310 may be used by a guide to develop a well-formed query based upon a user submitted query. For example, as illustrated in FIG. 13, the query ‘Need to fix a car’ has been submitted to the search system 130 (FIG. 1). A guide may use the query type control 1312 to classify a response that may be provided in return to an incoming query. For example, an incoming query may be classified as a ‘Standard’ in which a guide may continue through the GUI 1300 building a well-formed query in response to the user submitted request. Alternatively, the query type control 1312 may include the option ‘Music’, which if selected by a guide, may result in the GUI 1500 as shown in FIG. 15 being presented. Any number of options may be provided in the query type control. For example, if a web service(s) exist which may be used to respond to a user request, a guide may be presented with a GUI which may be used to prepare a request for processing by the web service. The session time indicator 1314 may display the amount of time that is being spent by a guide using the GUI 1300.

The query segment selection tools 1316 may allow a guide to select any number of the initial segments of a user submitted query to include in a well-formed query that may be assembled in the query building text box 1320. For example, a guide may choose to select only the subject of a user submitted query, such as the word ‘car’ illustrated in FIG. 13. If a guide selects the query segment selection tool 1316b corresponding to the word ‘to’ then the word ‘to’ would be added to the query building text box 1320. To select all segments of a user submitted query, the query segment controls 1318 may include a ‘Select All’ control 1318a, and to deselect all segments of a user submitted query, the ‘ResetAll’ control 1318b may be included.

The interrogative word selection controls 1322 may include any number of interrogative words that a guide my select in assembling a well-formed query in the query building text box 1320. For example, if a query is submitted to the search system by a user in a declarative form, a guide may choose to start a well-formed query with a word such as ‘Who’ 1322a, ‘What’ 1322b, etc.

The query building window may include the suggested questions window 1324. The suggested questions window 1324 may include any number of suggested question indicators 1326 contained in the search system database. The suggested questions 1326 may be provided by the search system database as associated with the user submitted query based on any of the words or segments contained in the user submitted query. For example, as illustrated in FIG. 13, the search system database has returned the suggested questions, ‘What do I need to fix a car?’, ‘Where can I fix a car?’ and, ‘Who can fix a car?’ based on the user submitted query, ‘Need to fix a car’. A guide may use the scrolling control 1328 to view any additional suggested questions that may not be displayed. A guide may select a suggested question indicator 1326 by clicking or otherwise selecting the question. If a guide selects a suggested question indicator 1326, the selected question is entered into the query building text box 1320. Alternately a guide may enter a query directly in the query text box 1350 as indicated by the succinct query 1305.

The category selection window 1330 may contain the suggested categories window 1332, the categories selection control 1334, and the selected categories window 1336. The suggested categories window 1332 may display any categories determined by the search system to be a potential category associated with the user submitted query in an order based on ratings of the category(ies). For example, as illustrated in FIG. 13, the categories, ‘/Commerce/Automotive’ and ‘/Reference/Automotive’ are displayed in the suggested categories window 1332 as a potential ‘match’ to the user submitted query, ‘need to fix a car’. A guide may use the categories selection control 1334 to select any category that may not be contained in the suggested categories window 1332. If a guide selects a category from the suggested categories window 1332, such selection may be indicated by the addition of the suggested category to the selected category window 1334 as illustrated by the category ‘/Commerce/Automotive’ in the selected category window 1334.

The location selection window 1338 may include a location selection control 1340. If a guide determines that a user submitted query may be location related, a guide may select the location selection control 1340 which may affect selection of a guide and/or other items responsive to a request.

The ‘Send to a Guide’ button 1342 may be selected if a guide has completed the assembly, formation, selection or otherwise of a well-formed query, and completed categorization of the query, or other operations as may be determined by the search system. A guide may select the ‘Send to Guide’ button to transfer the vetted query to an additional guide(s), or to the search system that may in turn provide an answer to a user request based on the vetted query. A guide may alternatively select from the user controls 1346. The ‘Customer Clarify’ user control 1346a may be selected to obtain clarification of a user submitted query and/or obtain additional information from a user that may be advantageous in responding to a user request. The ‘Abort’ user control 1346b may be used to cancel the current session and close the GUI 1300. The ‘Abuse’ user control 1346c may be used to report abuse or other prohibited behavior of a user to the search system. In addition, a guide may select the status selection tool 1344 to indicate that the guide desires to change his or her status to ‘Away’ and not accept additional queries after completion of the current session.

An exemplary graphical user interface for a guide to select a provider of good(s), service(s) and/or information pertaining thereto is illustrated in FIG. 14. A similar interface may be utilized to perform an information search responsive to a user request. As the user interface, and the information associated with a request may be similar to that used to select a guide and/or search result(s) responsive to a search request, a guide might select a provider of goods and/or services based on information associated with a previous search request. For example, a user may have previously submitted a request for search services, and subsequently may decide to purchase a product(s) and/or service(s) associated with a previous search request. In such an instance, information associated with a previous search request(s) may be presented to a guide, which may assist in selecting a provider, transmitting information to a provider, and/or selecting an advertisement(s).

As illustrated in FIG. 14, the provider selection GUI 1400 may include a user request box 1405, user request media controls 1407, request information controls 1410, a provider selection control 1420, an advertisement selection control 1440, a user dialogue section 1450 and a “Transfer” button 1460.

The user request box 1405 may include information of a request submitted by a user. While the user request box 1405 indicates a text query, other information may be included to indicate a user request. The user request media controls 1407 allow a guide to review media associated with a user request. The user request audio control 1407a may allow a guide to listen to an audio recording(s) associated with a user request. The user request video control 1407b may allow a guide to view an image(s) and/or video(s) associated with a user request. Any information associated with a user request indicated in the database 120 (FIG. 1) may be presented to a guide using the provider selection GUI 1400.

The request information controls 1410 allow a guide to associate information with and/or review information associated with a request. Using the example in FIG. 14, the keyword ‘home’ (from the user request box 1405) as illustrated in the request information control 1410a may be associated with a particular location based on information indicated in the database 120 (FIG. 1). A guide may have associated the keyword(s) ‘automotive’ and the category /Commerce/Automotive with the user request as indicated in the request information controls 1410b and 1410c. A guide may select the functionality ‘location sensitive’ (for example, using 1340 in GUI 1300) to rank providers based on proximity to a requested location as indicated in the request information control 1410d. A guide may identify particular information provided by a user associated with a request which may assist in selecting a provider such as ‘1997 Honda Accord’ as indicated in the request information control 1410e. Any number of request information controls may be provided in order that a guide may provide and/or view information associated with a request. Elements of the request information controls 1410 may be populated based on information indicated in the database 120 (FIG. 1). The request information controls 1410 may be implemented as typing boxes, drop-down lists, or any other interface which may allow a guide to provide information to assist in selecting a provider.

The provider selection window 1420 allows a guide to view information of provider(s) of good(s) and/or service(s) and/or to connect a user to a provider. Information associated with a user request using the request information controls 1410 may modify the content of the provider selection window 1420. The provider selection window 1420 may include provider indicators 1425 such as a name or other identifier, and provider connection controls 1430. The provider indicators 1425 may indicate a name or other information regarding a provider and may allow a guide to communicate with a provider. The provider connection controls 1430 may allow a guide to connect a provider to a user. Using the example illustrated in FIG. 14, the provider indicator 1425a identifies ‘Sam's Auto Parts’ as the top ranked provider. The provider indicator 1425b identifies ‘Bill's Shell Station’ as the second ranked provider. The provider indicator 1425c identifies ‘Manny and Moe's’ as the third ranked provider. The provider connection control 1430a may allow a guide to make a voice connection between a user and the provider ‘Sam's Auto Parts’. The provider connection control 1430b may allow a guide to make a voice connection between a user and the provider ‘Bill's Shell Station’. The provider connection control 1430c may allow a guide to make a voice connection between a user and the provider ‘Manny and Moe's’. Information associated with a user request may also be transmitted to a provider using communication systems such as email, SMS messaging, a POST or other web-based communication, etc. For example, a guide may include information from a user profile in a request transmitted to a provider without explicit knowledge of the information, and/or the need to manually enter the information.

The advertisement selection controls 1440 allow a guide to view an available advertisement(s) and select an advertisement to be transmitted to a user. Information associated with a user request using the request information controls 1410 may modify the content of the advertisement selection controls 1440. The advertisement selection controls 1440 may include an indication of an advertisement and may allow a guide to select an advertisement to be transmitted to a user. Using the example illustrated in FIG. 14, the advertisement selection control 1440a may allow a guide to select the advertisement ‘Shell Gasoline 148’ to be transmitted to a user system. The advertisement selection control 1440b may allow a guide to select the advertisement ‘Sam's Auto Parts 100’ to be transmitted to a user system. The advertisement selection control 1440c may allow a guide to select the advertisement ‘Tom's Used Cars 111’ to be transmitted to a user system. Multiple advertisement selection controls may be provided in the provider selection GUI 1400. One or more advertisement(s) may be delivered to one or more user system(s) based on information obtained using the provider selection GUI 1400. As illustrated in FIG. 14, advertisement(s) presented for selection via the advertisement selection controls 1440 for transmission to a user are not limited to advertisement of provider(s) those listed in the provider selection controls 1420.

The user dialogue window 1452 may allow a guide to conduct a dialogue with a user. The dialogue may be conducted using voice, text-to-speech, speech-to-text, IM, email, SMS, MMS, EMS and/or any combination of communication services. The user information window 1450a may include any information transmitted by a user system(s). For example, verbal communication by a user may be recorded, and a guide may be able to listen to a user request by activating a control such as the user playback controls 1455. The guide information section 1450b may indicate information sent to a user by a guide. For example, if the guide is communicating with a user on a voice connection using text-to-speech, text sent by a guide may be indicated in the guide information section 1450b. A guide may enter text using the guide text entry box 1450c.

The user playback controls 1455 may include a previous control 1455a, a play/pause control 1455b, and a next control 1455c. The previous control 1455a may allow a guide to select a previous user utterance, the next control 1455c may allow a guide to select a subsequent user utterance, and the play/pause control 1455b may allow a guide to play and/or pause playback of a user utterance. While GUI 1400 is described using certain controls, the disclosure is not limited to any particular interface controls. Likewise other types of media such as images and/or video provided by a user may be presented to and controlled by a guide.

The “Transfer” button 1460 may allow a guide to transfer a user request to another guide. Transfer of a request may affect the compensation and/or rating(s) of a guide.

While a voice connection has been used for the purposes of illustration, the provider selection GUI may allow any type of communication session(s) to be established between a user(s) and a provider(s) which may be accomplished using information indicated in the database 120.

Using the embodiments described herein, a user may submit a request(s) to a human-assisted search system, which may include a request for good(s) and/or service(s), and be connected to a provider of good(s) and/or service(s) using the assistance of a human searcher or guide. A request is assigned to a guide(s), who may determine the type of good(s) and/or service(s) the user intends to obtain, identify a provider of good(s) and/or service(s) and establish a communication session between a user and a provider of good(s) and/or service(s). The search system 130 (FIG. 1) may be compensated by a user and/or a provider. An advertisement(s) may be provided to a user(s) as a source of revenue for the search system 130.

A database of communication information associated with a user(s), a guide(s) and/or a provider(s) is utilized to allow a communication session(s) to be established between a user(s), a guide(s) and/or a provider(s). Communication may be enabled between any user system, guide system, and/or provider system which may include a desktop, laptop, server, or other computer, a mobile phone, a landline phone, a PDA, a smart phone, or any other device which may be used to submit a request to the search system 130 and/or receive a response. One or more user systems, guide systems, provider systems and/or devices may be utilized to obtain information of a user request and/or to provide a response and/or a connection to a provider(s) of goods and/or services.

An exemplary GUI for directing a user request to a web service is illustrated in FIG. 15. The GUI 1500 may be used by a guide to direct a request to a service which may respond to the request. For example, a request may be associated with the ‘Music’ category based on keyword(s) of a request, or information provided by a transcriber, etc.

As illustrated in FIG. 15, a guide has selected the ‘Music’ selection of the type control 1512 resulting in the display of the GUI 1500. The GUI 1500 may be used by a guide to assemble an answer to a user submitted query that the guide has recognized as conversational in nature. As illustrated in FIG. 15, the GUI 1500 includes a customer information window 1502, an advertisement window 1508, an answer building window 1510, a query type control 1512, a session time indicator 1514, a user submitted query 1516, music type selection tools 1518, a provided response display window 1520, an answer building text box 1522, a ‘Send Answer’ button 1524, a status selection tool 1526, and user controls 1528.

The customer information window 1502 may include the last known location indicator 1504 and the recent activity indicator 1506. The last known location indicator 1504 may display a user's most recent geographic location. This information may be used by the search system and/or a guide to facilitate provision of a response to a user that is relevant to a certain location, area, region, etc. The recent activity indicator 1506 may display information of a user's previous use of the search system 130 (FIG. 1) and other context information which may be relevant to a request. For example, the recent activity indicator 1506 may display a user's previous query(ies), responses by the search system, any advertisements that may have been provided to the user, previous search results, profile information of a user, etc. The advertisement window 1508 may display a selected advertisement based on content of the GUI 1500, which may be transmitted to a user based on actions of a guide. For example, an ambassador may select an advertisement that may be provided to a user while a search is being conducted.

The answer building window 1510 displays the user submitted query 1516. The music type selection tools 1518 may be selected by a guide based on a guide's interpretation of the user submitted query 1516. For example, as illustrated in FIG. 15, the user submitted query, ‘Who sang this song?’ may be interpreted to be a music query that elicits an answer of the type, ‘Music Identity’ of the type selection tool 1518b. Alternatively, a user submitted query may be better answered by a music type of ‘Ringtones’ 1518a, ‘Lyrics’ 1518c, or ‘Repair’ 1518d. If a guide selects any of the music type selection tools 1518, individual responses from one or more providers may be indicated in the provided answer display window 1520. A guide may select any response displayed in the provided answer display window 1520 to submit as a response to a query. Alternatively, a guide may use any part of a provided answer and/or his or her own text as a response to a user submitted query by entering such text into the answer building text box 1522. The text remaining indicator 1523 may display the number of characters a guide has remaining to provide in the answer building text box 1522 based on a total number of characters and/or words that a guide is allowed to use in building his or her answer. The number of characters may be based on a user device constraint, or any system constraints.

The ‘Send Answer’ button 1524 may be selected if a guide has completed the assembly, formation, selection or otherwise an answer in response to the user submitted query. A guide may alternatively select from the user controls 1528. The ‘Customer Clarify’ user control 1528a may be selected to obtain clarification of a user submitted query and/or obtain additional information from a user that may be advantageous in forming an answer. The ‘Abort’ user control 1528b may be used to cancel the current session and close the GUI 1500. The ‘Abuse’ user control 1528c may be used to report abuse or other prohibited behavior of a user to the search system. In addition, a guide may select the status selection tool 1526 to indicate that the guide desires to change his or her status to ‘Away’ and not accept additional queries after completion of the current session.

A guide may be assigned to a user request based on criteria determined by the search system 130. A guide may transfer a user request to a different guide. For example, an ambassador guide may transfer a request to a searcher, who may provide a search result(s) and/or other information to a user.

A provider of good(s) and/or service(s) and an advertisement(s) may be associated with a database indicated in the search database 120 (FIG. 1). A provider of good(s) and/or service(s) may be selected based on information associated with a user request and/or information associated with a provider. An advertisement may be selected based on information associated with a user request and/or an advertisement.

Rating(s) of a guide(s) and/or a provider(s) and/or an advertisement may be obtained. A rating(s) of a guide(s), a provider(s) and/or an advertisement(s) may be recorded and utilized to select a guide(s), a provider(s) and/or an advertisement(s).

As previously discussed, it is highly desirable that a user be provided with a convenient, secure way for paying for a service(s) and/or item(s). For many transactions, it is desirable that such payments may be aggregated. Users may prefer a package price for a service (e.g., unlimited text and/or media messaging) for a monthly price over a cost per message. Likewise, for many transactions such as ringtones or images, etc. the cost of a premium SMS is mainly associated with bandwidth and thus a carrier may charge a high percentage of the transaction. This would be prohibitive for high-value transactions (>$20) as the price would not be competitive with on-line transactions.

In light of this, it is desirable to have a system whereby a payment service associated with a provider of communication services may be used to pay for any transaction associated with an information search service. A payment service might be associated with any service which can transmit an MT or receive an MO SMS message which will be billed to an account associated with a user service account. For example, a mobile phone services account may be used to provide payments. An embodiment of the system is illustrated below.

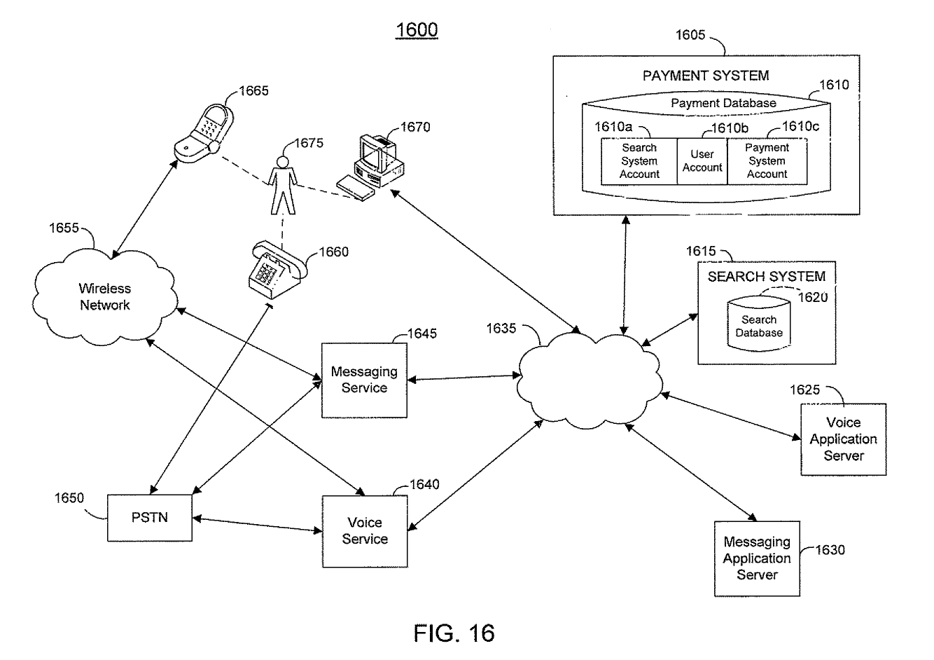

As illustrated in FIG. 16, system 1600 is provided. The system may include a payment system 1605, a payment system database 1610, a search system 1615, a search database 1620, a voice application server 1625, a messaging application server 1630, a network 1635, a voice service 1640, a messaging service 1645, a Public Switched Telephone Network (PSTN) 1650, a wireless network 1655, a voice enabled user device 1660, a user wireless device 1665, and a user system 1670.

The payment system 1605 provides payment services to users such as a user 1675. The payment system 1605 may be implemented by any provider of payment services, such as the payment service of a communication services provider. A communication service provider may include a provider of wireless and/or wired communications, internet services, or other services. As illustrated in FIG. 16, the payment system 1605 includes the payment system database 1610 which may contain information relating to billing, usage of services, and other information regarding users such as the user 1675. The payment system database 1610 may include information including a search system account 1610a, a user account 1610b, a payment system account 1610c, and other records which may be processed during operation of the embodiments as will be described in detail further herein below. The payment system 1605 may be a separate system or may be part of another system such as the voice service 1640 and/or the messaging service 1645.

The search system 1615 provides information search services to users such as the user 1675. The search database 1620 may include information regarding users, searchers, search result(s), and other records as described herein above which are processed during operation of the embodiments as will be described further herein below.

The voice application server 1625 provides a voice based interface including between the search system 1615 and the voice service 1640. Software operative on the voice application server 1625 provides two-way communication between the search system 1615 and the voice service 1640. The voice application server 1625 may be a separate system or may be included in the search system 1615 or any other suitable device in the system 1600. The voice application server 1625 may include hardware and/or software required to convert speech to text and/or text to speech. It may further include an application which may allow the search system to recognize the originating device for a message(s), and return messages by voice, messaging such as SMS, MMS, EMS, IM, email, etc. to the originating device. In at least one embodiment, the voice application server may include human transcribers who may convert spoken queries to text which may be recognized by the search system 1620.

The messaging application server 1630 provides messaging including based interface between the search system 1615 and the messaging service 1645. Software operative on the messaging application server 1630 provides two-way communication between the messaging service 1630 and the search system 1615. A messaging service may include short messaging service (SMS), enhanced messaging service (EMS), multimedia messaging service (MMS), email service, Instant Messaging (IM) service, etc. within the scope of the embodiments.

Software and/or hardware operative on the messaging application server 1630 may process messages received from the messaging service 1645 in order that they may be processed by the search system 1615, and likewise may convert a message from the search system in order that it may be transmitted to the messaging service 1645. For example the messaging application server 1625 may appear as a short-code or telephone number which may receive and send SMS, MMS, or EMS messages. The messaging application server 1630 may appear to be an IM ‘buddy’ by implementing a programmatic interface to the IM service. Similarly the messaging application server 1630 may appear to be a mail server implement in POP/SMTP or Outlook or other email protocols.

As previously explained with respect to FIG. 1, the databases 1620, 1610, and the systems 1605, 1620, 1625, 1630, 1645, 1640 may be implemented using hardware and software systems well known in the relevant art. Multiple servers, database systems, etc. may be used as required to implement the embodiments.

The network 1635 may be a global public network of networks (the Internet) or consist in whole or in part of one or more private networks and communicatively couples the elements of the system 1600 such as the payment system 1605, the payment database 1610, the search system 1615, the search database 1620, the voice application server 1625, the messaging application server 1630, the voice service 1640, the messaging service 1645, and the user system 1670 with the other components of the system.

The user system 1670 may include, within the scope of the disclosure, any device through which a user or information seeker can submit a search request to and/or receive a search result(s) from the search system 1615. In one embodiment, an information seeker computer system may be a device configured for connection to a network and may run web browser software. An information seeker computer system may be a laptop, personal data assistant, desktop PC or Mac®, a workstation or terminal connected to a mainframe, or a smart phone, etc. within the scope of the disclosure.

The voice enabled user device 1660 may include a landline phone, a mobile phone, a VoIP device or any other device whereby a user may submit a voice query to the search system 1615 via the network 1635. The user device 1665 may include a cellular phone, a smart phone, a PDA, a mobile PC, or any other device whereby a user may submit a search request to the search system 1615. The user device 1665 is any device which can transmit and/or receive messages such as SMS, EMS, and MMS, email, IM, etc.

The voice service 1640 provides voice based communication services to users such as the user 1675 via the PSTN 1650, the wireless network 1655 and/or the network 1635. The voice service 1640 may be a separate system, and/or may be included in a system such as the payment system 1605 or the search system 1615.

The messaging service 1645 provides messaging based communication services to users such as the user 1675 via the PSTN 150, the wireless network 1655 and/or the network 1635. The messaging service 1645 may be a separate system, or may be included in a system such as the payment system 1605 or the search system 1615.

The wireless network 1655 may be one or more wireless networks utilizing any radio-based communication system such as GPRS, TMDS, EDGE, CDMA, WiFi, WiMax, etc.

After being presented with the disclosure herein, one of ordinary skill in the art will readily appreciate that the systems of the embodiments can be any type of viable computer systems known in the art.

While only one messaging service and one messaging application server are illustrated in FIG. 16, multiple messaging services using multiple messaging application servers are envisioned. While only one voice service and one voice application server are illustrated in FIG. 16, multiple voice services using multiple voice application servers are envisioned. While only one user is depicted in FIG. 16, multiple users, user devices, and user systems are envisioned. While only one payment system is illustrated in FIG. 16, multiple payment systems may be utilized within the scope of the disclosure.

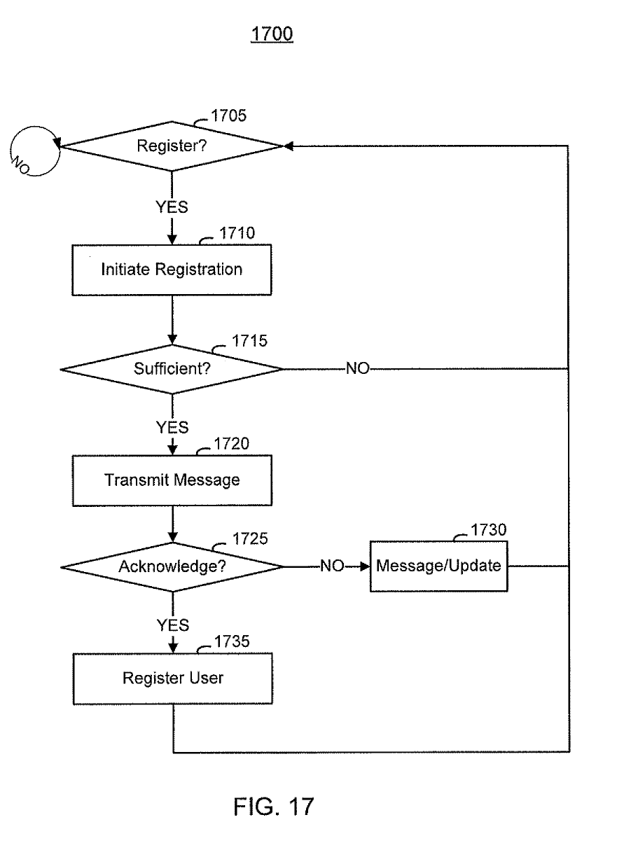

As illustrated in FIG. 17, a process 1700 for associating a payment service which may be used to provide payment with an identifier of a user is provided. For example, the process 1700 may be used to determine a mobile phone number which is associated with a payment account which is to be used to provide payment services for transactions effected using the search system 1615.

In operation 1705 a determination is made as to whether a request for registration is received. If in operation 1705 it is determined that a request for registration is not received, control remains at operation 1705 and process 1700 continues to wait. If in operation 1705 it is determined that a request for registration is received, control is passed to operation 1710 and process 1700 continues.

A request for registration may be received in various ways. In at least one embodiment, a request for registration may be generated by a user activating a link which directs a browser of a user device to a web page provided by the search system 1615 (FIG. 16). In at least one embodiment, a registration request is received when a request for search service(s) is received by the search system 1615 using a messaging service such as the messaging service 1645. In at least one embodiment, a request for registration may be received when a voice based search request is received by the search system 1615 using a voice service such as the voice service 1640. For example, if a user has not used the search service previously, a user may be invited to register with the search service by voice, web, IM, SMS, EMS, MMS or email.

In operation 1710 (FIG. 17) a registration process is initiated. Information necessary to associate a payment account such as the user account 1610b (FIG. 16) with a user identifier (ID) and an identifier of the payment account is obtained. In at least one embodiment, a user telephone number associated with a mobile service provider is obtained. A user may be presented with terms of service, and other information relating to a search service(s). A user may be required to acknowledge acceptance or rejection of terms of service. A message may be transmitted from the search system 1615 to the payment system 1605 to determine whether a telephone number associated with a voice based search request is included in the payment database 1610, and/or to obtain information from the payment system 1605 which may be required to initiate registration. An identifier of a user such as a telephone number and an identifier of a user payment account such as a user telephone service account number are associated and information of the association is recorded in the search database 1620 and/or the payment database 1610. The payment database 1610 and the search database 1620 are updated, control is passed to operation 1715 and process 1700 continues.

In operation 1715 a determination is made as to whether a user has provided sufficient information to initiate registration. If in operation 1715 it is determined that a user has not provided information required to initiate registration, control is passed to operation 1705 and process 1700 continues. If in operation 1715 it is determined that a user has provided information required to initiate registration, control is passed to operation 1720 and process 1700 continues.

Registration information may be provided in various ways. A user may provide registration information using a web form provided by the search system 1615 (FIG. 16). Information required to initiate registration may be provided by a provider of services such as the messaging service 1645, the voice service 1640 and/or the payment system 1605. For example, if a user opts-in with the user's phone service provider, the service provider may provide registration information to the search system 1615. A user may provide information to initiate registration in a text message, an email message and/or an Instant Message (IM), using a fax, regular mail, etc. Information required to initiate registration may be provided in a request for search services. In at least one embodiment, a phone number associated with a text or voice message may be the information required to initiate registration.

In operation 1720 a message is transmitted to a user device associated with the identifier of a payment account identified in operation 1710. In at least one embodiment, the message is a text message and/or other mobile message, the payment account is a mobile phone service account and the device is a text enabled mobile phone or other text enabled device associated with the mobile phone service account. For example, a text message may be sent to a telephone number responsive to a text or voice based request for search services from the phone number. A transmitted message may contain information required to complete a registration process. For example, a URL which directs a browser of a user device to a web page may be provided, information required to complete registration using text messaging may be provided, or other information may be provided. In at least one embodiment, information regarding a password, user login and/or required content of an acknowledgement message may be transmitted to a user. The message may be a voice message. For example, a user may be requested to provide information verbally, or via a voice interface. Control is passed to operation 1725 and process 1700 continues.

In operation 1725 a determination is made as to whether a user acknowledges a message transmitted in operation 1720. If in operation 1725 it is determined that a user does not acknowledge a message transmitted in operation 1720, control is passed to operation 1730 and process 1700 continues. If in operation 1725 it is determined that a user does acknowledge a message transmitted in operation 1720, control is passed to operation 1735 and process 1700 continues.

The determination in operation 1725 may be made based on various criteria. In at least one embodiment, a text message from a user may be used to determine if a user acknowledges a message transmitted in operation 1720. In at least one embodiment, a user may be required to provide information indicated in a message transmitted in operation 1720 in order to acknowledge the message. For example, a user may be required to reply to a message with a password, or other security information. Receipt of a message with specific content such as “YES”, a password, etc. may be used to determine that a user acknowledges a message transmitted in operation 1720. Receipt of a message with specific content such as “NO” or “DECLINE” may be used to determine that a user does not acknowledge a message. In at least one embodiment, a user may be determined not to have acknowledged a message if a time period has elapsed since the message in operation 1720 was transmitted. A voice reply from a user may be used to make the determination in operation 1725.

In operation 1730 a message may be transmitted to a user device to indicate that a registration acknowledgement has not been received. In at least one embodiment the message is a text message. In at least one embodiment, the message is a voice message. In at least one embodiment, the message is an email. In at least one embodiment, the message is an Instant Message. Any or all communication service(s) or method(s) associated with a user identifier may be used to transmit a message, indicating that a registration acknowledgement has not been received, to a user. Information indicating that a user has not completed a registration process may be recorded in association with an identifier of a user. For example, a user telephone number may be recorded in the search database 1620 with an indicator that a registration acknowledgement has not been received. Such information may be used to determine if a user is eligible to receive a search service(s). The search database 1620 (FIG. 16) is updated, control is passed to operation 1705 and process 1700 continues.

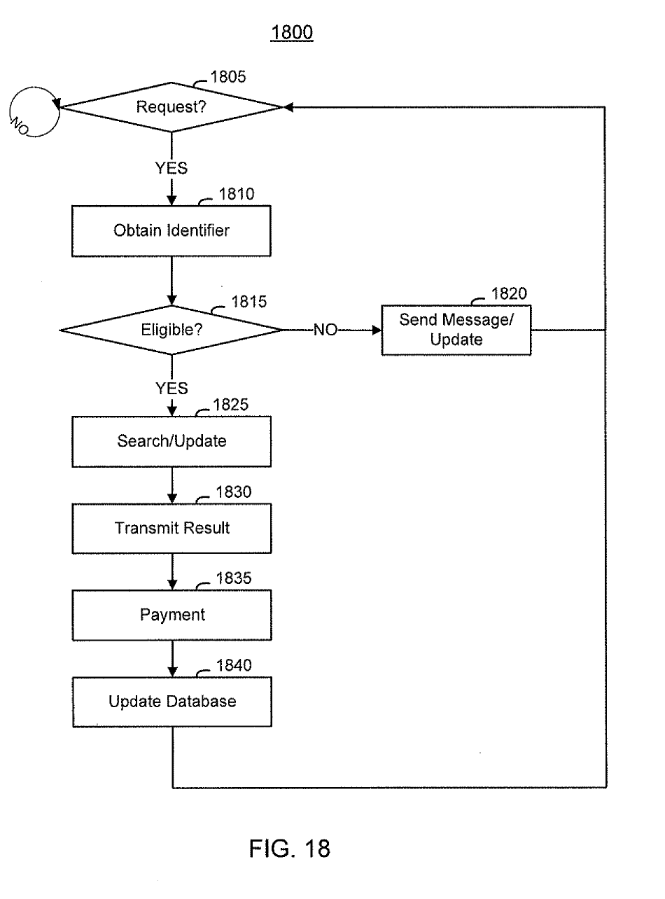

In operation 1735 a user registration process is completed. A message may be transmitted to a user to indicate that the registration process has been completed and/or that a user may utilize a search service(s). In at least one embodiment, the message is a text message. In at least one embodiment, the message is a voice message. In at least one embodiment, the message is an email. In at least one embodiment, the message is an IM. Any communication service or method associated with a user identifier may be used to transmit a message, indicating that a registration acknowledgement has been received, to a user. A message may be transmitted to a provider of messaging services such as the messaging service 1645 (FIG. 16) to indicate that a user has opted-in or registered with the search system 1615 and may accept a transaction such as an MT or MO transaction associated with a search service(s). A message is transmitted to the payment system 1605 to indicate that a user has registered with the search system 1615. Such information may be used to provide payment to a provider of search service(s), the messaging service provider and/or other service provider(s), as described further herein with respect to FIG. 18. Information indicating that a user has completed a registration process and/or that a payment account may be used to pay for services and/or items may be stored in association with an identifier of the user. The search database 1620 is updated, the payment system database 1610 is updated, control is passed to operation 1705 and process 1700 continues.

Using the process 1700 a user may associate an identifier of a user such as a telephone number with a payment account such as a mobile phone service account and indicate that the account may be used to pay for services and/or items by transmitting a message to and/or receiving a message from a mobile phone number as further described herein with respect to FIG. 18. As a user phone number may be the information required to initiate registration in operation 1710, and an acknowledgement in operation 1725 may be a verbal acceptance, and/or may be done as part of establishing a payment account; the association of a payment account, which may be used to pay for search service(s), with a user identifier may be done with little effort by a user but my provide sufficient assurance to the payment service provider that charges incurred are contractually binding.

As illustrated in FIG. 18 a process 1800 for obtaining payment from a user is provided.

In operation 1805 a determination is made as to whether a request is received. If in operation 1805 it is determined that a request is not received, control remains at operation 1805 and process 1800 continues to wait. If in operation 1805 it is determined that a request received, control is passed to operation 1810 and process 1800 continues. In at least one embodiment, the request is a request for voice (speech) based search service(s). A request may be received from a system associated with any communication service which may communicate with the search system 1615 (FIG. 16).

In operation 1810 a unique identifier of a user is obtained. In at least one embodiment, the unique identifier is a telephone number associated with a user device such as the user device 1665 (FIG. 16) or the user device 1660. Unique identifiers of a user associated with a request might be obtained, such as a username, an IM credential, an email address, a persistent ‘cookie’, etc. Control is passed to operation 1815 and process 1800 continues.

In operation 1815 a determination is made as to whether a user is eligible to receive a search service(s) requested in operation 1805. If in operation 1815 it is determined that a user is not eligible to receive a search service(s) requested in operation 1805, control is passed to operation 1820 and process 1800 continues. If in operation 1815 it is determined that a user is eligible to receive a search service(s) requested in operation 1805, control is passed to operation 1825 and process 1800 continues.

The determination in operation 1815 may be made based on various criteria. In at least one embodiment, a telephone number associated with a request for speech based search services is compared to information indicated in the search database 1620 (FIG. 16) to determine if a user is eligible to receive voice based search services. For example, a user who has registered with the search system 1615 and provided information to allow for payment for service(s) using the payment system 1605 may be determined to be eligible to receive voice and/or text based search service(s).

In at least one embodiment, a search request which is associated with an identifier of a user which is not associated with a payment account but may be used to provide payment may be determined to be eligible to receive a search service(s). For example, if a request for voice based search service is received which is associated with a phone number which is not included in information indicated in the search database 1620 (FIG. 16) a user may be allowed to receive a voice based search service(s). The search system 1615 may obtain information of an account associated with an identifier of a user using any information accessible through the network 1635. For example, information associated with a telephone number such as whether it is a mobile number, whether it is a pre-paid mobile number, whether it is a landline, etc. may be obtained from a provider of payment services such as the payment system 1605, the voice service 1640, and/or the messaging service 1645. Any information indicated in the payment database 1610 or the search database 1620 may be utilized to determine if a search request is eligible to receive a search service.

In at least one embodiment, if a search request is associated with a mobile phone number which has not been associated with more than a number of search requests, a search request may be determined to be eligible to receive a search service(s). This may allow a user to obtain a number of usages of a service(s) without being billed for the service(s). For example, the first three search request(s) submitted from a particular phone number may be accepted without a user being required to pay for a search service(s).

In at least one embodiment, eligibility to receive search services may be determined based on a time interval. For example, if a user is charged on a monthly basis, and the user has accepted the service charge it may be determined that a search request may receive search services. Alternately, if a user account is associated with a per-use payment account such as a pre-paid phone service, eligibility may be based on an amount of credit available in the user account. Although the determination at operation 1815 is described using a telephone account, the invention is not limited to use of any particular type of account and may include any identifier of the user through which payment may be authorized by the user.

In operation 1820 a message may be sent to a communication service or device associated with an identifier associated with a search request received in operation 1805. In at least one embodiment, a voice, text, email, IM and/or other message may be sent to a user to inform the user how the user may become eligible to receive a search service(s). A message may be sent using any or all communication service(s) or device(s) associated with an identifier associated with the request received in operation 1805. Information associated with a search request is recorded in the search database 1620. For example, a number of requests received which were determined not to be eligible to receive a search service(s) may be recorded, content of a search request may be recorded, etc. An advertisement may be sent to a user device or system. Control is passed to operation 1805 and process 1800 continues.

In operation 1825 a search is performed responsive to a user request. A search may be performed using the assistance of a guide. A search may be performed using an automated search resource(s). A guide and a user may communicate using a voice and/or messaging interface such as the voice service 1640 and/or the messaging service 1645. A search result(s) may be associated with an identifier associated with a search request received in operation 1805. The search result(s) and the identifier are associated and stored in the search database 1620 (FIG. 16). Control is passed to operation 1830 and process 1800 continues.

In operation 1830 a search result(s) is transmitted to a user using a communication service or device associated with the request received in operation 1805. Control is passed to operation 1835 and process 1800 continues.

In at least one embodiment, a voice response is provided to a user such as the user 1675 (FIG. 16) using a voice communication service such as the voice service 1640. A voice response may be provided to a user using VoIP, a cellular service, the Public Switched Telephone Network (PSTN) or any other telephonic connection. Preferably a voice response is provided to a phone number which is associated with a payment account such as the user account 1610b. For example a voice reply might be sent to the user 1675 (FIG. 16) via the voice service 1640, the wireless network 1655, and the user device 1665. Information of user acceptance may be recorded in the search database 1620. For example, an audio recording of all or part of a search session(s) may be stored in the search database 1620 in association with an identifier associated with a search request.

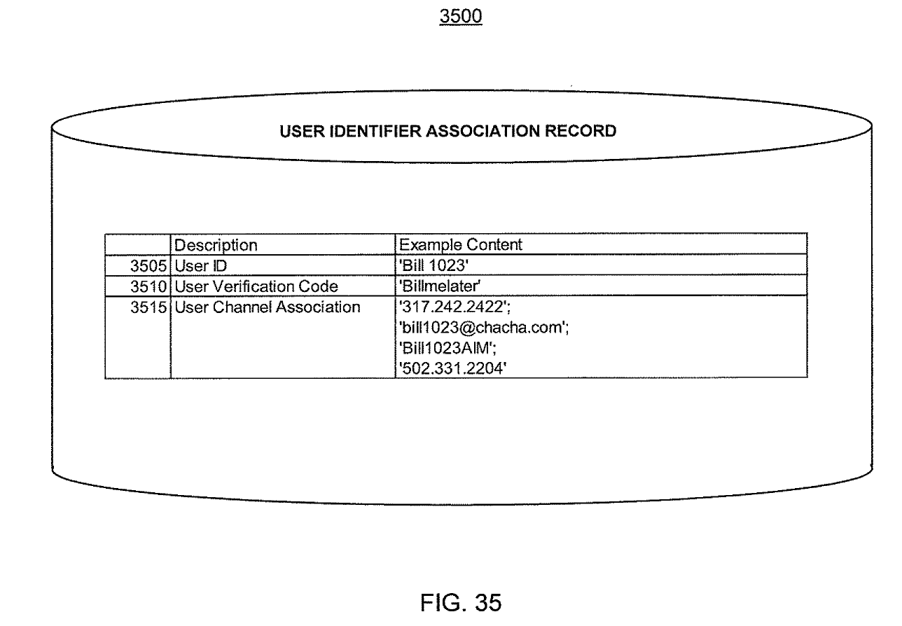

A search result(s) may be provided to a user associated with an identifier associated with the search request received in operation 1805 (FIG. 18) using any communication service(s) and/or device(s) associated with an identifier of the user. For example, a user may receive a search result(s) using a voice connection via the voice service 1640 (FIG. 16), may receive a text message which includes information of a search results via the messaging service 1645, may review a search result(s) associated with a search request by logging in to the search system 1615 and viewing a web page provided by the search system 1615, such as the web page 3500 illustrated in FIG. 35, may receive an email including information of a search result(s), etc. Methods for providing access to search services using multiple communication service(s) and device(s) are further described in the related application Ser. No. 12/265,411 previously mentioned.

In operation 1835 (FIG. 18) payment is made for search services. In at least one embodiment, a message is sent to a device associated with a payment account which is associated with an identifier of a user associated with the search request received in operation 1805. In at least one embodiment, the message is a MT Premium SMS (PSMS) message which is sent to a telephone number which may be billed to the user account 1610b (FIG. 16) associated with the telephone number. For example, a text (SMS) or other message may be transmitted to a user such as the user 1675 using the messaging service 1645, the wireless network 1655 and the user device 1665. The user account 1610b with the payment system 1605 is debited for the cost of a search service(s) plus any fees based on the transmission of the SMS or other message (also referred to as premium SMS). Any fees may be distributed between a service provider(s) such as a provider of the messaging service 1645, a provider of the voice service 1640, a provider of search services such as the search system 1615, a provider of payment services such as the payment system 1605, etc. according to an agreement between the service provider(s). The search system account 1610a is credited for the search service provided, the payment system account 1610c is credited with any payment fee, and account(s) associated with other service provider(s) may be credited.

In at least one embodiment, a user may be required to respond to a message to initiate a payment transaction. For example, a user may transmit a text message responsive to a voice and/or text message. In this case, the transaction may be a mobile originated (MO) PSMS transaction, and the user payment account is debited and other transactions are processed based on the receipt of the message from a user. Any number of messages may be sent or received by a user to complete a payment transaction. Control is passed to operation 1840 and process 1800 continues.

In operation 1840, information of a search request, a search result(s), payments, etc. which are associated with a search request and an identifier of a user are stored in the search database 1620 (FIG. 16). Payment information and other information may be recorded in the payment database 1610. Any information indicated in the search database 1620 or the payment database 1610 may be utilized by the search system 1615, the provider of the messaging service 1645, the provider of the voice service 1640, and/or the payment system 1605 for purposes, such as billing, review of account information, confirmation of user identity, confirmation of user eligibility to receive service(s), etc. Control is passed to operation 1805 and process 1800 continues.

Using the process 1800 a user may utilize a payment account associated with an identifier of a user in order to pay for a search service provided by the search system 1615 (FIG. 16). A user of mobile phone services may pay fees associated with a search service such as a voice based search service using an account established with the payment system 1605 which is associated with an identifier of the user such as a mobile phone number. Any services or item(s) provided by the search system 1615 may be paid for using the payment system 1605 once an association is made between an identifier of a user and an identifier of a user payment account such as the user account 1610b. Multiple identifiers of a user may be associated with a user payment account. For example, an email address(es), an IM credential(s), a username(s), a phone number(s) or any other identifier(s) of a user which may be associated with a search request may be utilized to pay for search services using the user account 1610b.

In at least one embodiment, a user may associate a mobile phone service account with an identifier of a user such as a telephone number which may be a land-line phone number, and may pay for voice based search services requested from the telephone number based on a Premium SMS message transmitted to a text-enabled device associated with the telephone number. A user may make such an association based on information which may be exchanged between the search system 1615 and the payment system 1605. A user is not required to establish a payment account with the search system 1615.

Use of a MT or MO PSMS message to pay for a product and/or item(s) may provide a high level of convenience to a user in conjunction with the services provided by the search system 1615. For example, a user might obtain information from a guide, create a transaction with a provider, and pay for the transaction using a PSMS message. The payment system (e.g. the mobile phone provider) receives increased revenue, the merchant obtains customers on a targeted basis, and the search system may be supported by sharing the revenue generated.

Subsequent to registering with the search system and providing payment information which is associated with an identifier of a user, a user may elect to discontinue receiving a search service(s) and/or may elect to remove an identifier from being associated with a payment account such as the user account 1610b. Any type of communication service(s) associated with the search system 1620 may be used to remove the association of an identifier of a user from being associated with a payment account.

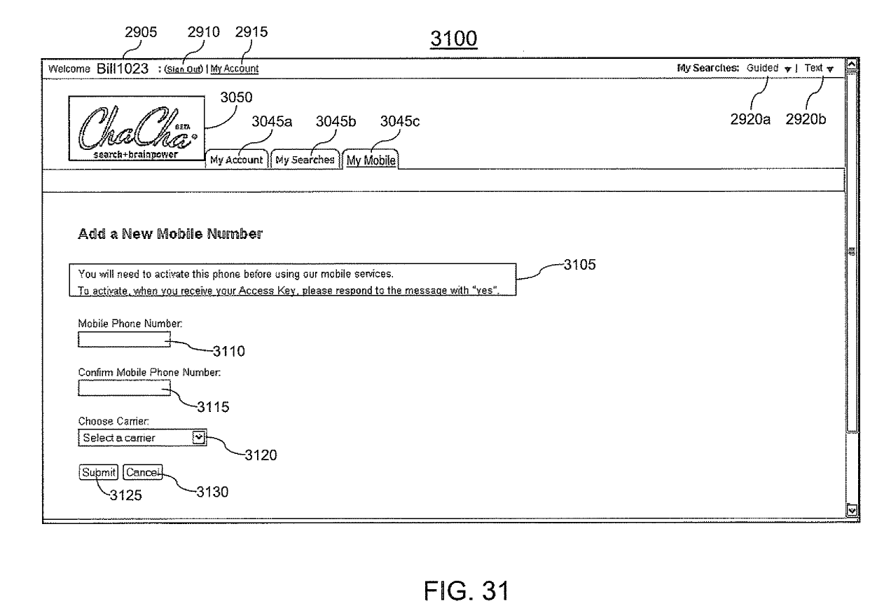

For example, a user may send a SMS message from a device associated with a user identifier such as a telephone number which may indicate the desire to opt-out of a search service(s) or user may cancel an association with a payment account using a web page such as the GUI 3100 illustrated in FIG. 31.

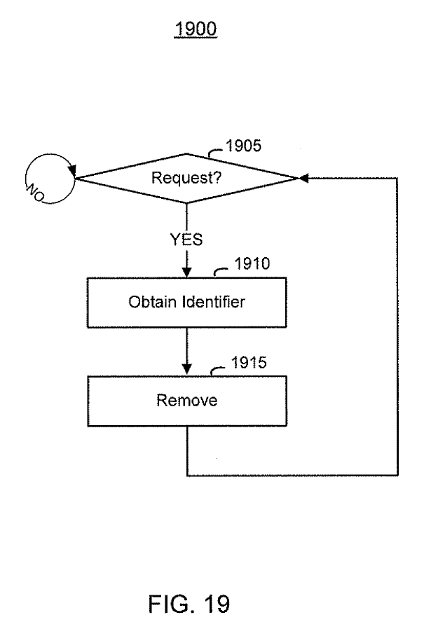

As illustrated in FIG. 19 a process 1900 for removing an association between a user identifier and a payment account is provided.

In operation 1905 a determination is made as to whether a request for access to a user account is received. If in operation 1905 it is determined that a request is not received, control remains at operation 1905 and process 1900 continues to wait. If in operation 1905 it is determined that a request for access to a user account is received, control is passed to operation 1910 and process 1900 continues.

The determination in operation 1905 may be made based on various criteria. In at least one embodiment, a text message from a telephone number associated with a user payment account is used to determine whether an access request is received. In at least one embodiment, receipt of a username and a password associated with a user account associated with a telephone number is used to determine whether an access request is received. An email message, a voice message, an Instant Message, etc. may be used to request access to a user account(s).

In operation 1910 an identifier of a user which is to be removed from association with a user payment account is selected. The selection may be performed using a GUI such as the GUI 3100 illustrated in FIG. 31, may be performed based on the content of an access request received in operation 1905, etc. Any or all identifiers of a user associated with a payment account may be selected to be removed. A user may be requested to confirm removal of an association by providing security information such as a password, username, or other verification information. Control is passed to operation 1915 and process 1900 continues.

In operation 1915 an identifier is removed from association with a user payment account. A change of association may be recorded in the search database 1620 (FIG. 16). A message may be transmitted from the search system 1615 to the payment system 1605. The change of association may be recorded in the payment database 1610. For example, a user payment record may be modified to indicate that an account of a user may not be used to provide payment for search services, or one or more identifiers of a user may be removed from a list of identifiers associated with a user account. A message may be transmitted to the voice service 1640 and/or the messaging service 1645 regarding the change of association. The search database 1620 is updated, the payment database 1610 is updated, control is passed to operation 1905 and process 1900 continues. A user may receive notification of a change of association via any service(s) associated with the user.

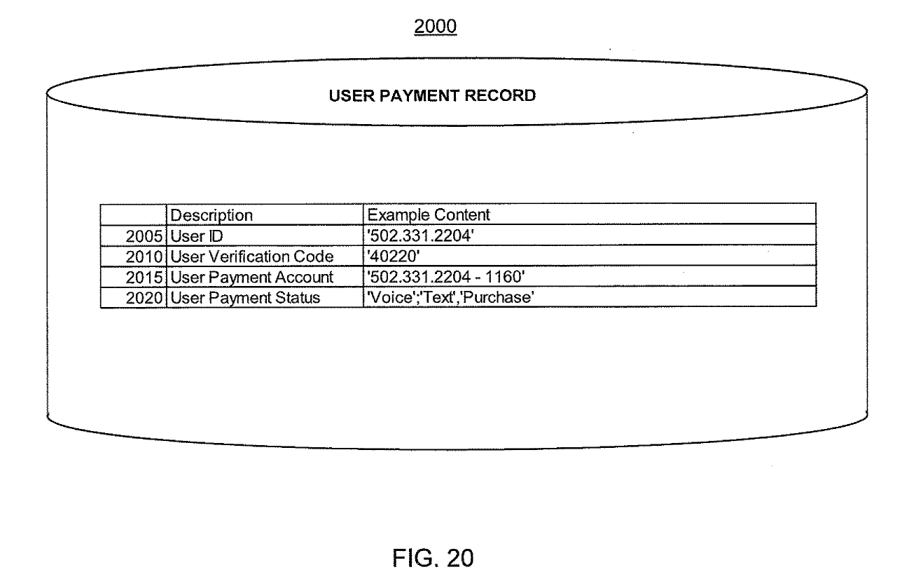

As illustrated in FIG. 20, a sample of a user payment record 2000, of which one or more may be associated with or resident in the search database 1620 (FIG. 16), may include a user ID field 2005, a user verification code field 2010, a user payment account field 2015, and a user payment status field 2020.

The user ID field 2005 may include an identifier of a user, which is preferably unique and preferably used consistently. For example, in at least one embodiment, the user ID field 2005 can include a randomly generated numerical code, and/or a character string indicating a user. A user ID serves to distinguish a user search payment record associated with a user from a user search payment record associated with other users. Although particular examples of identifiers are described herein, other types of identifiers uniquely indicating a user(s) may be utilized without departing from the spirit and scope of the embodiments. In at least one embodiment, the user ID is a telephone number. In at least one embodiment, a telephone number associated with a mobile phone service account may be included in the content of the user ID field 2005. A user ID may include a username, an IM credential, an email address, etc. Using the example in FIG. 20, ‘502.331.2204’ is the user ID associated with the user payment record 2000. A pointer to a user payment record may be included in a user record such as the user record 360 (FIG. 4).

The user verification code field 2010 may include a verification code for verifying that a user is authorized to access a user search payment record and/or a user payment account. A user verification code may be a character string and/or a numerical code that operates in conjunction with content of the user ID field 2005 to verify a user authorization(s). In at least one embodiment, a user ID is used to retrieve or “look-up” the user's verification code (password) to compare the verification code with a verification code entered by a user. If both a user ID match occurs and a verification code match occurs, a user may be allowed to access a user record(s). Other types of security data, such as a voice print, a finger print, etc. may be indicated in the verification code field when methods such as biometrics are used for access verification without departing from the scope of this disclosure. For example, if a user submits a request or query using a mobile phone, the user ID may be the telephone number associated with a search request, and the verification code may be a zip code associated with a user account 1610b with the payment system 1605. Using the example illustrated in FIG. 20, the password ‘40220’ is the user verification code associated with the user search payment record 2000 and the user ID ‘502.331.2204’. In at least one embodiment, a verification code may be required in order to change information indicated in the user payment status field 2020. For example, information associated with a user payment account such as a mobile phone service account may be required to be entered to acknowledge a message sent in operation 1725 (FIG. 17). In at least one embodiment, information included in the user verification code field 2010 (FIG. 20) may be obtained from the payment system 1605 (FIG. 16). A user may be required to provide information indicated in the user verification code field 2010 to confirm a purchase transaction.

The user payment account field 2015 (FIG. 20) may include information related to a payment account associated with a user ID. The content of the payment account field may include various types of data indicating a payment account which is associated with a user. For example, a telephone number, an IM credential, an email address, a username, a PayPal account and/or any other information indicating a payment account associated with a user ID may be indicated in the user payment account field 2015. Using the example illustrated in FIG. 20, the account number ‘502.331.2204-1160’ is the payment account identifier associated with the user ID ‘502.331.2204’. In at least one embodiment, information indicated in the user payment account field 2015 may be different than the content of the user ID field 2005. For example, a payment account which is associated with a mobile phone may be associated with a landline phone number indicated in the user ID field 2005. In at least one embodiment, a telephone number indicated in the user ID field 2005 is the only identifier of a user which may be associated with a user payment account indicated in the user payment account field 2015.

The user payment status field 2020 includes information to indicate whether a user payment account may be utilized to obtain payment. For example, if a user has completed a registration process such as the process described in the process 1700 (FIG. 17), the user payment status field 2020 may indicate that a user payment account may be utilized to obtain payment for a search service(s). One or more type(s) of search service(s) and payment account identifier(s) may be indicated in a user search payment record. The user payment account field 2015 and the user payment status field 2020 may be linked by, for example, a pointer. Using the example illustrated in FIG. 20, the user payment account ‘502.331.2204-1160’ may be used to pay for ‘Voice’, ‘Text’, and ‘Purchases’.

In at least one embodiment, the user payment status field 2020 may indicate whether a user payment account may be used to obtain payment for voice based search services by sending a Premium SMS message to a text enabled device associated with a user payment account identified in the user payment account field 2015. Additional fields may be included in a user search payment record. Any of the fields of a user payment record 2000 may be blank.

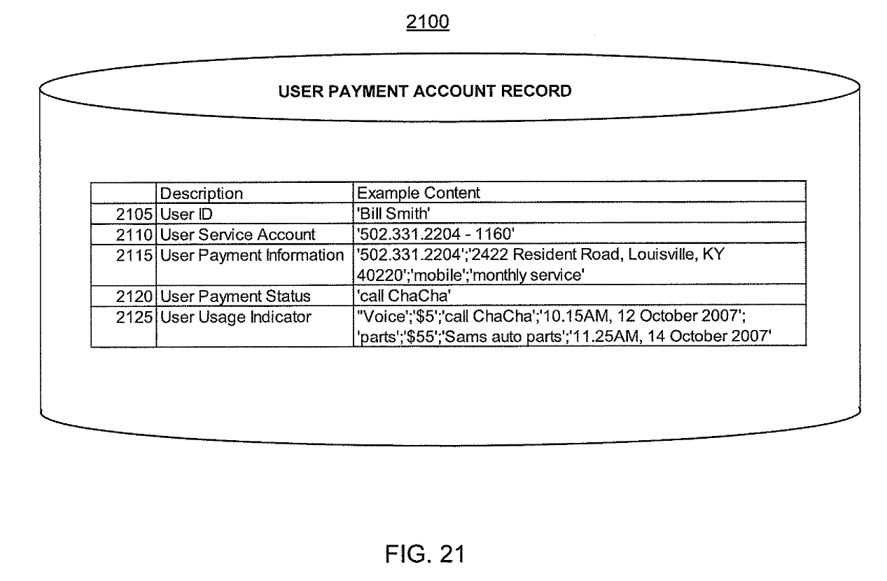

As illustrated in FIG. 21, a sample of a user payment account record 2100, of which one or more may be associated with or resident in the payment database 1610 (FIG. 16), may include a user ID field 2105, a user service account field 2110, a user payment information field 2115, a user payment status field 2120 and a user usage indicator field 2125.

The user ID field 2105 may include an identifier of a user, which is preferably unique and preferably used consistently. For example, in at least one embodiment, the user ID field 2105 can include a randomly generated numerical code and/or a character string indicating the user. A user ID serves to distinguish a user payment account record associated with a user from a user payment account record associated with other user(s). Although particular examples of identifiers are described herein, other types of identifiers uniquely indicating a user(s) may be utilized without departing from the spirit and scope of the embodiments. In at least one embodiment, the user ID is a telephone number. Using the example in FIG. 21, ‘Bill Smith’ is the user ID associated with the user payment account record 2100. In at least one embodiment, a telephone number associated with a mobile phone service account may be included in the content of the user ID field 2105.

The user service account field 2110 may include an identifier of a user account associated with a user ID. For example, a telephone number, or other account number which may be utilized to provide payment services to a user may be indicated in the user service account field 2110. Information included in the user service account field 2110 may be utilized by the payment system 1605 (FIG. 16) to associate a user identifier provided by the search system 1615 with a user ID indicated in a user payment account record such as the user payment account record 2100. The association of a user identifier with a user payment account record may be used to track services and/or products which may be charged to a user payment account associated with a search service(s) provided by the search system 1615. Using the example illustrated in FIG. 21, ‘502.331.2204-1160’ is the user service account identifier associated with the user ‘Bill Smith’.

The user payment information field 2115 includes information regarding billing of a user associated with the user payment account record 2100. For example, a phone number, a user name, address, zip code, payment method, service type, etc. may be indicated in the user payment information field 2115. Information indicated in the user payment information field 2115 may be used to verify that a user account may be billed using a billable messaging service. For example, if a user payment account is pre-paid, or if no billable messaging service (e.g. Premium SMS) is associated with a user account, a user payment account may not be eligible to be used for payment for an item(s) and/or service(s) provided through the search system 1615. Information indicated in the user payment information field 2115 may be used to verify access to a user payment account record. For example, information indicated in the user payment information field may be required to be provided in a message from a user device in order to complete a registration process. Information included in the user payment information field 2115 may be used to ‘look-up’ a user payment account record in the payment system database 1610 (FIG. 16) which is associated with the user account 1610b. A message may be transmitted from the search system 1615 to the payment system 1605 which contains a phone number associated with a search request. The payment system 1605 may use a phone number to identify a user payment account record.

The user payment status field 2120 includes information regarding whether a user payment account may be utilized to pay for item(s) and/or service(s) provided using the search system 1615. For example, after completion of a registration process, the user payment account status field may indicate that a user will accept charges associated with a search service(s). Using the example illustrated in FIG. 21, the user ‘Bill Smith’ may accept charges from ‘call ChaCha’, which will be paid using the user service account ‘502.331.2204-1160’.

The user usage indicator field 2125 includes information of any item(s) and/or service(s) billed to a user payment account such as the user account 1610b (FIG. 16). A type of charge, a time indicator, etc. may be indicated in the user usage indicator field 2125. Using the example illustrated in FIG. 21, a ‘Voice’ search fee of ‘$5’ from ‘call ChaCha’ was charged at ‘10.15 AM, 12 Oct. 2007’ and a ‘parts’ fee of ‘$55’ from ‘Sams auto parts’ was charged at ‘11.25 AM, 14 Oct. 2007’ to the user service account ‘502.331.2204-1160’. Information indicated in the user usage indicator field 2125 may be used to determine charges incurred by a user. For example, the search system 1625 may transmit information of a service provider and/or a payment charge to the payment system 1605. The search system and/or the payment system may transmit one or more messages to a user device in order to complete billing for the transaction. A provider and/or the search system 1615 may be compensated by the payment system, which may subsequently bill and collect from a user. Alternately, a provider may be paid by the search system 1615. In at least one embodiment, a PSMS message(s) are used to initiate a transaction.

Additional fields may be included in a user payment account record such as the user payment account record 2100. Any of the fields of a user payment account record may be blank. A user payment account record may be used to indicate an association between the user account 1610b (FIG. 16) in the payment system database 1610 and an identifier of a user associated with a search request received by the search system 1615. Using records such as the user search payment account record 2000 and the user payment account record 600, the search system 1615 and the payment system 1605 may identify a search request associated with an identifier of a user and provide payment for the search service(s).

A user of the search system such as the user 1675 may submit a voice based search request using a device such as the user device 1665 and make a payment based on receipt and/or transmission of a message such as an SMS message by a user device such as the user device 1665. It is not necessary for the user to establish a payment account or a user account with the search system 1615. An identifier of a user associated with a search request may be used to perform payment for services using the user account 1610b with the payment system 1605.

An exemplary registration text message 2200 which may be transmitted to a user as part of operation 1720 (FIG. 17). The registration text message 2200 includes notification of terms 2205, which may include a URL which may direct a browser of a user device to a web page, and response information 2210.

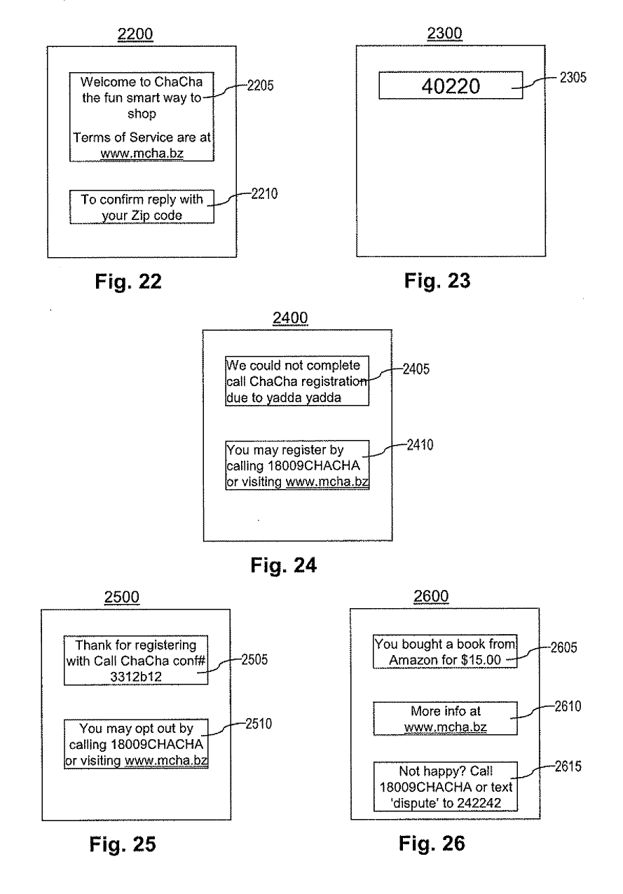

The notification of terms 2205 (FIG. 22) may inform a user of service costs and/or other terms. For example, a user may agree to accept any and all charges which are confirmed by a response which includes a code. A URL indicated in the notification 2205 may direct a user to a webpage which may provide a user with terms of service for a search service(s).

The response information 2210 may include information and instructions which may be used to complete registration. As illustrated in FIG. 22, a user may be requested to send information such as text to a short-code, and/or to visit a website to provide additional information. In at least one embodiment, the response information 2210 includes a request for verification information which is obtained by the search system 1615 from the payment system 1605. The information contained in the registration text message 2200 may also be delivered using voice based communication, an email, an Instant Message, and/or other communication service.

An exemplary registration acknowledgement text message 2300 which may be transmitted by a user in operation 1725 (FIG. 17) is illustrated in FIG. 23. The registration acknowledgement text message 2300 may include user verification information 2305 which may be used to confirm user acknowledgement and acceptance of the terms of service of the search system 1615. Using the example illustrated in FIG. 23 ‘40220’ is the user verification code included in the registration acknowledgement text message 2300. Information contained in the registration acknowledgement text message 2300 may also be provided using voice based communication, an email, an Instant Message, or other communication service.

An exemplary registration failure text message 2400 which may be transmitted to a user in operation 1730 (FIG. 17) is illustrated in FIG. 24. The registration failure text message 2400 may include a failure explanation message 2405 and a registration instruction 2410. The failure explanation 2405 may include information regarding a reason(s) for failure to complete user registration, such as a time-out, an authentication error, failure to associate a user identifier with a user account such as the user account 1610b (FIG. 16), etc. The registration instruction 2410 may include information regarding how a user may complete the registration process. Information contained in the registration failure text message 2400 may also be provided using voice based communication, an email, an Instant Message, or other communication service

An exemplary registration confirmation text message 2500 which may be transmitted to a user in operation 1735 (FIG. 17) is illustrated in FIG. 25. The registration confirmation text message 2500 may include a confirmation message 2505, and an opt-out instruction 2510. The confirmation 3005 may allow a user to verify an opt-in. The opt-out instruction 2510 may include information regarding how a user may remove an association of an identifier with a payment account, which may prevent charges from being made to a user account. Information contained in the registration confirmation text message 2500 may also be provided using voice based communication, an email, an Instant Message, or other communication service.

An exemplary billable text message 2600 which may be transmitted to a user in operation 1835 (FIG. 18) of process 1800 is illustrated in FIG. 26. The billable text message 2600 may include a product description message 2605, a transaction detail link 2610 and a dispute description 2615.

The service notification 2605 may include an indication of a purchase that has been provided to a user and a URL, as illustrated in FIG. 26. The transaction detail link 2610 may include text and a URL which may direct the browser of a user device to a web page where further information may be obtained. The dispute description 2615 includes instructions regarding how a user may dispute a charge. Information contained in the billable text message 2600 may be provided to a user using any communication services such as email, voice, IM, a web page, etc. which are associated with an identifier of a user.

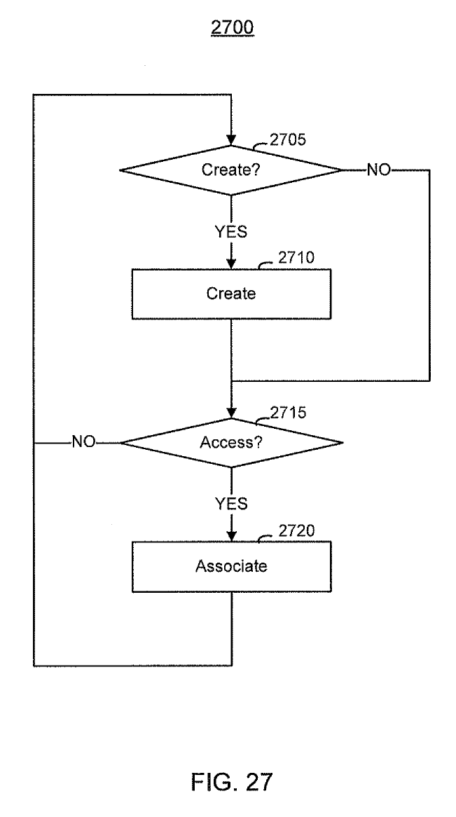

As illustrated in FIG. 27, a process 2700 for creating a user account and associating identifying information of a user with a user account with the search system 1615 (FIG. 16) is provided. The process 2700 may be operative on the search system 1615 (FIG. 16). The process 2700 may for example associate a user login ID with a user mobile phone number and a user landline phone number.

In operation 2705 a determination is made as to whether a user requests to create a user account. If in operation 2705 it is determined that a user does not request to create an account, control is passed to operation 2715 and process 2700 continues. If in operation 2705 it is determined that a user requests to create an account, control is passed to operation 2710 and process 2700 continues.

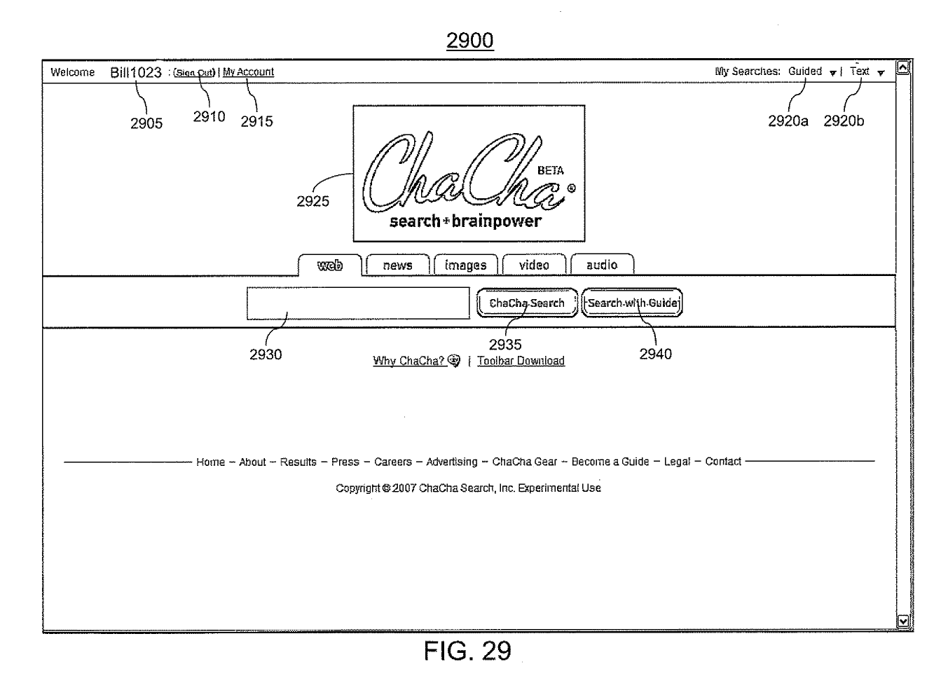

In operation 2710, a user account is created. A user may be presented with a GUI such as the GUI 2900 illustrated in FIG. 29. A user login ID is created and a user password may be determined. In at least one embodiment, a confirmation email may be sent to an email address provided by a user in order to verify the identity of the user. Similarly an SMS message may be delivered to a user device in order that a user may confirm addition of a device or service identifier to a user account. A temporary password may be provided, which may be modified by a user. Control is passed to operation 2715 and process 2700 continues.

In operation 2715 a determination is made as to whether a request to access a user account is received. If in operation 2715 it is determined that an access request is not received, control is passed to operation 2705 and process 2700 continues. If in operation 2715 it is determined that a request to access a user account is received, control is passed to operation 2720 and process 2700 continues. The determination in operation 2715 may be made based on verification of a user ID, confirmation of security information such as a user password, and/or other security information associated with a user ID. If suitable security information is provided, access to a user account may be provided.

In operation 2720 a user is provided with an option to associate information of a user with a user ID. For example, a user may be presented with a GUI such as the GUI 3100 illustrated in FIG. 31. A user may elect to associate various types of identifying information with a user login ID. For example, a user may associate a telephone number, an IM credential, an email address, or any other identifier with a user login ID. Control is passed to operation 2705 and process 2700 continues.

Using the process 2700, multiple unique identifiers of a user may be associated with an ID. If a user communicates with the search system 1615 using any service(s) associated with a user ID, the search system 1615 (FIG. 16) may provide various information such as a search query history, a search result(s) history, advertisement(s), searcher(s) list, search classification(s), search resource(s), affiliate groups associated with a search request(s), a purchase history, details of activities, and/or any other information which may have been provided responsive to a query(ies) submitted using any communication service(s) associated with a user login ID of a user.

For example, a user such as the user 1675 (FIG. 16) may submit a search query using a voice interface. A search result(s), a searcher(s), an advertisement(s), a search resource(s), etc. may be provided responsive to a search query. If at some later time, a user logs in to the search system by accessing a user account using a web browser function of a device such as the user computer 1670, or by any other communication channel which is associated with a user login ID, access may be granted to information associated with a search query(ies) submitted by the user. In at least one embodiment, a user may not be required to provide login credentials when accessing the search system using a communication channel associated with a user ID. In other embodiments, security information of any type may be required to access information associated with a user ID. For example, a user of a mobile phone or other device which may have limited capabilities may not be required to present authentication information while a user of a device such as laptop or desktop computer may be required to provide security information.

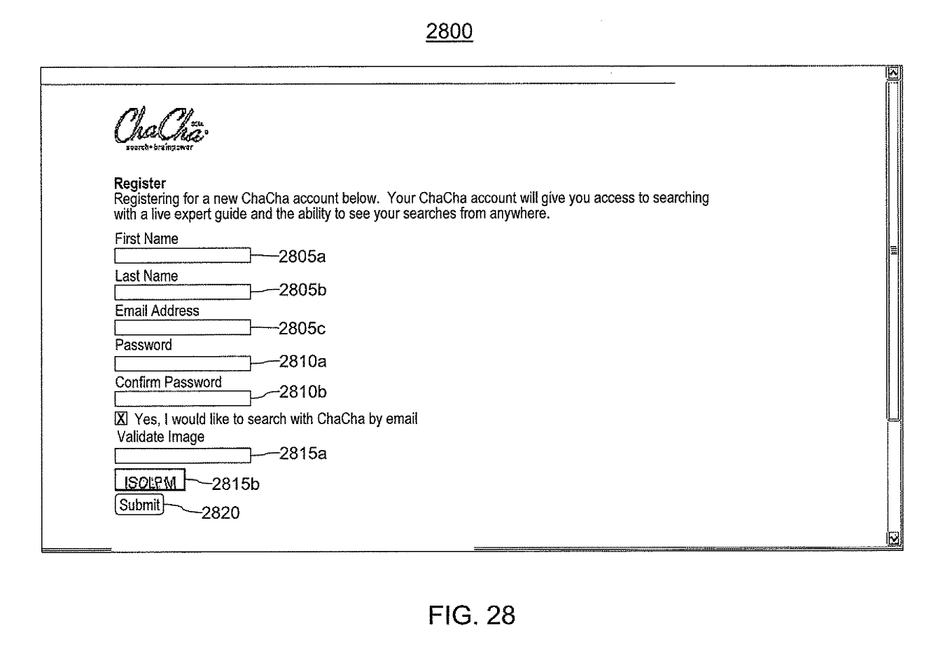

An example user registration GUI 2800 is illustrated in FIG. 28. The GUI 2800 may include user information indicators 2805, password indicators 2810, CAPTCHA controls 2815, and an action button 2820.

The user information indicators 2805 may be used to indicate information of a user. The first name user information indicator 2805a may be used to provide first name information. The last name user information indicator 2805b may be used to provide last name information. The email address user information indicator 2805c may be used to provide email address information. The password indicators 2810 may be used to provide and confirm a password. The ‘password’ password indicator 2810a may be used to provide a desired password. The ‘confirm password’ password indicator 2810b may be used to confirm a desired password. The CAPTCHA 2815 may be used to verify a visual indicator. The CAPTCHA entry box 2815a may be used to provide an interpretation of the information provided in the CAPTCHA display box 2815b. The action button 2820 may be used to submit the information provided in the GUI 2800 to the search system 340. An email address provided may be used for security and confirmation purposes.

While the login GUI 2800 has been described with respect to the example illustrated in FIG. 28, other types of registration interfaces, such as voice-controlled menu (voice xML), an interactive menu, etc. may be utilized to accomplish the user registration. Other information may be obtained in order to establish a user login ID.

An exemplary GUI for a user to conduct a search as a logged-in user is illustrated in FIG. 29. The GUI 2900 includes a user identifier 2905, a sign-in control 2910, an account viewing control 2915, search review controls 2920, an advertising window 2925, a query box 2930, an unguided search button 2935, and a guided search button 2940. The GUI 2900 may be presented as a landing page when a user logs in to the search system 1615 (FIG. 16).

The user identifier 2905 indicates information associated with a user login account. The user identifier may be based on any information submitted during a registration process. The sign-in control 2910 may be used to log in and log out of the search system 345.

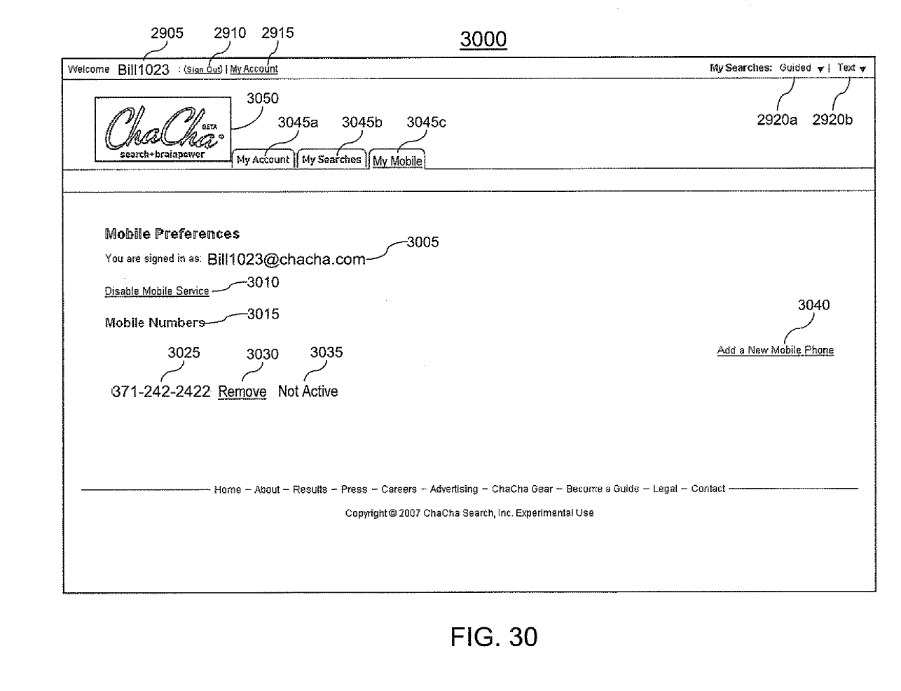

The account viewing control 2915 may be used to view and modify information associated with a user account. Activation of the account viewing control 2915 may cause the GUI 3000 illustrated in FIG. 30 to be provided.

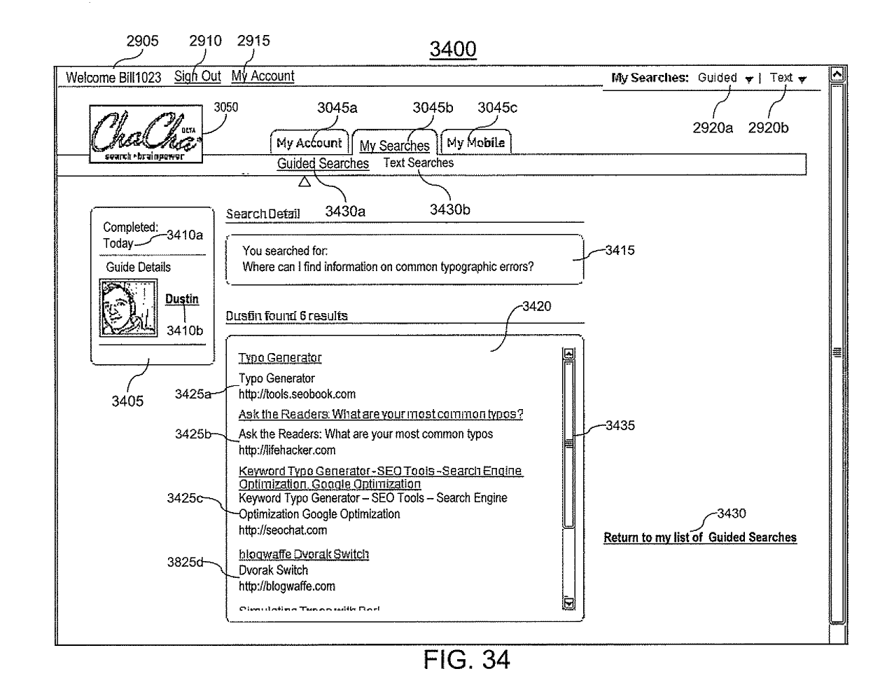

The search review controls 2920 may be used to review historical search information. Activation of the search review controls 2920 may cause a list of previous search queries to be presented to a user as for example a drop-down list. If a user selects an item from a list provided using a search review control, a GUI such as the GUI 3400 illustrated in FIG. 34 may be provided. Activation of the ‘Guided’ search review control 2920a may cause a drop-down list of search queries utilizing a guide associated with a user login to be provided. Activation of the ‘Text’ search review control 2920b may cause a drop-down list of search queries submitted using a text-based device(s) associated with a user ID to be provided.

The advertising window 2925 may present an advertisement of any type. More than one advertising window 2925 may be present within the GUI 2900. An advertisement may be targeted to a user based on information associated with a user ID and/or other information indicated in the GUI 2900. Further, an advertisement may be presented based on a communication service being used to deliver information to a user. For example, content provided using an SMS service may be different than an advertisement provided via an email service.

The search query box 2930 may be used to enter a search query. The ‘ChaCha Search’ unguided search button 2935 may be used to request an unguided search. The ‘Search with a Guide’ search button 2940 may be used to request a search utilizing the assistance of a human searcher.

An exemplary GUI 3000 for a user to associate a device and/or other communication service(s) with a user ID is illustrated in FIG. 30. The GUI 3000 includes a user identifier 3005, a service election control 3010, a channel type identifier 3015, a channel identifier 3025, a channel deactivation control 3030, a channel status indicator 3035, a channel addition control 3040, account selection tabs 3045 and an advertising window 3050. The GUI 3000 may be presented to a user at any time responsive to a request to associate a new device or other communication channel with a user ID.

The user identifier 3005 indicates information associated with a user account. The user identifier may be based on any information provided to the search system during a registration process. Using the example illustrated in FIG. 30, a user identifier is the email address of a user associated with the login account.

The service election control 3010 may be used to select to enable or disable a type of service. Activation of the service election control 3010 may enable or disable a type of service associated with a user. For example, a user may elect to deactivate all access using mobile messaging, or IM, or voice, etc.

The channel identifier 3015 indicates the type of communication channel which is associated with a user account. More than one channel identifier 3015 may be present in the GUI 3000. Using the example illustrated in FIG. 30, the channel identifier indicates that a mobile phone number(s) may be associated with a user ID.

The channel identifier 3025 indicates information of one or more communication channels associated with a user ID. Such information may include a phone number, an email address, an IM login ID and provider, etc. The channel deactivation control 3030 may be used to remove a selected communication channel from the list of communications channels associated with a user ID. A user may elect to remove a communication channel due to various reasons such as change of phone number(s), modification of a service provider(s), and/or cancellation of an account(s). The channel status indicator 3035 indicates whether a communication channel is actively available to a user for submitting and/or reviewing information associated with a search query(ies). While a phone number is used for purposes of illustration in FIG. 30, no limitation is implied thereby.

The channel addition control 3040 may be used to indicate that a new communication service is to be added to the list of services associated with a user ID. If the channel addition control 3040 is activated, the GUI 3100 illustrated in FIG. 31 may be provided.

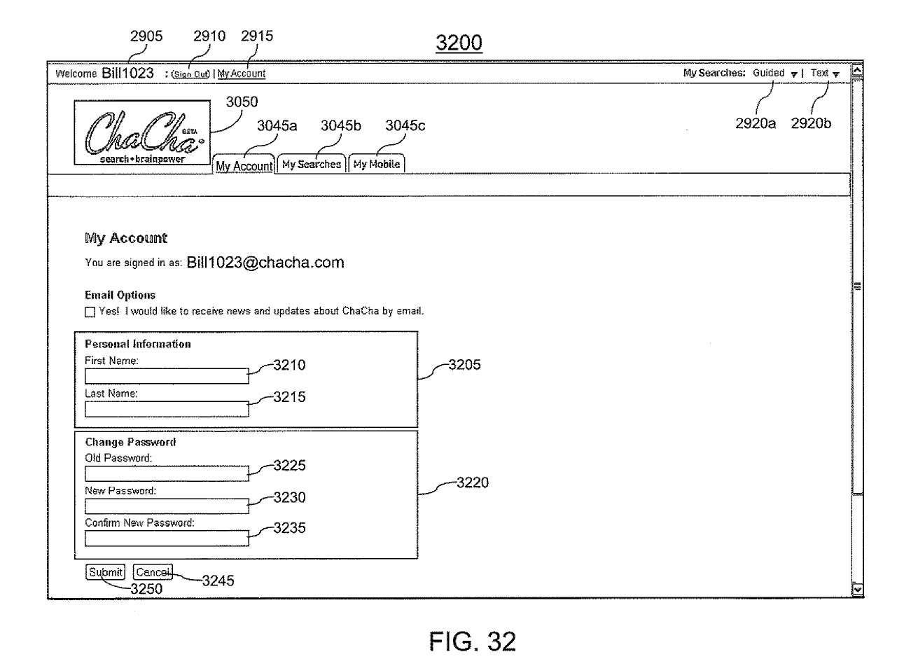

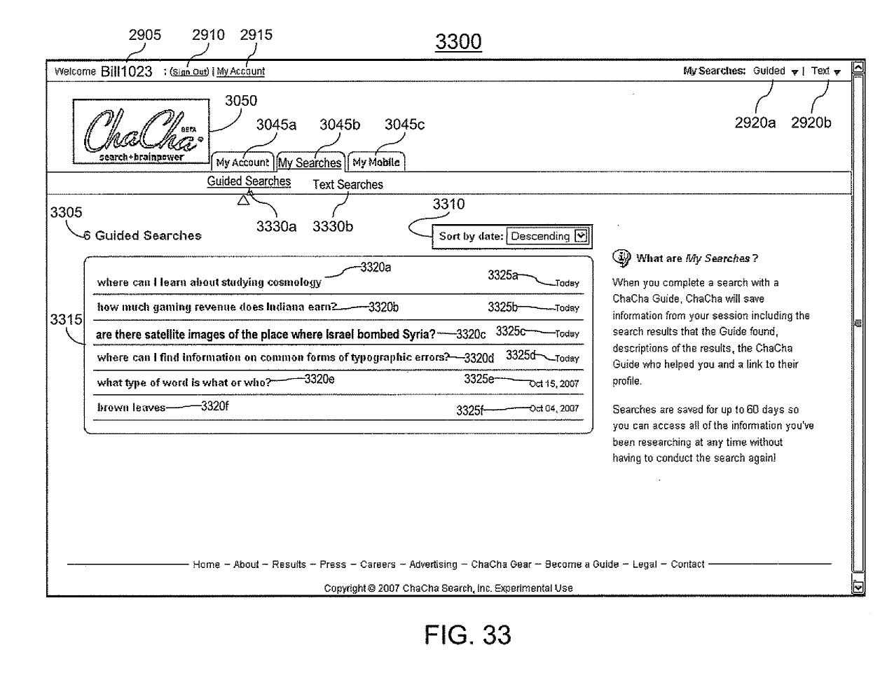

The account selection tabs 3045 allow a user to view information associated with a user account. Using the example illustrated in FIG. 30, activation of the ‘My Account’ account selection tab 3045a may cause the GUI 3200 illustrated in FIG. 32 to be provided. Activation of the ‘My Searches’ account selection tab 3045b may cause the GUI 3300 illustrated in FIG. 33 to be provided. Activation of the ‘My Mobile’ account selection tab 3045c may cause the GUI 3000 illustrated in FIG. 30 to be provided.

The advertising window 3050 may present an advertisement of any type. More than one advertising window 3050 may be present within the GUI 3000. An advertisement may be targeted to a user based on information indicated in the database 1620 (FIG. 16).

While association of a communication channel with a user ID has been described with respect to the GUI 3000 illustrated in FIG. 30, other types of interfaces may be utilized to associate a device(s) and/or communication channel(s) with a user ID. For example, a user might associate a device with a user ID by sending a text message from the device, receiving a confirmation message and replying to the confirmation message or a user might call a telephone number, request to associate the originating number with a user ID, and provide verification information via voice, text, or other communication service(s).

An exemplary GUI 3100 for a user to associate a device or other communication service(s) with a user ID is illustrated in FIG. 31. The GUI 3100 includes user instructions 3105, a phone number entry box 3110, a phone number confirmation box 3115, a carrier selection box 3120, a submit button 3125, and a cancel button 3130. The GUI 3100 may be presented to a user at any time responsive to a request to associate a new device or other communication service with a user ID.

The user instructions 3105 explain how a user may associate a new communication channel with a user ID. Instructions may be provided for completion of an association process using any type of communication service(s) and/or device(s). Using the example illustrated in FIG. 31, a user is provided with instructions to confirm addition of a mobile phone for text service.

The phone number entry box 3110 may be used to provide information associated with a mobile phone number. The phone number confirmation box 3115 may be used to confirm information provided in the phone number entry box 3115. Preferably a 10-digit phone number may be provided. The carrier selection box 3120 may be used to designate a telephone service provider associated with a phone number. The carrier selection box 3115 is preferably implemented as a drop-down list of carriers that may support the search services of the search system 1615 (FIG. 16). Telephone subscription information may be used for customer service and/or billing purposes such as those described herein above.

The submit button 3125 may be used to submit the information indicated in the GUI 3100 for processing. The cancel button 3130 may be used to discard information indicated in the GUI 3100 and return to the GUI 3000.

While association of a communication channel with a user ID has been described with respect to the GUI 3100 illustrated in FIG. 31, other types of interfaces may be utilized to associate a device(s) and/or communication channel(s) with a user ID. For example, a user might associate a device by sending a text message from that device, receiving a confirmation message and replying to the confirmation message or a user might call a telephone number, request to associate the originating number with a user ID, and provide verification information via voice, text, or other communication service(s).

An exemplary GUI 3200 for a user to manage information associated with a user ID is illustrated in FIG. 32. The GUI 3200 includes personal information entry controls 3205, password controls 3220, a submit button 3250, and a cancel button 3245. The GUI 3200 may be presented to a user at any time responsive to a request to manage information associated with a user ID.

The personal information entry controls 3205 may be used to enter or change personal information associated with a user login ID. The personal information entry controls 3205 may include the first name box 3210 which may be used to provide first name information, and the last name box 3215 which may be used to provide last name information.

The password controls 3220 may be used to modify a user password associated with a user ID. The password controls 3220 may include an old password entry box 3225, a new password entry box 3230, and a new password confirmation box 3235. The old password entry box 3225 may be used to provide a current password associated with a user ID. The new password entry box 3230 may be used to provide a new password to be associated with a user ID. The new password confirmation box 3235 may be used to confirm a new password associated with a user ID.

The submit button 3250 may be used to submit the information indicated in the GUI 3200 for processing. The cancel button 3245 may be used to discard any information indicated in the GUI 3200 and return to the GUI 2900.

While a specific set of user information is described in FIG. 32, other information of a user may be obtained by the search system.

An exemplary GUI 3300 for a user to review historical search information is illustrated in FIG. 33. The GUI 3300 includes a search type indicator 3305, search sorting controls 3310, a search history list 3315, search query indicators 3320, search timestamp indicators 3325, and search type selection tabs 3330. The GUI 3300 may be presented to a user at any time responsive to a request to review a search history associated with a user ID.

The search type indicator 3305 indicates the type of search which was conducted, and an indication of the number of historical search sessions available to a user. The search sorting controls 3310 allow a user to sort historical searches based on selectable criteria. The sorting controls 3310 are preferably implemented as a drop-down list of options, which may include date, topics, purchases, providers, and/or other sorting criteria.

The search history list 3315 indicates information of a search query(ies). The search history list 3315 includes the search query indicators 3320, and the search timestamp indicators 3325. The search query indicators 3320 display information of a query, which may include text, audio, images, etc. A hyperlink may be associated with a search query indicator 3320. The search timestamp indicators 3325 indicates time information associated with a search request. The search query indicator 3320a indicates a search request regarding cosmology which was conducted ‘Today’ as indicated by the search timestamp indicator 3325a. The search query indicator 3320b indicates a search request regarding ‘gaming’ which was conducted ‘Today’ as indicated by the search timestamp indicator 3325b. The search query indicator 3320c indicates a search request regarding a news item which was conducted ‘Today’ as indicated by the search timestamp indicator 3325c. The search query indicator 3320d indicates a search request regarding typographic errors which was conducted ‘Today’ as indicated by the search timestamp indicator 3325c. The search query indicator 3320e indicates a search request regarding grammar which was conducted ‘today’ as indicated by the search timestamp indicator 3325e. The search query indicator 3320f indicates a search request regarding ‘brown leaves’ which was conducted ‘today’ as indicated by the search timestamp indicator 3325f. Activation of the search query indicator 3320d may cause a GUI such as the GUI 3400 illustrated in FIG. 34 to be provided.

The search type selection tabs 3330 may to select queries which have been submitted using various communications channels. Activation of the ‘Guided Searches’ search type selection tab 3330a may cause the GUI 3300 to be displayed. A “guided search” is an interactive live search session with a guide. Activation of the ‘Text Searches’ search type selection tab 3330b may provide a GUI which allows a user to review search requests submitted using a text device. A “text search” is a search which is conducted using a text messaging functionality (SMS), which may utilize a guide(s) and/or an automated response(s). Additional search type selection tabs 3330 may be provided based on the communication channels associated with a user ID. For example, voice searches, email searches, IM searches, etc.

An exemplary GUI 3400 for a user to review historical search results is illustrated in FIG. 34. The GUI 3400 includes a guide information window 3405, guide information indicators 3410, a query indicator 3415, a search review window 3420, search result indicators 3425, and a return control 3430. The GUI 3400 may be presented to a user at any time responsive to a request to review a search session.

The guide information window 3405 indicates information of a guide(s) who conducted a search. The completion indicator 3410a may be used to indicate when a search was completed. The guide information indicator 3410b may provide a hyperlink to a web page associated with a guide. Any information of a guide(s) may be provided in the guide indicator window 3405.

The query indicator 3415 indicates information of a search query. The query indicator 3415 may include text, images, audio, etc. which is associated with a query.

The search review window 3420 may be used to review search results which have been provided. The search review window 3420 may include the search result indicators 3425. The search result indicators 3425 may include a hyperlink to a web resource identified by a guide, and a text snippet and/or other description associated with a search result by a guide. Any information associated with a search result may be indicated in a search result indicator 3425. The search result indicator 3425a indicates the result ‘Typo Generator’. Activation of the ‘Typo Generator’ hyperlink associated with the search result indicator 3425a may direct a browser to the website <<http://tools.seobook.com>>. The search result indicators 3425b, 3425c, and 3425d indicate other search results associated with the query ‘Where can I find information on common typographic errors?’ The return control 3430 allows a user to return to the GUI 3300 depicted in FIG. 33. The navigation controls 3435 may be used to navigate within the content of the search review window 3420.

The GUIs described herein allow a user to review any information associated with a search request which has been submitted by a device(s) associated with a communication service(s) which has been associated with a user ID using a browser functionality of a user system. Such capability may for example allow a user to obtain a search result via a first device and/or communication service, and later review additional information associated with the search request using a different device and/or communication service. Likewise, a user may elect to submit a search request using a first device and/or communication service and may receive a search result(s) using a different device and/or communication service. Purchases which have been made using a payment service may be reviewed even if the purchases have been made using various devices.

As illustrated in FIG. 35, a sample of a user identifier association record 3500, of which one or more may be associated with or resident in the search database 1620 (FIG. 16), may include a user ID field 3505, a user verification code field 3510, and a user communication information field 3515.

The user ID field 3505 contains a unique identifier of a user, which is preferably used consistently. For example, in at least one embodiment, the user ID field 3505 can include a randomly generated numerical code, and/or a text string indicating a user. A user ID serves to distinguish a user identifier association record associated with a user from a user identifier association record associated with other user(s). Although particular examples of identifiers are described herein, other types of identifiers uniquely indicating a user(s) may be utilized without departing from the spirit and scope of the embodiments. Using the example in FIG. 35, ‘Bill1023’ is the user ID associated with the user identifier association record 3500.

The user verification code field 3510 includes a verification code for verifying that a user is authorized to access a user record. A user verification code may include a text string and/or numerical code that operate in conjunction with contents of the user ID field 3505 to verify a user authorization(s). In at least one embodiment, a username entered by a user is used to retrieve or “look-up” the user's verification code (password) to compare the verification code with a verification code entered by a user. If both a username match occurs and a verification code match occurs, a user may be allowed to access a user record(s). Other types of security data, such as fingerprint, retinal scan data, etc. may be indicated in the verification code field when technologies such as biometrics are used for access verification without departing from the scope of this disclosure. Using the example illustrated in FIG. 35, the password ‘Billmelater’ is the user verification code associated with the user identifier association record 3500 and the user ID ‘Bill1023’.

The user communication information field 3515 includes information of a number of communication channels which have been associated with a user ID. The content of the user communication information field may include a various types of data indicating that a communication service(s) and/or device(s) is associated with a user. For example, a telephone number, an IM credential, an email address, and/or any other information indicating a communication service(s) and/or device(s) which may be associated with a user ID may be indicated in the user channel association field 3515. Using the example illustrated in FIG. 35, the telephone number ‘317.242.2422’, the email address ‘bill1023@chacha.com’, and the IM credential ‘bill1023 AIM’ are associated with the user ID ‘Bill1023’. Any number of communication services and/or devices may be indicated in the user communication information field 3515.

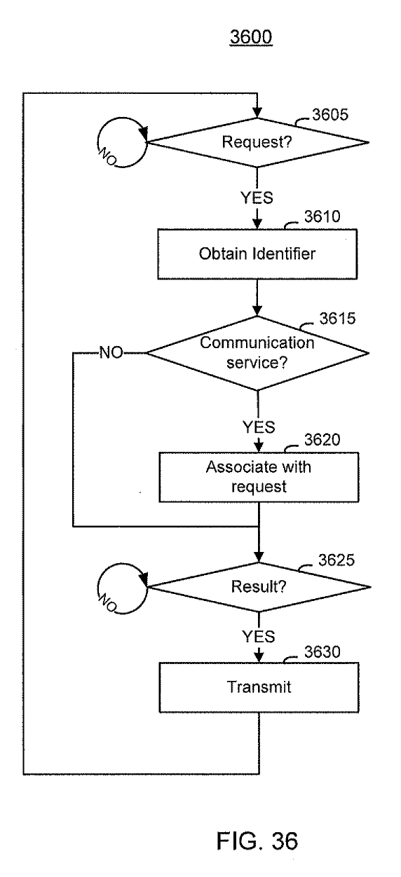

As illustrated in FIG. 36 a process 3600 for associating a communication service(s) with a search request(s) is provided. The process 3600 may be operative on the search system 1615 (FIG. 16) and/or any other suitable system such as a server associated with the mobile messaging application 1630 (FIG. 16). The process 3600 may allow a payment service(s) to be associated with a request, which may allow a payment associated with a transaction to be performed.

In operation 3605 a determination is made as to whether a request is received. If in operation 3605 it is determined that a request is not received, control remains at operation 3605 and process 3600 continues to wait. If in operation 3605 it is determined that a request is received, control is passed to operation 3610 and process 3600 continues. A request may be based on stored information. A query may be triggered by an event(s).

In operation 3610 an identifier associated with a request is obtained. For example, an IP address, a phone number, an email address, an IM credential, a persistent ‘cookie’, a username and/or any other identifier of a user which is associated with a request may be obtained. Control is passed to operation 3615 and process 3600 continues.

In operation 3615 a determination is made as to whether a communication service(s) is associated with a request. If in operation 3615 it is determined that an additional communication service(s) is not associated with a request, control is passed to operation 3625 and process 3600 continues. If in operation 3615 it is determined that an additional communication service(s) is associated a request, control is passed to operation 3620 and process 3600 continues.

The determination in operation 3615 may be based on comparing an identifier associated with a message to information indicated in the database 1620 (FIG. 16) to determine if the identifier is associated with a user ID, which may be associated with a different communication service(s) and/or device(s).

In operation 3620 a communication service(s) is associated with a request. A communication service(s) may be associated with a search request or other message in various ways. For example, any communication service(s) associated with a user identifier may be associated with a search request so that a user may receive immediate notification of information related to a search request(s) such as a search result(s), or other information. Alternately, a communication service(s) may be selectively associated with a search request based on factors such as a category(ies), a keyword(s), a location, availability information, user selections, or other information which may be indicated in the database 1620 (FIG. 16). Using such associations, a user may include information of a communication service(s) which may be utilized to transmit information associated with a search request when a search request is submitted. For example, a user may submit a spoken query, and request to receive a search result via SMS, via a voice reply, and using a webpage provided to a user based on log-in information. In at least one embodiment, a user may designate a default service(s) to be utilized to transmit information related to a search request based on conditions such as a category or keyword associated with a request, a communication service(s) associated with a request, a time factor such as day and date, or a time interval, a priority list for delivering information, etc. Control is passed to operation 3625 and process 3600 continues.

In at least one embodiment, if a user identifier associated with a payment account is associated with an identifier obtained in operation 3615, it may be determined that a request for an item(s) and/or service(s) may be billed to the payment account. For example, if a guide facilitates a transaction from a home phone, and a user has agreed to accept charges to an account associated with a mobile phone service the transaction may be completed without the user providing explicit payment information to the guide. A provider may send a payment request to the payment system, which is confirmed by a PSMS message to a user, and the payment is effected.

In operation 3625 a determination is made as to whether a search result(s) or other information is available to be transmitted to a user. If in operation 3625 it is determined that a search result(s) or other information is not available to be transmitted to a user control remains at operation 3625 and process 3600 continues to wait. If in operation 3625 it is determined that a search result(s) or other information is available to transmit to a user, control is passed to operation 3630 and process 3600 continues. In at least one embodiment, the information may be confirmation of a purchase by a user from a provider.

In operation 3630 a search result(s) or other information is transmitted to a user. Any information may be transmitted to a user using any communication service(s) associated with a user. For example, a user may receive brief information of a search result(s) via an SMS or text message, and may receive more detailed information of a search result(s) via an internet service. A user may receive a voice message notifying the user that a searcher has been identified and requests clarification relating to a search request. A user may receive an IM notification that a search result has been provided which may include a link to a website associated with a user. Any or all communication service(s) associated with a search request may be utilized to transmit information to a user Control is passed to operation 3605 and process 3600 continues. In at least one embodiment, a PSMS message is transmitted to a user device to complete payment for a transaction.

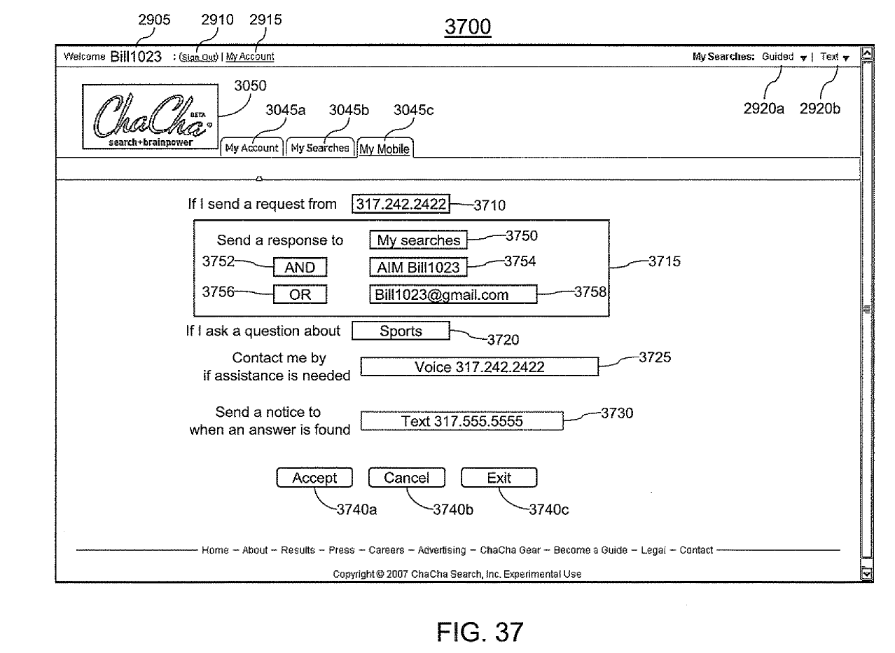

A GUI 3700 for a user to associate a communication service(s) with a search request is illustrated in FIG. 37. The GUI 3700 includes a search condition selector 3710, a search response information window 3715, a search topic selector 3720, a contact indicator 3725, a search notification indicator 3730, and action buttons 3740. The GUI 3700 may be provided to a user and/or a guide.

The search condition selector 3710 may be implemented as a text box, a drop-down list, or typing box, which may present a list of items such as a phone number(s), an email address(es), IM credential(s), user names, locations, or other information. The search condition selector 3710 may be used to designate a condition which will associate one or more communication service(s) with a search request. As illustrated in FIG. 37, a user may designate a location, or a phone number, and email address, etc. from which a search request originates.

The search response window 3715 may be used to indicate a communication service(s) and conditions which may be utilized to send information to a user responsive to a search request associated with the communication service indicated in the search condition selector. The search response window 3715 includes the primary service designator 3750, the first condition designator 3752, the secondary service indicator 3754, the second condition indicator 3756, and the tertiary communication service indicator 3758. The primary service designator 3750 may be implemented as a text box, or preferably a drop-down list of communication services and may indicate a communication service to be used to deliver a search result or other information. The first condition indicator 3752 may be a text box, or drop-down list of conditions, such as ‘AND’, ‘OR’ or other logical conditions which indicate whether and how a secondary communication service may be utilized. The secondary service designator 3754 may be implemented as a text box, or preferably a drop-down list of communication services. The second condition indicator 3756 may be a text box, or drop-down list of conditions, such as ‘AND’, ‘OR’ or other logical conditions which indicate whether and how a tertiary communication service may be utilized. The tertiary service designator 3754 may be implemented as a text box, or preferably a drop-down list of communication services. Although three service designator boxes and two condition indicators are illustrated in FIG. 37, any number of such controls may be provided as needed to operate the embodiments.

The search topic indicator 3720 may be implemented as a text box or drop-down list. The search topic indicator may be used to indicate a category, topic, or other item associated with a search request. For example, a topic such as ‘Sports’, or ‘Dining’ might be indicated using the search topic indicator 3720. For example, if a search request occurs at a particular time of day from a particular device, a response may be delivered using a specified service(s).

The contact indicator 3725 may be a text box, or preferably a drop-down list of communication services associated with a user. The contact indicator 3725 can be used to designate a communication service which may be utilized to communicate with a user to obtain clarification of a search request. For example a user may indicate a telephone number or IM credential which may be utilized for real-time communication with a guide.

The search notification indicator 3730 may be a text box, or preferably a drop-down list of communication services associated with a user. The search notification indicator 3730 may be used to designate a communication service which may be utilized to transmit a notification or other information of a search request to a user.

The action buttons 3740 may be used to take action regarding information obtained using the GUI 3700. The ‘Accept’ button 3740a may be used to indicate that information indicated in the GUI 3700 is to be recorded in the database 1620. The ‘Cancel’ button 3740b may be used to indicate that information obtained in the GUI 3700 is to be discarded. The ‘Exit’ button 3740c may be used to close the GUI 3700.

While the GUI 3700 has been illustrated using specific configurations of controls, and interfaces, any number of controls may be utilized, and any or all of the controls may be suppressed.

A voice, text or other interface may be employed to associate a communication service with a user and/or a search request. For example, a user may associate a communication service with a search request by speaking to a guide, by using a VoiceXML or other voice menu, by sending a text, media, or other mobile message, by sending an email message, etc. The association of a user with a search request may allow any communication service, such as the communication services listed in the user record 3500 illustrated in FIG. 35 to be associated with a search request. A user may designate any communication service to be associated with a search request. A communication service or device may be associated with a search request automatically.

Using the method and system described herein a user may submit a request to a search system. A number of guides may facilitate a transaction. This may allow a user to utilize the search system as a one-stop shop for information, advice and access to providers of products and/or services. If a user elects to associate a payment service with a user account with the search system any transactions facilitated by the search system may be paid for using the payment service. As the payment service is associated with a user payment account it is not necessary for a user to provide sensitive information to a guide. The existing PSMS payment system is utilized to ensure that a transaction is secured. A user may also be provided with a facility to review search activities, purchases, merchants, etc. in a single unified location. Because the search system provides the ability to ask any question, the system has a much broader appeal than calling customer service or directly calling the provider. Further the search system may locate a provider based on any criteria which a user may specify, further increasing the flexibility and value of the system to a user.

The many features and advantages of the invention are apparent from the detailed specification and, thus, it is intended by the appended claims to cover all such features and advantages of the invention that fall within the true spirit and scope of the invention. Further, since numerous modifications and changes will be readily perceived by those of ordinary skill in the art, it is not desired to limit the invention to the exact construction and operation illustrated and described, and accordingly all suitable modifications and equivalents may be resorted to while falling within the scope of the invention.

1. A method of providing access to a good and/or a service, comprising:
receiving a request from a user;
providing information of the request to a guide; and
selecting a provider based on the information presented to the guide.

2. The method of claim 1, wherein the request is received from a mobile device.

3. The method of claim 1, wherein the guide and the provider are selected based on a category associated with the request.

4. The method of claim 1, wherein the provider is associated with a web service.

5. The method of claim 1, comprising:
obtaining an identifier associated with the request, and
providing a payment to the provider based on the identifier.

6. The method of claim 1, the information is qualified by another guide and the provider is ranked based on the information.

7. The method of claim 1, wherein the guide is selected based on the information.

8. The method of claim 1, wherein the request is delivered to a search service.

9. The method of claim 1, comprising: establishing a communication between the user and the provider.

10. The method of claim 9, comprising:
associating another identifier with the identifier,
transmitting a pay per use message to a device associated with the other identifier, and
providing the payment to the provider based on the message.

11. The method of claim 1, wherein the selection is made anonymously.

12. A computer readable medium storing therein a program for causing a program to execute an operation including providing access to a product or a service, comprising:
receiving a request from a user;
providing information of the request to a guide; and
selecting a provider based on the information presented to the guide.

13. The computer readable medium of claim 12, wherein said provider presents one of the product, the service or information thereof as a result to the request, and a payment for the result is provided using an existing service of the user.

14. The computer readable medium of claim 13, comprising:
verifying the existing service of the user using data transmitted to the user prior to applying the payment.

15. The computer readable medium of claim 13, wherein the existing service is a phone service.

16. The computer readable medium of claim 12, wherein the guide directs the user to the provider.

17. The computer readable medium of claim 12, wherein information from the provider is presented to the user using a communication format identified by the user.

18. The computer readable medium of claim 12, comprising: modifying the request of the user to be in a format identified by the provider, and presenting the request to the provider.

19. The computer readable medium of claim 12, wherein the guide establishes a communication session between the provider and the user.

20. A system, comprising:
a user device sending a request;
a search system providing information of the request to a guide;
a guide system selecting a provider based on the information presented to the guide; and
a provider system providing a product and/or a service.
